(19) United States
(12) Patent Application Publication
(10) Pub. No.: US 2026/0330430 A1
(43) Pub. Date: Oct. 22, 2026

(54) MATCHING SYSTEM, USER DEVICE, COMPUTING DEVICE, AND METHOD

(71) Applicant: Cotonova Co., Ltd., Nagaokakyo-shi (JP)

(72) Inventors: Masaharu ITAYA, Nagaokakyo-shi (JP); Kazuki MATSUI, Nagaokakyo-shi (JP)

(73) Assignee: Cotonova Co., Ltd., Nagaokakyo-shi (JP)

(21) Appl. No.: 19/463,153

(22) Filed: Jan. 29, 2026

Related U.S. Application Data
(63) Continuation of application No. PCT/JP2024/020706, filed on Jun. 6, 2024.

(30) Foreign Application Priority Data
Aug. 2, 2023 (JP) 2023-126320

(51) Int. Cl. G06Q 10/40

(52) U.S. Cl. CPC G06Q 10/40

(57) ABSTRACT

A matching system for matching a business case includes: a user device to be operated by a user; and a computing device including processing circuitry, the computing device is configured to access a database in which the business case is registered and configured to disclose the business case to the user, wherein the user device includes a first user device to be operated by a first user belonging to a first group, and a second user device to be operated by a second user, the computing device sets a scope of disclosure of a business case provided by the second user based on disclosure information indicating the scope of disclosure of the business case, based on an operation of the first user, the first user device transmits, to the computing device, restriction information for restricting disclosure of the business case to the first group.

CROSS-REFERENCES TO RELATED APPLICATIONS

The present application is a continuation application of International Application No. PCT/JP2024/020706, filed on Jun. 6, 2024, which claims priority to Japanese Patent Application No. 2023-126320, filed on Aug. 2, 2023, the entire contents of each of which are incorporated herein by reference.

### BACKGROUND

### Technical Field

The present disclosure relates to a matching system, a user device, a computing device, and a method so as to match a business case.

### Background Art

Conventionally, crowdsourcing has been utilized in companies and the like. In general, the crowdsourcing refers to a process of asking an unspecified number of people for contribution so as to acquire a required service, idea, or content. In the crowdsourcing, it is necessary to find a person having a capability optimal for a required business.

PTL 1 describes a method of making a comparison as to whether information about a person required by a development project matches with information of a member of a company so as to extract, as a search result, a member who matches with the required person from the entire organization of the company.

### CITATION LIST

### Patent Literature

PTL 1: Japanese Patent Laid-Open No. 2003-44642

### SUMMARY

A matching system according to a first aspect of the present disclosure is a matching system for matching a business case, the matching system comprising: a user device to be operated by a user; and a computing device including processing circuitry, the computing device is configured to access a database in which the business case is registered and configured to disclose the business case to the user, wherein the user device includes a first user device to be operated by a first user belonging to a first group, and a second user device to be operated by a second user, the computing device sets a scope of disclosure of a business case provided by the second user based on disclosure information indicating the scope of disclosure of the business case, based on an operation of the first user, the first user device transmits, to the computing device, restriction information for restricting disclosure of the business case to the first group, and the computing device restricts the business case provided by the second user from being disclosed to the first group in accordance with the restriction information regardless of the scope of disclosure set based on the disclosure information.

A user device according to a second aspect of the present disclosure is a user device for communicating with a computing device for matching a business case, wherein the computing device is configured to access a database in which the business case is registered and is configured to disclose the business case to a user, the computing device sets a scope of disclosure of the business case based on disclosure information indicating the scope of disclosure of the business case and restriction information, the user device includes a receiver that receives a user operation for inputting the restriction information, and a transmitter that transmits the restriction information to the computing device when the user operation is received by the receiving unit, and the restriction information is information that restricts the business case from being disclosed to a first group to which a first user belongs, regardless of the scope of disclosure that is based on the disclosure information.

A computing device according to a third aspect of the present disclosure is a computing device for communicating with a user device and matching a business case, the computing device including: processing circuitry configured to access a database in which the business case is registered and that sets a business case to be disclosed to a first group to which a first user belongs, based on disclosure information indicating a scope of disclosure of the business case; receive, from the user device, restriction information for restricting the disclosure of the business case to the first group; and when the restriction information is received, restrict the business case from being disclosed to the first group in accordance with the restriction information regardless of the scope of disclosure set based on the disclosure information.

A method according to a fourth aspect of the present disclosure is a method of matching a business case, the method comprising: accessing a database in which the business case is registered and setting a business case to be disclosed to a first group to which a first user belongs, based on disclosure information indicating a scope of disclosure of the business case; receiving, from a user device, restriction information for restricting the disclosure of the business case to the first group; and when the restriction information is received, restricting the business case from being disclosed to the first group in accordance with the restriction information regardless of the scope of disclosure set based on the disclosure information.

### BRIEF DESCRIPTION OF DRAWINGS

The scope of the present disclosure is best understood from the following detailed description of exemplary embodiments when read in conjunction with the accompanying drawings.

FIG. 1 is a block diagram showing an overview of a matching system.

FIG. 2 is a block diagram showing configurations of a sharing server, an inviter device, and an applicant device.

FIG. 3 is a diagram showing an exemplary company database.

FIG. 4 is a diagram showing an exemplary member database.

FIG. 5 is a diagram showing an exemplary community database.

FIG. 6 is a diagram showing an exemplary invitation case database.

FIG. 7 is a diagram showing an exemplary sideline database.

FIG. 8 is a diagram showing an exemplary evaluation input database.

FIG. 9 is a diagram showing an exemplary evaluation summary database.

FIG. 10 is a diagram for illustrating functions of the sharing server, the inviter device, and the applicant device.

FIG. 11 is a diagram for illustrating the functions of the sharing server, the inviter device, and the applicant device.

FIG. 12 is a diagram for illustrating the functions of the sharing server, the inviter device, and the applicant device.

FIG. 13 is a diagram for further illustrating the function of the applicant device.

FIG. 14 is a diagram for illustrating a procedure of registering an invitation case into the invitation case database.

FIG. 15 is a diagram for illustrating a procedure of searching for an invitation case in the database.

FIG. 16 is a diagram for illustrating a procedure of registering schedule and record of a sideline into the database.

FIG. 17 is a diagram for illustrating a procedure of registering an evaluation for an applicant into the database.

FIG. 18 is a diagram for illustrating a procedure of registering an evaluation for an inviter into the database.

FIG. 19 is a diagram for illustrating a procedure of presenting, on a display, an evaluation for an applicant and a search result for a member.

FIG. 20 is a diagram for illustrating a procedure of presenting, on the display, an evaluation for an inviter and a search result for a member.

FIG. 21 is a diagram for illustrating a permitted scope of viewing of the evaluation summary database.

FIG. 22 is a diagram showing an example of setting a scope of disclosure in accordance with a disclosure level.

FIG. 23 is a diagram showing a screen presented on an applicant device of an administrator (superior for an applicant) when the administrator checks a sideline status of a subordinate.

FIG. 24 is a diagram showing a screen presented on the applicant device when the administrator changes a setting of a viewing restriction.

FIG. 25 is a timing chart for a setting of restriction information.

FIG. 26 is a diagram showing a detail of a case content included in the invitation case database.

FIG. 27 is a diagram showing an exemplary profile database.

FIG. 28 is a diagram showing an exemplary company-specific term database.

FIG. 29 is a flowchart showing a processing procedure for an index function of the matching system.

FIG. 30 is a flowchart showing a processing procedure of a company-specific term registration unit.

FIG. 31 is a flowchart showing a processing procedure of a case registration unit.

FIG. 32 is a flowchart showing a processing procedure of presenting a meaning of a company-specific term on a screen in accordance with an operation of an applicant.

FIG. 33 is a flowchart for a process for restriction information as performed by a sharing server as a modification 1.

FIG. 34 is a diagram for illustrating functions of a sharing server, an inviter device, and an applicant device according to a modification 2.

FIG. 35 is a diagram showing an exemplary member database according to modification 2.

FIG. 36 is a flowchart showing a procedure of a counteroffer member search process according to modification 2.

FIG. 37 is a block diagram showing configurations of a sharing server, an inviter device, and an applicant device according to a modification 3.

FIG. 38 is a diagram showing an exemplary member group database according to modification 3.

FIG. 39 is a diagram showing an exemplary invitation case database according to modification 3.

FIG. 40 is a diagram for illustrating functions of the sharing server, the inviter device, and the applicant device according to modification 3.

FIG. 41 is a diagram for illustrating a procedure of registering an invitation case into the invitation case database according to modification 3.

FIG. 42 is a diagram showing a configuration of a matching system according to a modification 4.

FIG. 43 is a diagram showing an example (modification 5) in which Kerberos authentication is applied to a matching system.

### DESCRIPTION OF EMBODIMENTS

Hereinafter, embodiments of the present disclosure will be described in detail with reference to figures. It should be noted that the same or corresponding portions in the figures are denoted by the same reference characters and will not be described repeatedly.

### Technical Problem

The crowdsourcing described in PTL 1 is implemented within one group, i.e., the company. However, in order to find a more appropriate person, it is desirable to further expand the scope of the crowdsourcing. In this case, it is necessary to take a stake between users into consideration when matching a business case. For example, it is necessary to provide a matching system with a mechanism that allows an inviter side to control where to disclose a business case associated with the matching, so as to avoid the business case from being disclosed to a competitor. However, only by providing such a mechanism in the matching system, it may not be possible to prevent know-how from being leaked to the competitor.

The present disclosure has been made to solve the above-described problem, and has an object to restrict a scope of disclosure of a business case in consideration of a stake between users when matching the business case.

### Background as to Proposal of Matching System 1

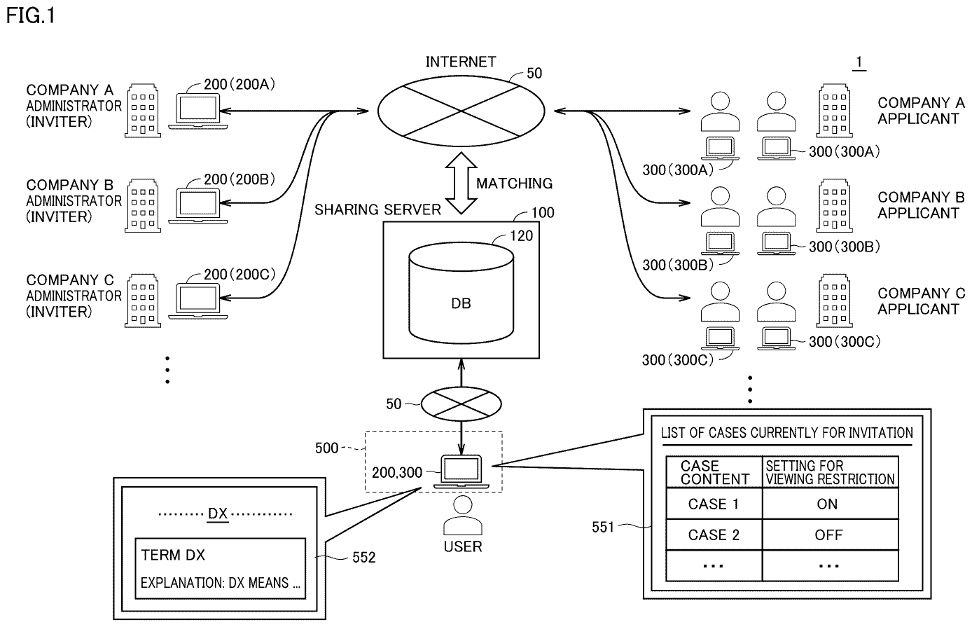

FIG. 1 is a block diagram showing an overview of a matching system 1 according to the present embodiment. First, a background as to proposal of matching system 1 in the present embodiment will be described.

Matching system 1 is utilized, for example, for crowdsourcing among companies. The crowdsourcing is generally a process of asking an unspecified number of people for contribution so as to acquire a required service, idea, or content.

In order to utilize human resources effectively, not a few companies promote sidelines. By utilizing the crowdsourcing among the companies, the capabilities of the employees of the companies can be utilized.

However, when a general crowdsourcing technique is applied between the companies without modification, the following problems may occur.

### Possibility of Leakage of Secret Information

In the general crowdsourcing technique, since a relationship between a company on the order placer side and a company on the order receiver side is not taken into consideration, adoption of the crowdsourcing involves a company risk and an individual risk. For example, secret information may be leaked to a company having a rival relationship through a sideline of an employee. In the conventional crowdsourcing technique, an administrator cannot check that an employee has not received an order for a case of another competitor as a sideline.

### Possibility of Overwork

When a company permits a sideline of an employee, the employee's work time may become excessively long. To eliminate a risk of overwork, it is contemplated that the company determines an upper limit on overtime work including the main job and the sideline. However, it is difficult for the company to manage the sideline time of the employee as long as the employee can freely receive an order as a sideline. This may result in a state of overwork of the employee.

### Possibility That Outcome of Sideline is Not Properly Evaluated

Conventionally, there has been a crowdsourcing system that requests an order placer to make an evaluation for an order receiver. When an appropriate evaluation made by an order placer is shared in the crowdsourcing system, one who makes an invitation to an order receiver for a business can refer to the evaluation so as to select a person having a high capability from many persons who wish to receive an order for a business.

However, an order placer in a certain company may input a higher magnitude of evaluation into the system than a reasonable magnitude of evaluation in consideration of an order receiver in another company to be evaluated. Moreover, an order placer of a certain company may avoid an order receiver of another company from being evaluated to have a low magnitude of evaluation in consideration of a possibility of deterioration of a relationship between the companies. Furthermore, the order placer may not think that there is a benefit in making an evaluation and may input an evaluation that is much different from a reasonable magnitude of evaluation into the system. In view of these possibilities, reliability of evaluations provided by the system may be decreased. In this case, even when evaluations for order receivers are shared, an order placer for a business cannot utilize the evaluations as reference data when selecting an order receiver.

### Possibility That Accurate Information About Inviter Cannot be Obtained

In the crowdsourcing system as described above, an applicant who wishes to apply for a business for which an invitation is made will select an acceptable business while referring to content, reward, and the like of the business. However, some inviters may frequently make an additional request falling out of the scope of the business for which a contract has been made and may frequently instruct changes of the content of the business. An applicant would like to avoid such inviters when applying for an invitation business. On the other hand, some inviters cause no problem until completion of businesses. An applicant would like to apply for a business invited by such an inviter, if possible. Therefore, it is desirable to widely share not only the evaluations for the applicants (order receivers) but also the evaluations for the inviters (order placers) in the crowdsourcing system.

When appropriate evaluations for inviters are shared in the crowdsourcing system, one who is going to apply for a business can refer to the evaluations so as to select an acceptable business from a large number of invitation businesses in consideration of past transaction histories or the like of the inviters.

However, in the case of constructing the evaluation system in which inviters can be evaluated, the same problem as in the case of constructing the evaluation system in which order receivers can be evaluated may occur. That is, an order receiver (applicant) in a certain company may input a higher magnitude of evaluation into the system than a reasonable magnitude of evaluation, in consideration of an order placer (inviter) in another company to be evaluated. Moreover, an order receiver (applicant) in a certain company may avoid an order placer (inviter) in the other company from being evaluated to be low in consideration of a possibility of deterioration of a relationship between the companies. Further, an order receiver (applicant) may not think that there is a benefit in making an evaluation, and may input a magnitude of evaluation that is much different from a reasonable magnitude of evaluation into the system. In view of these possibilities, reliability of evaluations provided by the system may be decreased. In this case, even when the evaluations for inviters are shared, an applicant cannot utilize the evaluations as reference data when selecting an inviter.

### Specialness When Entities to be Matched Are Companies

In general, in order to match a person and a business between companies, an intimate relationship such as a trust relationship is needed between the companies between which a person and a business are to be matched. Therefore, for example, matching between a person and a business is very difficult between companies having no capital relationship. Moreover, there is such a special situation that matching between a person and a business cannot be made among a large number of companies because enterprises such as publicly traded companies are likely to compete with other companies from the viewpoint of diversification of business or the like and are likely to result in cannibalization with the other companies.

### Possibility that Communication is Inhibited by Company-Specific Term

In a company, a company-specific term specific to the company may be widely used. Such a company-specific term is understandable by a person from the company in which the company-specific term is widely used, but may not be understandable by a person who does not belong to the company in which the company-specific term is widely used. Further, the company-specific term is understood as a term having a specific meaning among people from the company in which the company-specific term is widely used, but may be understood as a term having a meaning different from the specific meaning among people who do not belong to the company in which the company-specific term is widely used.

Such a company-specific term may be used in an application guideline for business. When a company to which an inviter belongs is different from a company to which an applicant belongs, the applicant may be unable to correctly understand the meaning of a company-specific term used by the inviter in the application guideline. The applicant may apply for the invitation business while the applicant does not correctly understand the meaning of the company-specific term used by the inviter in the application guideline. This may result in a trouble in the business.

Such a company-specific term may be used in a meeting between an inviter and an applicant. When a company to which the inviter belongs is different from a company to which the applicant belongs, the applicant may be unable to correctly understand the meaning of a company-specific term spoken by the inviter. Similarly, the inviter may be unable to correctly understand the meaning of a company-specific term spoken by the applicant.

When the company-specific term spoken by one of the inviter and the applicant is an unfamiliar company-specific term, the other will be able to understand the meaning of the company-specific term by asking a question to the speaker with regard to the meaning of the term. However, when the meaning of one company-specific term is differently understood between the inviter and the applicant, the meeting proceeds while the difference in recognition between them remains uncorrected. This may result in a trouble in business.

As terms similar to the company-specific terms, terms used in unique meanings may be widely used not only in companies but also in non-profit organizations. Regardless of a profit organization or a non-profit organization, one organization may be divided into a plurality of units such as departments and sections, and terms used in specific meanings may be widely used in each unit. Further, such terms may also be widely used in a community formed by gathering a plurality of organizations such as companies. Therefore, when an inviter and an applicant belong to different organizations, units, and communities, the difference in recognition of the terms may result in the above-described trouble in business.

In the present embodiment, not only the “company-specific terms” as used in the profit organizations such as companies and the units in the profit organizations, but also the “terms similar to the company-specific terms” as used in the non-profit organizations, communities, and units in the non-profit organizations and communities are collectively referred to as “in-house terms”. In the description below, the present embodiment will be described by illustrating the “company-specific terms” for the companies as an example of the “in-house terms”.

In the present embodiment, matching system 1 described in detail below is proposed in order to solve at least one of the above-described various problems in the conventional cloud sourcing.

### Overall Configuration

An overview of a configuration of matching system 1 will be described with reference to FIG. 1. Matching system 1 includes a sharing server 100, inviter devices 200A, 200B, 200C, . . . , and applicant devices 300A, 300B, 300C, . . . .

Sharing server 100 provides a large number of companies with a matching service for matching placement and reception of orders for businesses among the companies. In FIG. 1, companies A, B, C, . . . are shown as exemplary companies that use the matching service. Companies A, B, C, . . . are registered as company members of matching system 1. Among employees of companies A, B, C, . . . , employees who use matching system 1 are also individually registered as members of matching system 1.

A business offered in matching system 1 is, for example, a temporary business assumed to be completed in a predetermined period of time. Hence, one who receives an order for a business offered in matching system 1 has a main job that is a business in a specific department to which he/she belongs in a company, has a sideline that is the business offered in matching system 1, and engages in each of the businesses. It should be noted that in matching system 1, for example, an applicant of company A can receive an order for a business of company A. Therefore, in matching system 1, an applicant belonging to a department Y of company A is permitted to receive an order for a business of a different department X of company A.

Hereinafter, in matching system 1, a business for which an invitation is made to an order receiver may be referred to as an “invitation business”, an “invitation case”, or a “business case”, one who provides such an invitation case may be referred to as an “inviter”, and one who applies for reception of an order for such an invitation case may be referred to as an “applicant”. Applying for an invitation business may be referred to as “application for an invitation business” or “application for an invitation case (business case)”.

An applicant who has received an order for an invitation case corresponds to an “order receiver”, and an inviter who has placed an order for a case to an order receiver corresponds to an “order placer”; however, the “applicant” may be referred so as to include the “order receiver” and the “inviter” may be referred so as to include the “order placer” in the below description.

A database 120 necessary for the matching service is constructed in sharing server 100. Database 120 includes various databases in each of which information necessary to provide the matching service is registered. For example, pieces of information of a member and an invitation business are registered in database 120. Sharing server 100 is managed and operated by a company other than the companies that use the matching service. Any company that uses the matching service may manage and operate sharing server 100.

Inviter device 200A is operated by an administrator of company A. Inviter device 200B is operated by an administrator of company B. Inviter device 200C is operated by an administrator of company C. Hereinafter, inviter devices 200A, 200B, 200C, . . . may be collectively referred to as “inviter device 200”.

Applicant device 300A is operated by an applicant of company A. Applicant device 300B is operated by an applicant of company B. Applicant device 300C is operated by an applicant of company C. Hereinafter, applicant devices 300A, 300B, 300C, . . . may be collectively referred to as “applicant device 300”. Although FIG. 1 illustrates two applicants for each company, the number of applicants is not limited thereto. A larger number of applicants may exist in each company, or one applicant may exist in a certain company. Sharing server 100 may accept, as an applicant, one who does not belong to a company, such as a freelancer.

Each of the administrators of companies A, B, C, . . . plays a role as an inviter in the present embodiment. Therefore, in the description below, each of the administrators of the companies may be referred to as “inviter”. The inviter can also behave as an applicant for a business for which another inviter invites an application. In this case, inviter device 200 functions as applicant device 300. In the present embodiment, when an administrator of a company behaves as an inviter, a device used by the administrator to use the matching service is referred to as inviter device 200.

There may be one or a plurality of administrators in company A. When administrators are placed in company A, the administrators may be provided with inviter devices 200 respectively, or one inviter device 200 may be shared by the plurality of administrators. The same applies to companies B, C, . . . .

Sharing server 100 and inviter device 200 are configured to communicate with each other via Internet 50, which is an exemplary communication network. Sharing server 100 and applicant device 300 are configured to communicate with each other via Internet 50.

When receiving access from inviter device 200, sharing server 100 requests sign-in involving input of a member ID and a password. Similarly, when receiving access from applicant device 300, sharing server 100 requests sign-in involving input of a member ID and a password. Sharing server 100 specifies each one of inviters and applicants by a corresponding member ID notified at the time of sign-in.

Inviter device 200 receives various operations of the inviter. For example, inviter device 200 receives an operation of inputting an invitation case (requested business), an operation of inputting an evaluation for an order receiver having finished the business, and an operation of searching for a member of the matching service.

In response to each operation on inviter device 200, inviter device 200 communicates with sharing server 100. In response to the operation of inputting an invitation case (requested business), sharing server 100 registers the invitation case into database 120, in response to the operation of inputting an evaluation, sharing server 100 registers the evaluation of the target applicant (order receiver) into database 120, and in response to the operation of searching for a member, sharing server 100 provides information of the member to inviter device 200.

Applicant device 300 receives various operations of the applicant. For example, applicant device 300 receives an operation of searching for an invitation case, an operation of applying for an invitation case, an operation of inputting a record of a business, and the like.

In response to each operation on applicant device 300, applicant device 300 communicates with sharing server 100. Sharing server 100 provides an appropriate invitation case to applicant device 300 in response to the operation of searching for an invitation case, issues a notification of acceptance or rejection to applicant device 300 in response to the operation of applying for an invitation case, and registers a record of a business into database 120 in response to the operation of inputting a record of a business.

As described above, matching system 1 includes: an evaluation system for evaluating an applicant (order receiver) for a business; and an invitation system for inviting an order receiver for a business.

An inviter belonging to a certain department of company A can use matching system 1 to employ, as an order receiver for a corresponding invitation case, an applicant belonging to another department of company A. An inviter belonging to company A can use matching system 1 to employ, as an order receiver for a corresponding invitation case, an applicant belonging to company B.

In the description below, the member of matching system 1 may be referred to as “user”. Further, in the description below, inviter device 200 and applicant device 300 operated by the members may be collectively referred to as “user device 500”. Each of the users who use matching system 1 uses “user device 500” to access sharing server 100 as an inviter or an applicant.

Various types of information are presented on user device 500. For example, when the user is accessing sharing server 100 in the position of applicant, a list of business cases for which the user can apply is presented on user device 500. The user can select a case for which the user wishes to apply from the list of business cases. In particular, FIG. 1 shows a screen 551 indicating the “list of cases currently for invitation” as presented when the user signs up to sharing server 100 in an administrator mode. The user can view the “list of cases currently for invitation” and can accordingly know all the business cases disclosed for the company to which the user belongs.

The “list of cases currently for invitation” includes an area for allowing the user to set a viewing restriction on a business case. Such an area is not presented when the user signs up to sharing server 100 in a general mode other than the administrator mode. From the large number of business cases, the user having an administrator authority can select a case that the user does not want an employee belonging to the company to view, and set a viewing restriction on the selected case. The case on which the viewing restriction is set will not be disclosed to the company to which the user having the administrator authority belongs.

Thus, in the present embodiment, only the user having the administrator authority can make the setting for the viewing restriction on the business case. However, the system may be configured such that one who has obtained permission from the user having the administrator authority can make the setting for the viewing restriction on the business case. Alternatively, the system may be configured such that any user can make the setting for the viewing restriction on the business case.

When a user is accessing sharing server 100 in the position of inviter, the user can also present the profile of an applicant on user device 500. The user checks the job history or the like of the applicant by using user device 500. Alternatively, an application guideline for the business is presented on user device 500. The user (applicant) sees a screen 552 of user device 500 so as to check details of the business. The user (inviter) sees screen 552 so as to check the job history or the like of the applicant. Alternatively, on screen 552, a report on an ongoing business, an instruction for a change in a part of the content of a request, an instruction for addition to the content of a request, and the like are presented. The user checks the contents presented on screen 552 and performs a necessary process using user device 500, such as reply to the counterpart with regard to a necessary matter.

Information such as the application guideline, job history, business report, and instruction presented on screen 552 may include a company-specific term. When a company to which the user who sees screen 552 belongs is different from a company to which a user who provides the information belongs, the user who sees screen 552 may be unable to correctly understand the company-specific term.

To address this, matching system 1 registers company-specific terms of the companies and the meanings thereof into database 21. Matching system 1 generates an index for a company-specific term from a text used by the user such as an application guideline, and links the index to a corresponding company-specific term registered in database 21. Thus, matching system 1 has an index function.

When a company-specific term is included in the text presented on screen 552, user device 500 presents the company-specific term in a presentation manner different from those of the other terms. Thus, the user understands that it is a company-specific term. Further, in response to an operation by the user (for example, an operation of clicking a portion of the company-specific term), user device 500 presents the meaning intended by the company-specific term on screen 552.

For example, “DX” is presented on screen 552 shown in FIG. 1 as an exemplary company-specific term. “DX” is underlined to indicate that it is a company-specific term. The user clicks “DX”. Then, a window explaining the meaning of the term “DX” is presented on screen 552. DX is an abbreviation for Digital Transformation and generally means a change through digital technology. However, some companies may use “DX” as a company-specific term that means to create some new value regardless of whether or not the digital technology is used. In such a case, the meaning corresponding to the company-specific term is explained in the window of screen 552. Thus, the user can correctly understand the meaning of “DX” intended by the counterpart.

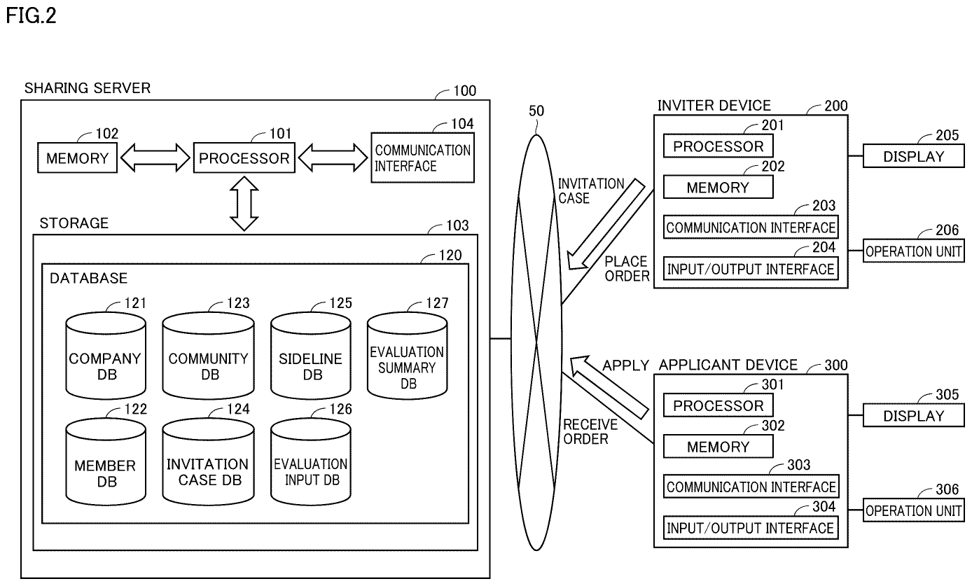

FIG. 2 is a block diagram showing configurations of sharing server 100, inviter device 200, and applicant device 300.

### Configuration of Sharing Server 100

Sharing server 100 includes a processor 101, a memory 102, a storage 103, and a communication interface 104 (herein “processing circuitry” means the same as “processor”).

Memory 102 includes a RAM (random access memory), a ROM (read only memory), a flash memory, or any other suitable memory system. Memory 102 stores a program necessary for arithmetic processing of processor 101, temporary data calculated in the arithmetic processing, and the like.

Storage 103 is constituted of a hard disk drive, a solid state drive, and the like. Storage 103 stores database 120. Database 120 includes a plurality of types of databases. The plurality of types of databases include a company database (company DB) 121, a member database (member DB) 122, a community database (community DB) 123, an invitation case database (invitation case DB) 124, a sideline database (sideline DB) 125, an evaluation input database (evaluation input DB) 126, and an evaluation summary database (evaluation summary DB) 127.

A part of the plurality of types of databases may be stored in a storage provided separately from sharing server 100. For example, connection may be made to a cloud service different from sharing server 100, and a part of the plurality of types of databases shown in FIG. 2 may be stored in the cloud. In this case, sharing server 100 can access a necessary database by communicating with the cloud via Internet 50.

Processor 101 connects to Internet 50 via communication interface 104 in accordance with a program stored in memory 102. Processor 101 connects to Internet 50 and communicates with inviter device 200 and applicant device 300. Processor 101 accesses database 120 and performs a process of extracting necessary data, a process of registering new data into database 120, a process of updating data registered in database 120, and the like. The processor/processing circuitry 101 can be programmable circuitry (e.g., embedded processor) or fixed circuitry (e.g., ASIC or PAL). In an exemplary embodiment, the processor/processing circuitry 101 can include one or more programmable processors/controllers.

### Configuration of Inviter Device 200

Inviter device 200 includes a processor 201, a memory 202, a communication interface 203, an input/output interface 204, a display 205, and an operation unit 206. Operation unit 206 is constituted of a mouse, a keyboard, and the like.

Memory 202 includes a RAM (random access memory), a ROM (read only memory), a flash memory, or any other suitable memory system. Memory 202 stores a program necessary for arithmetic processing of processor 201, temporary data calculated in the arithmetic processing, and the like.

Processor 201 connects to Internet 50 via communication interface 203 in accordance with a program stored in memory 202. Processor 201 connects to Internet 50 and communicates with sharing server 100. Processor 201 communicates with sharing server 100 so as to perform a process of transmitting an invitation case, a process of presenting, on display 205, information of a member who is an applicant, a process of placing an order to an order receiver selected from applicants, a process of transmitting, to sharing server 100, a content of evaluation for an order receiver input by an inviter, and the like.

Information input by an operation on operation unit 206 is notified to processor 201 via input/output interface 204.

### Configuration of Applicant Device 300

Applicant device 300 includes a processor 301, a memory 302, a communication interface 303, an input/output interface 304, a display 305, and an operation unit 306. Operation unit 306 is constituted of a mouse, a keyboard, and the like.

Memory 302 includes a RAM (random access memory), a ROM (read only memory), a flash memory, or any other suitable memory system. Memory 302 stores a program necessary for arithmetic processing of processor 301, temporary data calculated in the arithmetic processing, and the like.

Processor 301 connects to Internet 50 via communication interface 303 in accordance with a program stored in memory 302. Processor 301 connects to Internet 50 and communicates with sharing server 100. Processor 301 communicates with sharing server 100 to perform a process of applying for an invitation case, a process of presenting, on display 305, a notification of acceptance or rejection for a case for which an application has been made, a process of transmitting, to sharing server 100, a record of a business for which an order has been received, and the like.

Information input by an operation on operation unit 306 is notified to processor 301 via input/output interface 304.

### Overview of Database 120

Hereinafter, an overview of database 120 will be described. In company database 121, pieces of information of the companies participating in matching system 1 are registered. In member database 122, pieces of information of the members using matching system 1 are registered. Many members are employees of the companies participating in matching system 1.

Each of the members registered in member database 122 can act as an inviter (order placer) or an applicant (order receiver) by using matching system 1. The members may include not only the employees belonging to the companies registered in company database 121, but also an individual (freelancer) not belonging to each of the companies.

Community database 123 stores pieces of information for specifying companies belonging to communities. Each of the communities is formed by an agreement between companies. Therefore, a plurality of communities can be formed depending on manners of agreements between companies. The number of companies belonging to one community can also be set variously. Between companies having a community relationship, a trust relationship is formed to an extent determined by a manner of an agreement when forming the community. In community database 123, information for specifying a company belonging to a community is registered on the community basis.

In invitation case database 124, businesses (invitation cases) for which invitations are made to order receivers are registered. While an employee of each of the companies engages in the main job of the company's department to which the employee belongs, the employee can receive, as a member of matching system 1, an order for a case, registered in invitation case database 124, of another department of the employee's company or can receive an order for a case, registered in invitation case database 124, of another company. In this case, the member receives, as a sideline, the order for the case of the other department of the employee's company or the case of the other company.

In sideline database 125, data indicating a sideline status is registered on the member basis. The data indicating the sideline status includes information such as a record of sideline and a schedule of sideline.

In evaluation input database 126, pieces of information of evaluations for applicants (order receivers) for businesses are registered. An inviter (order placer) for a business can use matching system 1 to evaluate, as an evaluator, a job performance of an applicant (order receiver) who has finished the business. The evaluations made by the individual evaluators are registered in evaluation input database 126.

Evaluation summaries are registered in evaluation summary database 127. In evaluation summary database 127, an evaluation summary is registered on the member basis. Each of the inviters can view the evaluation summaries. An inviter can select a member, who seems appropriate, as an order receiver while viewing the respective evaluation summaries of the members who apply for the invitation case.

### Company Database 121

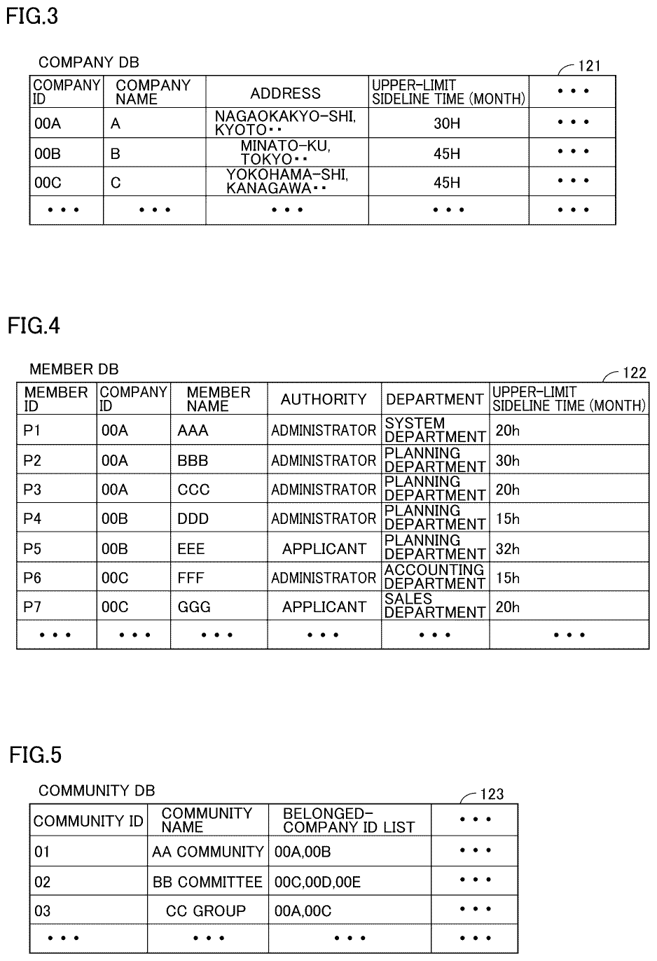

FIG. 3 is a diagram showing an exemplary company database 121. In company database 121, a company ID, a company name, and an address of a company for identifying the company, as well as an upper-limit sideline time are registered on the company basis. The upper-limit sideline time is an upper-limit time during which an employee is permitted to have a business as a sideline separately from the main job. The upper-limit sideline time is determined on the company basis. For example, the upper-limit sideline time can be calculated as follows: “a predetermined time of overtime work—a time of overtime work in the main job other than the sideline”. The “predetermined time of overtime work” differs among companies. It should be noted that FIG. 3 shows an upper-limit sideline time on a monthly basis, but an upper-limit time on a weekly basis may be employed. The unit of the upper-limit sideline time may be determined on the company basis.

In the present embodiment, each of the members is permitted to apply for businesses invited by various companies and departments and to receive orders for the businesses to such an extent that the upper-limit sideline time determined by a company to which the member belongs is not exceeded.

### Member Database 122

FIG. 4 is a diagram showing an exemplary member database 122. Various types of information of each of the members are registered in member database 122. The various types of information of each of the members include a member ID for identifying the member, a company ID of a company to which the member belongs, a member name, an authority of the member, a department to which the member belongs, and a permissible sideline time.

Types of the authority of the member include an administrator and an applicant. A member having the administrator authority is given an authority to use matching system 1 as an inviter and an applicant. A member having the applicant authority is given an authority to use matching system 1 as an applicant, but is not given an authority to use matching system 1 as an inviter. The administrator authority is given to a department director in a company in order to manage a sideline status of a subordinate in the department. The administrator having the administrator authority is given an authority to approve the application from the applicant who is the subordinate. Thus, the administrator functions as an approver.

The permissible sideline time is a remaining time during which one can engage in a sideline. The permissible sideline time is calculated as follows: “the upper-limit sideline time—a total sideline time”. When a subject engages in a plurality of sidelines, the total sideline time includes a time already spent for the plurality of sidelines. The total sideline time includes an expected sideline time in addition to the time already spent for the sideline. The expected sideline time is calculated in accordance with estimated man-hours registered in invitation case database 124. FIG. 4 shows a permissible sideline time on the monthly basis. To an applicant who searches for an invitation business using matching system 1, businesses that can be handled with man-hours falling within the range of the permissible sideline time are provided as cases for which applications can be made.

### Community Database 123

FIG. 5 is a diagram showing an exemplary community database 123. In community database 123, pieces of information of communities formed between companies are registered. The community information includes a community ID for identifying each of the communities, a community name, and an ID list of the companies belonging to the community. Each company can form various communities by making agreements with the other companies. A company belonging to a community can change a company eligible to belong to the community, by making an agreement with the other companies.

### Invitation Case Database 124

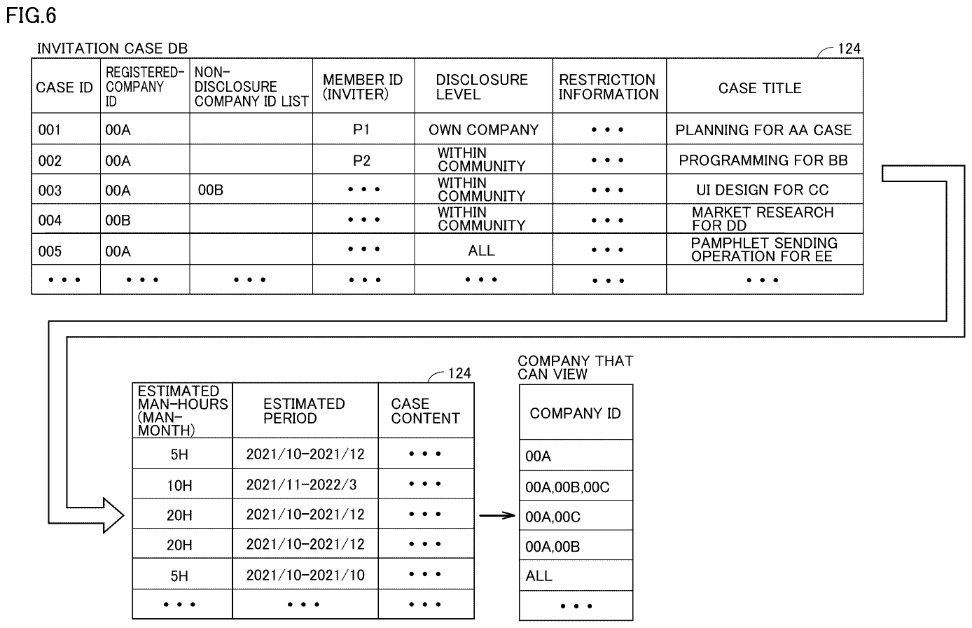

FIG. 6 is a diagram showing an exemplary invitation case database 124. In invitation case database 124, pieces of information of invitation cases are registered. The pieces of information of the invitation cases include a case ID for identifying an invitation case, an ID of a company to which an inviter who has registered an invitation case belongs, a non-disclosure company ID list, a member ID of an inviter, a disclosure level, restriction information, a case title, estimated man-hours, an estimated period, and a case content.

For example, in the non-disclosure company ID list, the ID of a company to which an invitation case is prohibited to be disclosed is registered. In the disclosure level, any one of three levels, i.e., “own company”, “within community”, and “all” is set. When the disclosure level is set to “all”, the disclosure is made to those including an applicant outside the community. The restriction information is information about the viewing restriction shown in FIG. 1. The restriction information is set on the basis of a company of an applicant for an invitation case.

On the right side of invitation case database 124 in FIG. 6, the IDs of companies that can view the invitation cases are shown. For example, in an invitation case corresponding to a case ID=001, the disclosure level is set to “own company”. In this case, members belonging to the company (company ID=00A) having registered the invitation case can view the invitation case corresponding to the case ID=001.

In the description below, invitation cases corresponding to respective case IDs may be referred to as a case 001, a case 002, a case 003, . . . by using the case IDs. Similarly, communities corresponding to respective community IDs may be referred to as a community 01, a community 02, a community 03, . . . by using the community IDs, and members corresponding to respective member IDs may be referred to as a member P1, a member P2, a member P3, . . . by using the member IDs. Further, in the description below, companies corresponding to respective company IDs may be referred to as a company A, a company B, a company C, . . . by using parts of the company IDs.

In case 002, the disclosure level is set to “within community”. According to community database 123 shown in FIG. 5, companies each having a community relationship with company A having registered case 002 are company B and company C. Therefore, as shown in FIG. 6, members belonging to any of company A, company B, and company C can view case 002.

However, when the administrator of company B sets a viewing restriction on case 002, restriction information for restricting a member of company B from viewing case 002 is registered into invitation case database 124. In this case, members belonging to any of company A and company C can view case 002.

In case 003, the invitation case is registered by the same company as that in case 002 and the disclosure level is the same as that of case 002. However, in case 003, “00B” is registered in the non-disclosure company ID list. Therefore, as shown in FIG. 6, the members belonging to any of company A and company C can view case 003, and the members belonging to company B are not each given an authority to view case 003.

In an invitation case for which the disclosure level is set to “all”, all the members can view the invitation case. Case 005 shown in FIG. 6 corresponds to this. If one or a plurality of company IDs are registered in the non-disclosure company ID list of case 005, the members belonging to the companies of the one or plurality of company IDs are not each given an authority to view case 005.

The estimated man-hours and the estimated period are used by the applicant and matching system 1 so as to estimate a time to deal with a corresponding invitation case.

It should be noted that it is conceivable to employ various modifications with regard to the setting of the disclosure level. For example, the user may be allowed to control where to disclose the business information by selecting a specific item. More specifically, a check box for selecting a company to which the business information is to be disclosed may be provided on the screen for registering an invitation case. Alternatively, the user may select one of predefined options to control related information or function. For example, a list by which the user can select the scope of disclosure of the business information from “within own company”, “within community”, and “all users” may be presented on the screen for registering an invitation case.

User device 500 may provide the user with a setting screen for variously setting the disclosure level. For example, the setting screen may present a checkbox to allow the user to select one to which the case is to be disclosed, on the business type basis such as “pharmaceutical”, “chemistry”, “electrical equipment”, “railway and bus”, or “food”. Further, by presenting company names corresponding to the business types on the setting screen, the user may be able to select one to which the case is to be disclosed, on the “business type” basis and the “company” basis.

For example, it is assumed that companies A, B, C, and D exist as companies corresponding to “pharmaceutical”, companies E, F, G, and H exist as companies corresponding to “chemistry”, and companies I, J, K, and L exist as companies corresponding to “electrical equipment”.

In this case, “company A” to “company D” are indicated to be included in the business type “pharmaceutical”, and check boxes respectively corresponding to “pharmaceutical”, “company A”, “company B”, “company C”, and “company D” are presented on the setting screen. Further, “company E” to “company H” are indicated to be included in the business type “chemistry”, and check boxes respectively corresponding to “chemistry”, “company E”, “company F”, “company G”, and “company H” are presented on the setting screen. Further, “company I” to “company L” are indicated to be included in the business type “electrical equipment”, and check boxes respectively corresponding to “electrical equipment”, “company I”, “company J”, “company K”, and “company L” are presented on the setting screen.

For example, it is assumed that the user checks the check boxes respectively corresponding to “pharmaceutical” and “chemistry” and does not check the check box corresponding to “electrical equipment”. In this case, the business type “electrical equipment” is excluded so as not to disclose the case thereto. Further, it is assumed that the check boxes corresponding to companies A to C each belonging to “pharmaceutical” and the check boxes corresponding to companies E to H each belonging to “chemistry” are checked, but the check box corresponding to company D belonging to “pharmaceutical” is not checked. In this case, companies A to C each belonging to “pharmaceutical” and companies E to H each belonging to “chemistry” are each handled as one to which the case is to be disclosed, but company D belonging to “pharmaceutical” is excluded so as not to disclose the case thereto.

### Sideline Database 125

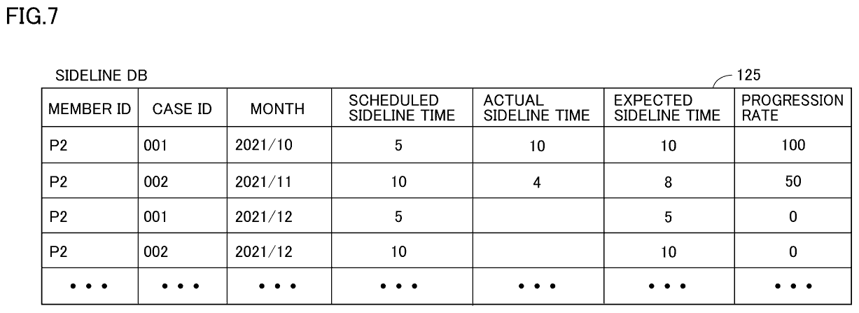

FIG. 7 is a diagram showing an exemplary sideline database 125. In sideline database 125, pieces of information indicating the sideline status of a member are registered on the sideline case basis. The pieces of information indicating the sideline status includes an ID of a member who engages in a sideline, a case ID, a month (period during which the member engages in the sideline), a scheduled sideline time, an actual sideline time, an expected sideline time, and a progression rate.

The scheduled sideline time is a time considered necessary for a member to deal with a case for which an order has been received. The member who has received the order for the sideline inputs the scheduled sideline time from his/her applicant device 300 on the monthly basis. The input scheduled sideline time is reflected in sideline database 125. For example, the estimated man-hours of case 001 are set to 5 hours/man-month in invitation case database 124. This means a workload of 5 hours per person in one month. In general, the member inputs the scheduled sideline time with reference to the estimated man-hours of the invitation case.

The actual sideline time is a time during the member has actually engaged in the case for which the order has been received. In other words, the actual sideline time is a time during which the member has already worked as an actual record. Whenever the member engages in the case for which the order has been received until completion of the business of the case, the member uses his/her own applicant device 300 at any timing so as to input a time during which the member has engaged in the business of the case. In sideline database 125, the cumulative value of the times input by applicant device 300 is registered as the actual sideline time on the monthly basis.

The expected sideline time is a time estimated to be needed for the business of a target case. In other words, the expected sideline time is a time expected as a future work time of the member. Sharing server 100 automatically sets the expected sideline time in consideration of the scheduled sideline time and the actual sideline time. The member may be allowed to input the expected sideline time at any timing by his/her applicant device 300 until the business of the target case is completed. Moreover, the member may be allowed to correct the expected sideline time automatically set. The expected sideline time is desirably equal to or less than the scheduled sideline time. However, depending on a situation of the case, there is a possibility that the expected sideline time becomes longer than the scheduled sideline time. The member who engages in the case may be able to update the expected sideline time at any timing until the business of the case is completed.

The progression rate indicates a degree of progression of a sideline. The progression rate is input in accordance with judgment of the person engaging in the sideline. The progression rate is input between 0(%) and 100(%), for example.

For example, when the member has received an order for a certain case, the progression rate is initially 0%, the actual sideline time is initially 0 hour, and the scheduled sideline time and the expected sideline time coincide with each other. The expected sideline time is changed in conjunction with the member proceeding with the business of the case and the member inputting the actual sideline time and the progression rate.

In sideline database 125 shown in FIG. 7, data of sidelines of a member P2 in October, 2021 to December, 2021 are shown. Referring to sideline database 125 shown in FIG. 7, it is understandable that member P2 has engaged in a case 001 and a case 002 between October, 2021 and December, 2021.

As the data of October of case 001, the scheduled sideline time=5, the actual sideline time=10, and the expected sideline time=10 are registered in sideline database 125. In view of this, it is understandable that member P2 has engaged in case 001 to exceed the scheduled sideline time in October.

As the data of November of case 002, the scheduled sideline time=10, the actual sideline time=4, and the expected sideline time=8 are registered in sideline database 125. In view of this, it is understandable that member P2 has engaged in case 002 without exceeding the set expected sideline time in November. Since the progression rate is 50, it is understandable that member P2 has completed the half of the whole of the business of case 002 in November.

As the data of December of case 001, the scheduled sideline time=5 and the expected sideline time=5 are registered in sideline database 125, and the actual sideline time is not registered. Similarly, the actual sideline time is not registered as the data of December of case 002. These mean that each of the actual sideline times is yet to be input by member P2.

Sharing server 100 uses the expected sideline time and the actual sideline time in sideline database 125 so as to calculate a remaining capacity that the member can additionally do a sideline. When the member engages in a plurality of sidelines, sharing server 100 calculates a “total expected sideline time”, which is the sum of expected sideline times corresponding to the plurality of sidelines, and a “total actual sideline time”, which is the sum of actual sideline times corresponding to the plurality of sidelines. Sharing server 100 calculates the remaining capacity for sideline by calculating “the upper-limit sideline time—(the total expected sideline time+the total actual sideline time)”. Here, when “the total expected sideline time+the total actual sideline time” is defined as the “total sideline time”, the remaining capacity for sideline, i.e., the “permissible sideline time” is calculated as follows: “the upper-limit sideline time-the total sideline time”. For example, the total expected sideline time, which is the sum of the expected sideline times of member P2, in December, is 15 hours (5 hours+10 hours) in sideline database 125 shown in FIG. 7. Moreover, the total actual sideline time of member P2 in December is zero. On this occasion, assuming that the “upper-limit sideline time” determined by the company to which member P2 belongs is 30 hours, the remaining capacity (permissible sideline time) of member P2 for sideline is calculated as 15 hours (30 hours−15 hours).

Here, an exemplary, more specific calculation procedure for the expected sideline time will be described. For example, the “expected sideline time” may be calculated based on the following calculation formula: “(a man-hour progression rate/the progression rate) ×the scheduled sideline time-the actual sideline time”. Here, the “man-hour progression rate” is calculated as follows: “the actual sideline time/the scheduled sideline time”. The “progression rate” is a rate input to sideline database 125 in accordance with the judgment of the person who engages in the sideline as described above.

For example, when the scheduled sideline time=10 hours and the actual sideline time=2 hours, the man-hour progression rate is calculated to be 20%. Here, it is assumed that the progression rate is 40%. On this occasion, the expected sideline time is calculated as “(20%/40%)×10 hours−2 hours”=3 hours. That is, in accordance with the calculation result, the expected sideline time for the target sideline is 3 hours.

### Evaluation Input Database 126

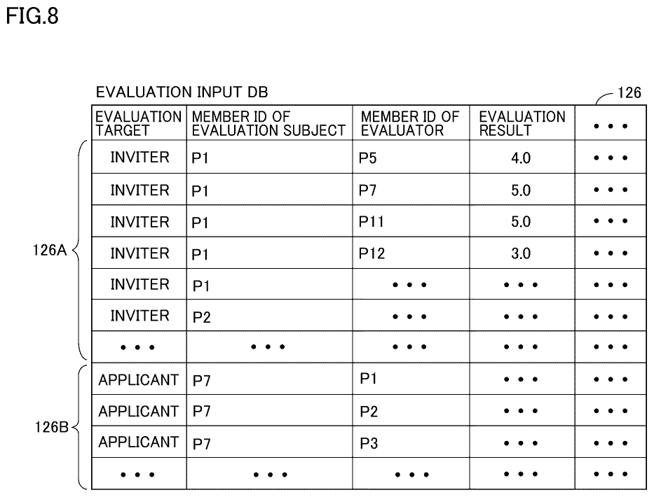

FIG. 8 is a diagram showing an exemplary evaluation input database 126. In evaluation input database 126, pieces of information of evaluations for evaluation subjects are registered. The information of each of the evaluations includes an evaluation target, a member ID of an evaluation subject, a member ID of an evaluator, and an evaluation result.

Evaluation input database 126 includes an inviter evaluation portion 126A and an applicant evaluation portion 126B. In inviter evaluation portion 126A, pieces of information of evaluations for inviters (order placers) are registered. In applicant evaluation portion 126B, pieces of information of evaluations for applicants (order receivers) are registered.

In inviter evaluation portion 126A, an inviter (order placer) corresponds to the evaluation target (evaluation subject), and an applicant who has applied for an invitation business of the evaluation target and has received an order for the business corresponds to the evaluator. In inviter evaluation portion 126A, an evaluation for an evaluation subject is registered on the evaluator basis. FIG. 8 shows an example in which each of members P1, P2 corresponding to the evaluation subjects is evaluated by all the evaluator members. In particular, FIG. 8 shows an example in which member P1 is evaluated by each of evaluator members P5, P7, P11, P12. Each of evaluation results (evaluation values) is represented by a numerical value with the maximum value of the evaluation result being 10 and the minimum value of the evaluation result being 0.

In applicant evaluation portion 126B, the evaluation target (evaluation subject) corresponds to an applicant (order receiver) for an invitation case, and the evaluator corresponds to an inviter (order placer) for the case. In applicant evaluation portion 126B, an evaluation for the evaluation subject is registered on the evaluator basis. FIG. 8 shows an example in which member P7 corresponding to the evaluation subject is evaluated by members P1, P2, P3 corresponding to the evaluators. Various evaluation results are registered in applicant evaluation portion 126B in the same manner as in inviter evaluation portion 126A.

When an applicant (order receiver) completes a business for which an order has been received from an inviter (order placer), the applicant (order receiver) uses applicant device 300 to evaluate, as an evaluator, the evaluation subject who is the inviter. An evaluation result by the evaluator is registered into evaluation input database 126. When a certain applicant receives an order of another business again from an inviter from whom the applicant has received an order for a business, the applicant evaluates the inviter again. In this case, the average value of the previous evaluation result and the subsequent evaluation result is registered into evaluation input database 126.

When the applicant (order receiver) completes the business offered to the applicant (order receiver), the inviter (order placer) uses inviter device 200 to evaluate, as the evaluator, the evaluation subject who is the applicant. An evaluation result by the evaluator is registered into evaluation input database 126. When a certain inviter places an order for another business again to an applicant to whom a business has been offered, the inviter evaluates the applicant again. In this case, the average value of the previous evaluation result and the subsequent evaluation result is registered into evaluation input database 126.

Therefore, the average value of the evaluations made for the evaluation subject by the evaluator is reflected in each of the evaluation results registered in evaluation input database 126. It should be noted that instead of the average value, a weighted average value, a deviation value, or the like calculated in accordance with the number of evaluations may be employed. An evaluation result on the case ID basis may be further registered into evaluation input database 126.

### Evaluation Summary Database 127

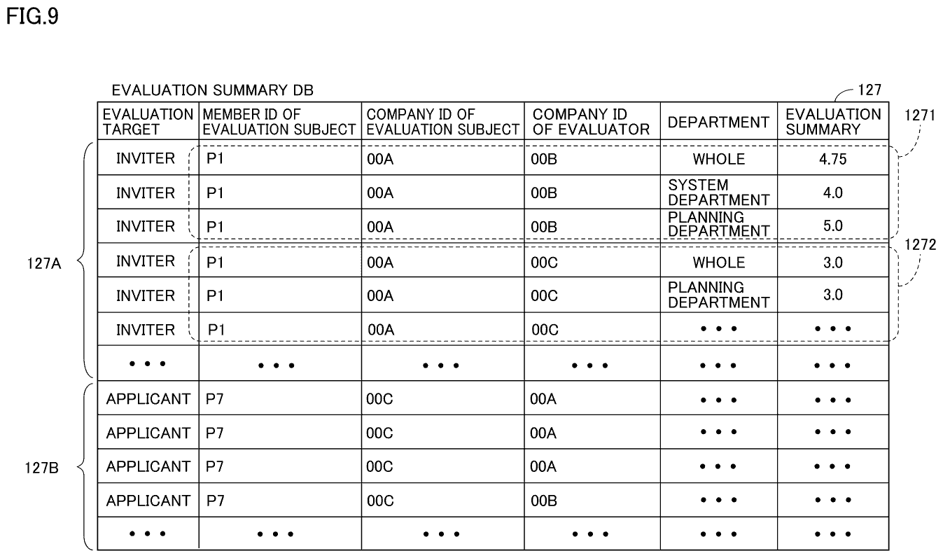

FIG. 9 is a diagram showing an exemplary evaluation summary database 127. In evaluation summary database 127, pieces of information of evaluations for evaluation subjects on the department basis are registered. The information of each of the evaluations on the organization basis includes an evaluation target, a member ID of the evaluation subject, an ID of a company to which the evaluation subject belongs, an ID of the company to which the evaluator belongs, a department to which the evaluator belongs, and an evaluation summary.

Evaluation summary database 127 includes an inviter evaluation summary portion 127A and an applicant evaluation summary portion 127B. In inviter evaluation summary portion 127A, the evaluation target (evaluation subject) corresponds to an inviter (order placer). In applicant evaluation summary portion 127B, the evaluation target (evaluation subject) corresponds to an applicant (order receiver). In evaluation summary database 127, evaluation summaries for evaluation targets are registered on the department basis.

Each of the evaluation summaries is calculated based on an aggregation result of evaluation input database 126. A category for department includes: each of departments such as “system department” and “planning department” belonging to a company; and “whole”, which means the whole of the company. The evaluation summary is calculated on such a “department” basis.

For inviter evaluation summary portion 127A, FIG. 9 shows an example in which member P1 corresponds to the evaluation subject. The company ID of the evaluation subject is “00A”. Therefore, member P1 belongs to company A. In FIG. 9, a data group 1271 represents evaluations made by company B for member P1 who behaves as an inviter, and a data group 1272 represents evaluations made by company C for member P1 who behaves as an inviter.

Referring to data group 1271, it is understandable that the evaluations by company B are classified into an evaluation by the whole of the company, an evaluation by the system department in company B, and an evaluation by the planning department in company B. In the evaluation summary, the average value of the evaluations corresponding to each of the classified categories is registered.

For example, as an evaluation summary corresponding to the whole of company B, the average value of evaluation results by the members of company B who have evaluated member P1 who behaves as an inviter is registered. In FIG. 9, the value is “4.75”. As an evaluation summary corresponding to the system department, the average value of evaluation results by the members who belong to the system department among the members of company B and who have evaluated member P1 who behaves as an inviter is registered. In FIG. 9, the value is “4.0”. As an evaluation summary corresponding to the planning department, the average value of evaluation results by the members who belong to the planning department among the members of company B and who have evaluated member P1 who behaves as an inviter is registered. In FIG. 9, the value is “5.0”.

In data group 1272, the evaluations by company C are classified into an evaluation by the whole of the company and evaluations by the respective departments in company C as in data group 1271. Each of data groups 1271, 1272 is data for evaluating the inviter. Therefore, the evaluation summaries registered in data groups 1271, 1272 are inviter evaluation summaries.

Inviter evaluation summary portion 127A has been described in detail above. Next, applicant evaluation summary portion 127B will be described. For applicant evaluation summary portion 127B, FIG. 9 shows an example in which member P7 corresponds to the evaluation subject. The company ID of the evaluation subject is “00C”. Therefore, member P7 belongs to company C. In applicant evaluation summary portion 127B, evaluations for member P7 who behave as an applicant are registered on the department basis.

Applicant evaluation summary portion 127B has the same structure as that of inviter evaluation summary portion 127A except that the evaluation target is not the “inviter” but the “applicant”. Therefore, here, the above-described explanation of inviter evaluation summary portion 127A applies to the explanation of applicant evaluation summary portion 127B.

Sharing server 100 specifies the evaluation result for each member using evaluation input database 126, and specifies where the member belongs using member database 122. Sharing server 100 updates the data of evaluation summary database 127 based on the results of specifying them.

It should be noted that FIG. 9 shows members P1, P7 as the evaluation subjects; however, each of members P2 to P6, P8, and P9 . . . is also registered in evaluation summary database 127 as an evaluation subject. Evaluation summary database 127 may include data in which a certain member is evaluated as an inviter and an applicant. For example, in evaluation summary database 127 shown in FIG. 9, the applicant evaluation summary for member P1 may be registered in addition to the inviter evaluation summary for member P1.

### Functions of Sharing Server, Inviter Device, and Applicant Device

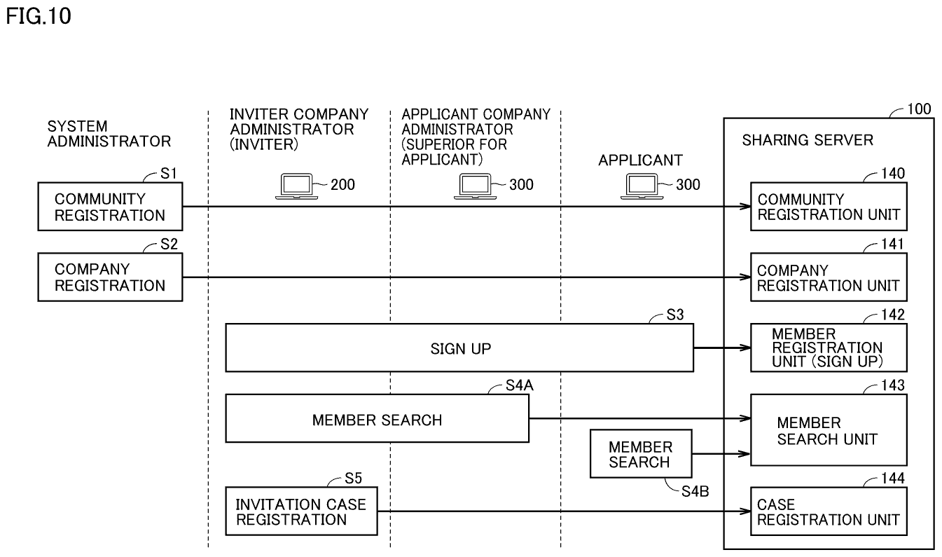

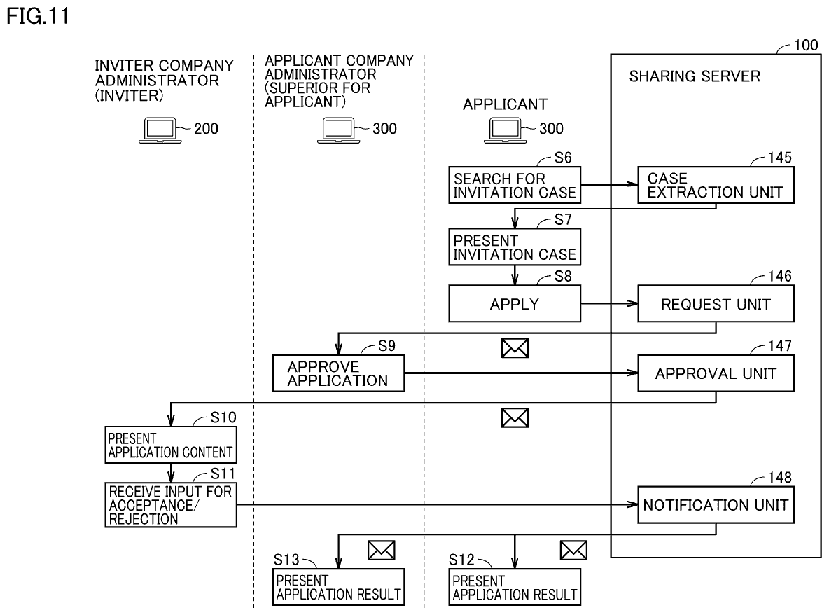

Each of FIGS. 10 to 12 is a diagram for illustrating functions of the sharing server, the inviter device, and the applicant device.

As shown in FIG. 10, sharing server 100 functionally includes a community registration unit 140, a company registration unit 141, a member registration unit 142, a member search unit 143, and a case registration unit 144. These various functions are realized by processor 101, memory 102, storage 103, and communication interface 104 included in sharing server 100.

Community registration unit 140 has a function of registering a community into community database 123. A system administrator who manages matching system 1 inputs information about the community into sharing server 100 using the operation unit such as a keyboard.

The information about the community includes a community name and information of a company belonging to the community. Community registration unit 140 registers the community into community database 123 in accordance with the input from the system administrator (step S1). Community registration unit 140 further has a function of updating information of a community registered in community database 123.

Company registration unit 141 has a function of registering a new company to participate in matching system 1. The system administrator inputs information about the company into sharing server 100 using the operation unit such as a keyboard.

The information about the company includes information such as a company name, an address, and an upper-limit sideline time. Company registration unit 141 registers the company into company database 121 in accordance with the input from the system administrator (step S2). Company registration unit 141 further has a function of updating information of a company having been already registered.

Member registration unit 142 has a function of registering (signing up) a new member to participate in matching system 1. Member registration unit 142 issues a member ID and a password in response to a request from one belonging to a company participating in matching system 1. One who would like to become a member performs a sign-up process using a personal computer or the like (step S3).

Specifically, one who would like to become a member inputs information into the personal computer or the like such as a name, a company to which he/she belongs, and a department to which he/she belongs, and transmits the input information to sharing server 100. Member registration unit 142 registers the input information into member database 122. The new member can sign in to sharing server 100 using the personal computer used for the member registration. In this case, the personal computer functions as inviter device 200 or applicant device 300.

FIG. 10 shows two applicant devices 300. One applicant device is a device assumed to be operated by an administrator of the applicant company. The other applicant device is a device assumed to be operated by a person other than the administrator in the applicant company. The administrator of the applicant company is engaged in a manager job such as a department director, and corresponds to a superior for the applicant who is a subordinate. In the present embodiment, the administrator of the applicant company plays a role as an approver who approves an application made for an invitation case by the subordinate.

Member search unit 143 has a function of searching for a member of matching system 1. In response to a request from each of inviter device 200 and applicant device 300, member search unit 143 provides a corresponding one of inviter device 200 and applicant device 300 with information of a member registered in member database 122.

When receiving a search operation from the inviter, inviter device 200 performs a member search process (step S4A). Thus, the inviter can view, for example, pieces of information of applicants. From the plurality of applicants, the inviter can select a person on whom the order for the business is to be placed, in consideration of the pieces of information of the applicants. Similarly, when receiving a search operation from an administrator corresponding to a superior for a certain applicant, applicant device 300 performs a member search process (step S4A).

Further, when receiving a search operation from the applicant, applicant device 300 performs a member search process (step S4B). Thus, the applicant can view, for example, pieces of information of inviters. From a plurality of invitation businesses, the applicant can select a business desired to receive an order, in consideration of the pieces of information of the inviters.

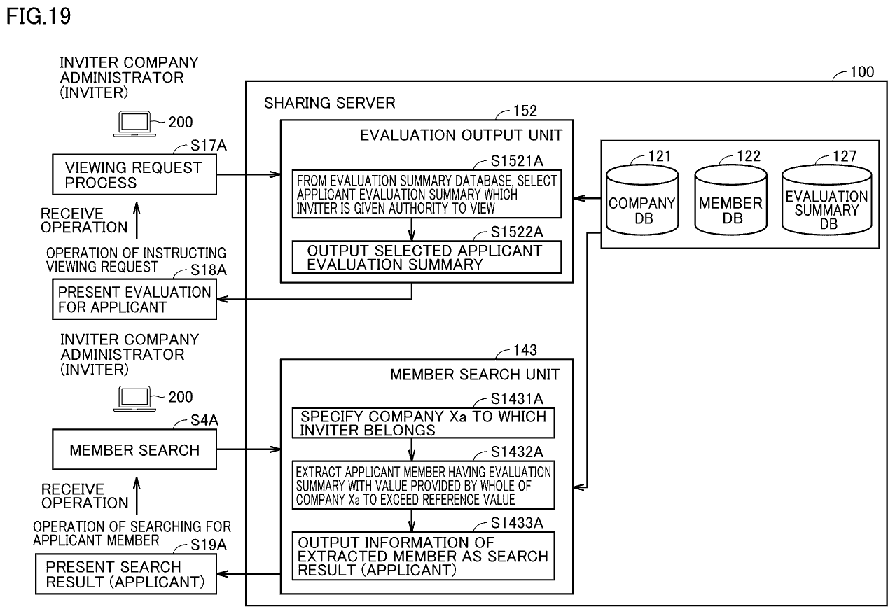

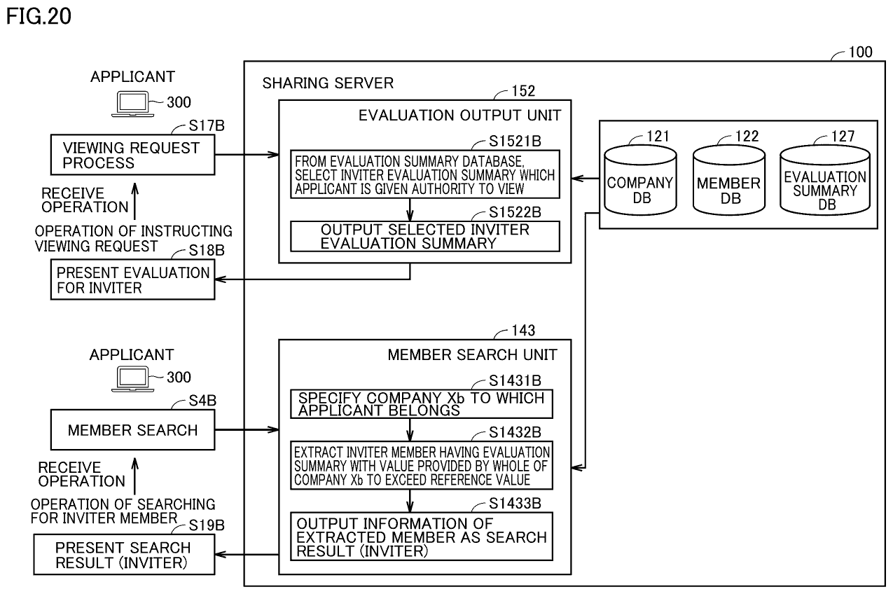

The member search process (step S4A) performed by inviter device 200 and the process of member search unit 143 will be described in detail later with reference to FIG. 19. The member search process (step S4B) performed by applicant device 300 and the process of member search unit 143 will be described in detail later with reference to FIG. 20.

Case registration unit 144 has a function of registering an invitation case into invitation case database 124. When receiving an operation of inputting an invitation case, inviter device 200 performs a process of registering the invitation case (step S5). In the process of registering the invitation case, inviter device 200 transmits information of the invitation case to sharing server 100. Case registration unit 144 registers the received information of the invitation case into invitation case database 124.

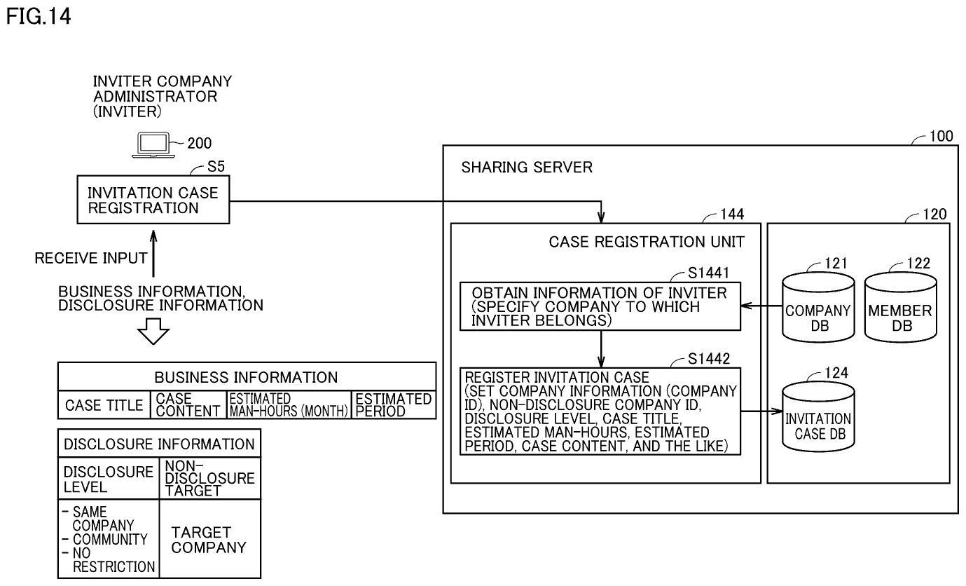

The invitation case registration process (step S5) performed by inviter device 200 and the process of case registration unit 144 will be described in detail later with reference to FIG. 14.

As shown in FIG. 11, sharing server 100 functionally includes a case extraction unit 145, a request unit 146, an approval unit 147, and a notification unit 148. These various functions are realized by processor 101, memory 102, storage 103, and communication interface 104 included in sharing server 100.

Case extraction unit 145 has a function of extracting an invitation case that can be viewed by an applicant. Request unit 146 has a function of requesting an administrator (superior for an applicant) to approve an application from the applicant. Approval unit 147 has a function of transmitting the content of the application for the invitation case to the inviter on condition that the approval of the application is received from the administrator (approver). Notification unit 148 has a function of receiving, from the inviter, a result as to whether to accept the applicant and notifying the result to the applicant and the administrator.

Request unit 146, approval unit 147, and notification unit 148 realize, by a workflow system, the notification for requesting the administrator for approval, the notification for notifying the applicant to the inviter, and the notification for notifying the application result to the applicant.

When an operation by the applicant for requesting a search for invitation case is received, applicant device 300 performs a search process for invitation case (step S6). In the search process for invitation case, applicant device 300 transmits a search request to case extraction unit 145 of sharing server 100.

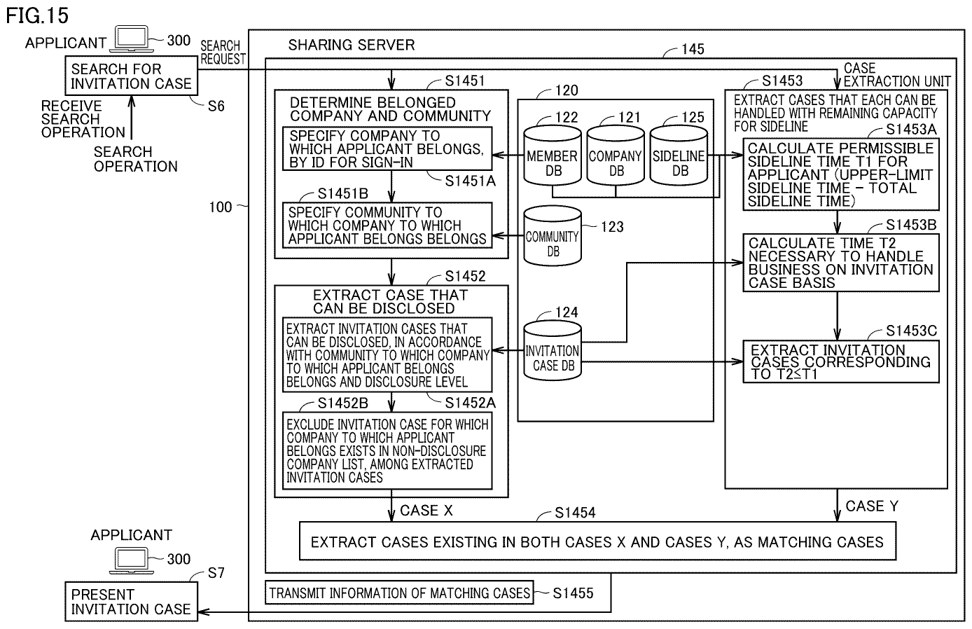

When the search request is received, case extraction unit 145 extracts cases each permitted to be viewed by the applicant from the invitation cases registered in invitation case database 124, and transmits the extracted cases to applicant device 300. Based on a first criterion and a second criterion, case extraction unit 145 determines that each of the cases is permitted to be viewed by the applicant. The first criterion is a scope of disclosure set in the invitation case. The second criterion is a remaining capacity of the applicant for sideline. The scope of disclosure is determined by disclosure information shown in FIG. 14. The remaining capacity for sideline is calculated as a permissible sideline time shown in FIG. 15.

Case extraction unit 145 determines the cases each satisfying both the first criterion and the second criterion, as the cases permitted to be viewed by the applicant. Therefore, case extraction unit 145 extracts, from the invitation cases registered in invitation case database 124, cases each permitted to be disclosed to the applicant having transmitted the search request. Further, from the invitation cases registered in invitation case database 124, case extraction unit 145 extracts cases that can be handled with the permissible sideline time of the applicant who has transmitted the search request. Case extraction unit 145 transmits, to applicant device 300, the cases each permitted to be viewed by the applicant.

Case extraction unit 145 may be configured to receive an operation of setting a criterion for extracting a case. For example, sharing server 100 may be provided with a function that allows the system administrator to select one of a first setting that enables the first criterion, a second setting that enables the second criterion, and a third setting that enables both the first criterion and the second criterion.

Applicant device 300 receives the invitation cases from case extraction unit 145. Applicant device 300 presents the received invitation cases on display 305 (step S7).

It should be noted that the invitation case search process (step S6), the process of presenting the invitation cases (step S7), and the process of case extraction unit 145 will be described in detail later with reference to FIG. 15.

The applicant performs an operation of selecting a case for which an application is to be made, from the invitation cases presented on display 305 in applicant device 300. Applicant device 300 performs an application process in response to the operation from the applicant (step S8). In the application process, applicant device 300 transmits, to request unit 146 of sharing server 100, application information indicating the case for which the application is to be made. Thus, applicant device 300 transmits, to request unit 146, a request for reception of order for the business.

Request unit 146 transmits, to applicant device 300 of the administrator (superior for the applicant), the application information received from applicant device 300. For example, request unit 146 specifies the member ID of the superior, who is the administrator for the applicant, based on a relationship between the member ID of the applicant and the member ID of the superior as registered in member database 122. Request unit 146 transmits, to applicant device 300 corresponding to the specified member ID of the superior, the application information received from the subordinate. In applicant device 300 of the administrator, the administrator checks the business for which the subordinate applies. In applicant device 300, the administrator performs an operation for approving the application. Applicant device 300 receives an approval operation and performs an application approval process (step S9). In the application approval process, applicant device 300 transmits approval information to approval unit 147 of sharing server 100. Thus, the approval information, which serves as an exemplary approval notification, is transmitted from applicant device 300 of the administrator (approver) to approval unit 147.

Approval unit 147 receives the application from the applicant on condition that the approval information is received from applicant device 300. In this way, in the present embodiment, the application from the applicant is received on condition that the approval is made by the administrator for the applicant. Therefore, the administrator can beforehand check the content of the invitation business for which the application is to be made by the subordinate. As a result, it is possible to prevent confidential information from being leaked to the outside of the company through the action of the employee for the sideline.

It should be noted that FIG. 11 shows a flow when the administrator approves the application. If an operation of turning down the application is received in step S9, turndown information is transmitted from applicant device 300 of the administrator to approval unit 147. When the turndown information is received, approval unit 147 may notify applicant device 300 of the applicant that the application has been turned down.

Approval unit 147 having received the application from the applicant transmits the application information to inviter device 200. The application information includes the information of the applicant and the content of the business for which the application is made. Inviter device 200 presents the content of the application on display 205 (step S10). Based on the presentation on display 205, the inviter checks the applicant and the business for which the application is made, and determines whether to accept the applicant.

The inviter inputs, to inviter device 200, a result of determination for acceptance or rejection. Inviter device 200 receives the input result (step S11). Inviter device 200 transmits the received result of acceptance or rejection to notification unit 148 of sharing server 100.

When the result of acceptance or rejection is received from inviter device 200, notification unit 148 transmits the application result (result of acceptance or rejection) to each of applicant device 300 of the applicant and applicant device 300 of the administrator.

Each of applicant device 300 of the applicant and applicant device 300 of the administrator presents the applicant result on display 305 (steps S12, S13). Each of the applicant and the administrator checks the application result by viewing the presentation on display 305.

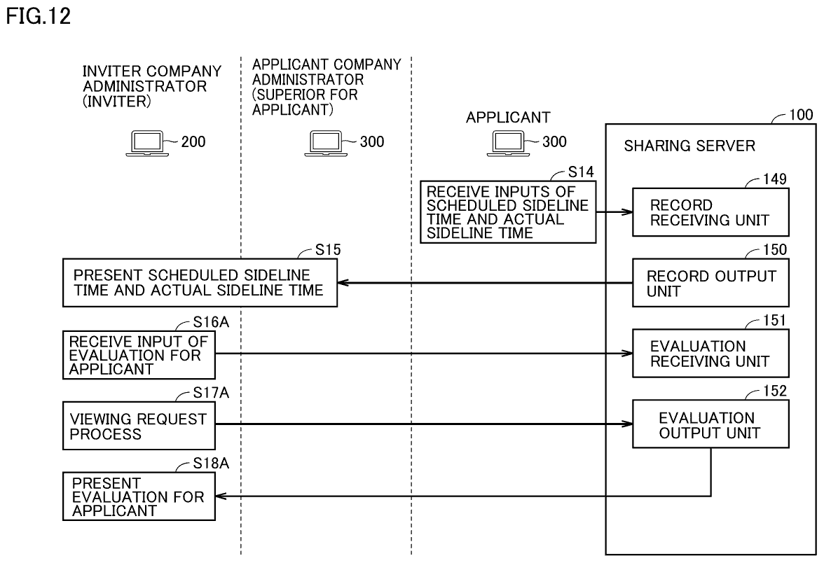

As shown in FIG. 12, sharing server 100 functionally includes a record receiving unit 149, a record output unit 150, an evaluation receiving unit 151, and an evaluation output unit 152 (herein “receiver” means the same as “receiving unit”). These various functions are realized by processor 101, memory 102, storage 103, and communication interface 104 included in sharing server 100.

Record receiving unit 149 has a function of receiving a scheduled sideline time and an actual sideline time input by an applicant in applicant device 300. Record output unit 150 has a function of outputting information including the scheduled sideline time and the actual sideline time of the applicant to inviter device 200 or applicant device 300 of the administrator.

Evaluation receiving unit 151 has a function of receiving an evaluation for an applicant (order receiver) as input by an inviter in inviter device 200. Evaluation output unit 152 has a function of outputting information indicating the evaluation for the applicant to inviter device 200.

When the applicant engages in a sideline, the applicant inputs a scheduled sideline time and an actual sideline time to applicant device 300. Normally, the applicant inputs a scheduled sideline time to applicant device 300 when an order for a new sideline is received, and inputs an actual sideline time to applicant device 300 at any timing while engaging in the sideline. For example, when an order is received as a sideline for a business for which an estimated period is a plurality of months, the applicant inputs an actual sideline time to applicant device 300 on the monthly basis.

Applicant device 300 receives inputs of the scheduled sideline time and the actual sideline time (step S14). Applicant device 300 transmits the received scheduled sideline time and actual sideline time to record receiving unit 149 of sharing server 100.

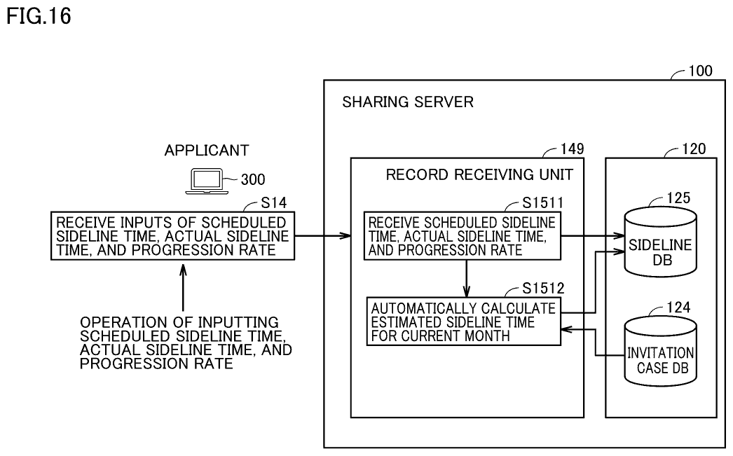

Record receiving unit 149 registers the received scheduled sideline time and the received actual sideline time into sideline database 125. The process of step S14 performed by applicant device 300 and the process of record receiving unit 149 will be described in detail later with reference to FIG. 16.

Record output unit 150 transmits the scheduled sideline time and the actual sideline time registered in sideline database 125 to inviter device 200 and applicant device 300 of the administrator. Inviter device 200 presents the received information including the scheduled sideline time and the actual sideline time on display 205, and applicant device 300 of the administrator presents the received information including the scheduled sideline time and the actual sideline time on display 305 (step S15). However, when the information transmitted to inviter device 200 is compared with the information transmitted to applicant device 300 of the administrator, the cases for transmission are different.

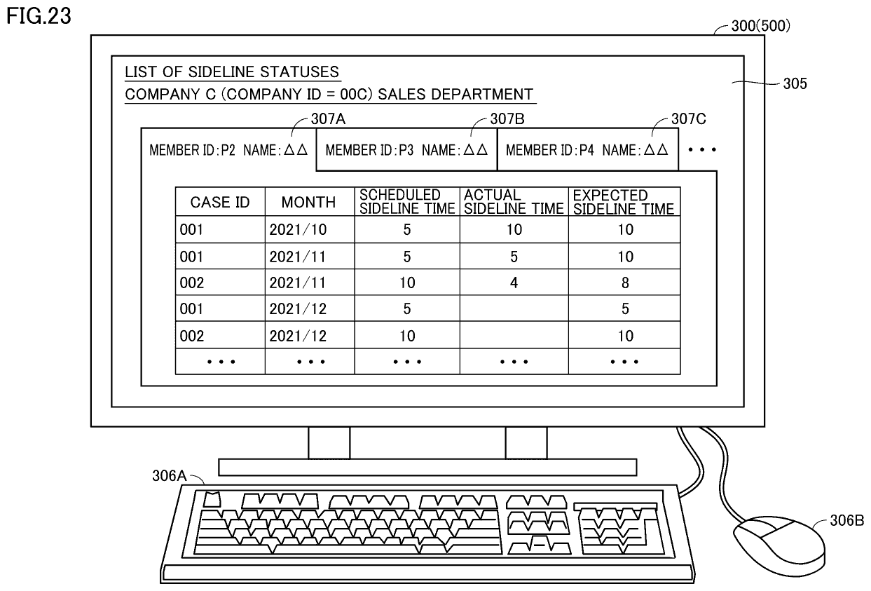

Data corresponding to the case handled by the subordinate among many cases registered in sideline database 125 is transmitted from record receiving unit 149 to applicant device 300 of the administrator. The administrator can see display 305 so as to check the sideline status of the subordinate. It should be noted that a screen presented on applicant device 300 of the administrator when the administrator checks the sideline status of the subordinate will be described later with reference to FIG. 23.

Data corresponding to the case for which an invitation is made by the inviter among many cases registered in sideline database 125 is transmitted from record receiving unit 149 to inviter device 200. For example, assume that a first inviter makes an invitation for a case 001 and a second inviter makes an invitation for a case 002 among a plurality of inviters in sideline database 125 shown in FIG. 7.

In this case, various types of data corresponding to case 001 in sideline database 125 are transmitted from record receiving unit 149 to inviter device 200 operated by the first inviter. Various types of data corresponding to case 002 in sideline database 125 are transmitted from record receiving unit 149 to inviter device 200 operated by the second inviter.

Each of the first inviter and the second inviter can check the progression status of his/her case by viewing the scheduled sideline time, the actual sideline time, and the like presented on display 305 of inviter device 200.

The inviter inputs an evaluation for the applicant to inviter device 200 when the sideline is completed. Inviter device 200 receives input of the evaluation for the applicant (step S16A). Therefore, inviter device 200 functions as an evaluator device operated by the evaluator (inviter) when receiving the input evaluation.

Inviter device 200 transmits the received evaluation to evaluation receiving unit 151 of sharing server 100. Evaluation receiving unit 151 updates evaluation input database 126 and evaluation summary database 127 based on the received evaluation. Thus, the information of applicant evaluation portion 126B is updated in evaluation input database 126, and the information of applicant evaluation summary portion 127B is updated in evaluation summary database 127.

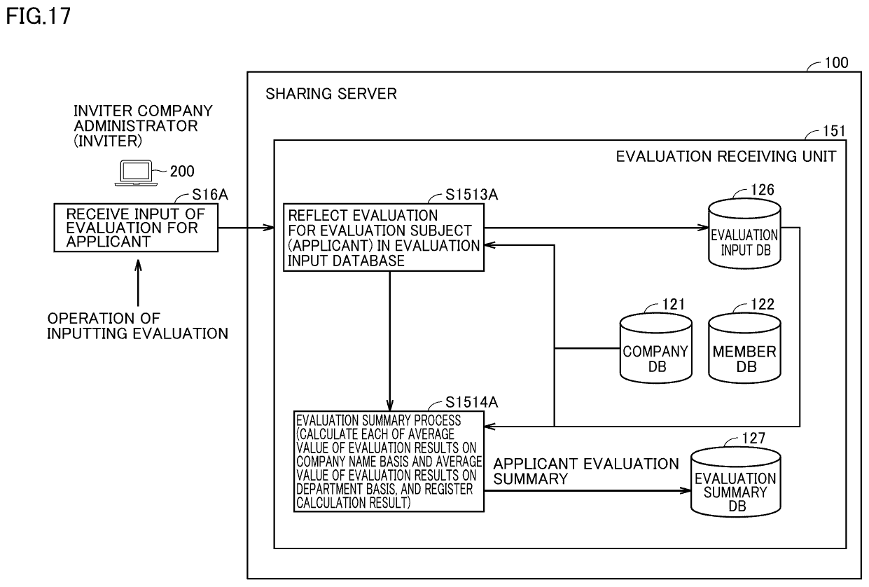

The process of step S16A performed by inviter device 200 and the process of evaluation receiving unit 151 will be described in detail later with reference to FIG. 17.

When an operation for allowing the inviter to view an evaluation for the applicant is received, inviter device 200 performs a viewing request process (step S17A). In the viewing request process, inviter device 200 transmits a viewing request to evaluation output unit 152 of sharing server 100. In response to the viewing request, evaluation output unit 152 transmits, to inviter device 200, the evaluation for the applicant as registered in evaluation summary database 127 (applicant evaluation summary). Inviter device 200 presents the received evaluation for the applicant on display 205 (step S18A).

The processes of steps S17A, S18A performed by inviter device 200 and the process of evaluation output unit 152 will be described in detail later with reference to FIG. 19.

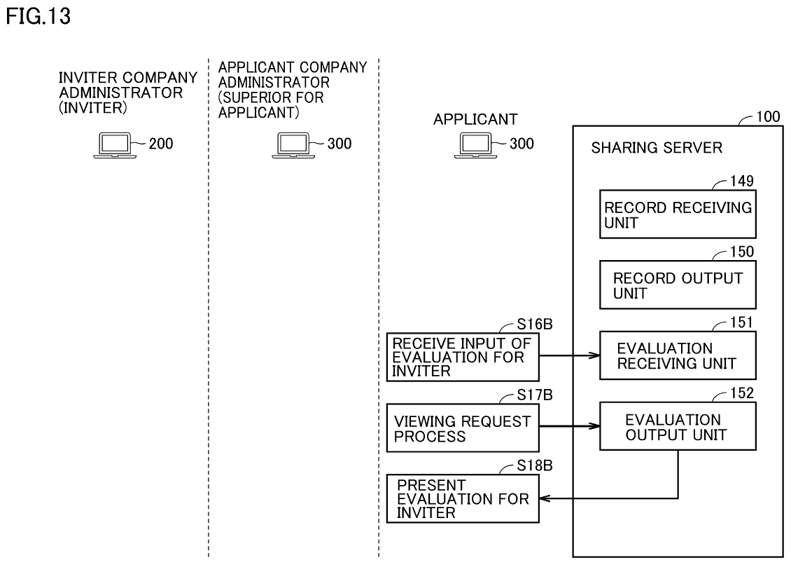

FIG. 13 is a diagram for further illustrating the function of applicant device 300. Here, input and output of an evaluation for the inviter will be described with reference to FIG. 13. Evaluation receiving unit 151 further has a function of receiving the evaluation for the inviter as input by the applicant in applicant device 300. Evaluation output unit 152 further has a function of outputting information indicating the evaluation for the inviter to applicant device 300. When the business for which the order has been received is completed, the applicant inputs the evaluation for the inviter into applicant device 300. The applicant evaluates the inviter based on various points.

For example, when the applicant could communicate with the inviter without trouble and complete the business in an appropriate time, the applicant gives the inviter a high magnitude of evaluation. Conversely, the applicant gives the inviter a low magnitude of evaluation when there are frequent requests to add, change, and correct the content of the business, when too many man-hours are needed outside the scope of the business, when communication for instruction is too slow, and when the inviter unilaterally makes an instruction without consulting in advance with regard to correction of the content of the business.

Applicant device 300 receives input of the evaluation for the inviter (step S16B). Therefore, applicant device 300 functions as an evaluator device operated by the evaluator (applicant) when receiving the input evaluation.

Applicant device 300 transmits the received evaluation to evaluation receiving unit 151 of sharing server 100. Evaluation receiving unit 151 updates evaluation input database 126 and evaluation summary database 127 based on the received evaluation. Thus, the information of inviter evaluation portion 126A is updated in evaluation input database 126, and the information of inviter evaluation summary portion 127A is updated in evaluation summary database 127.

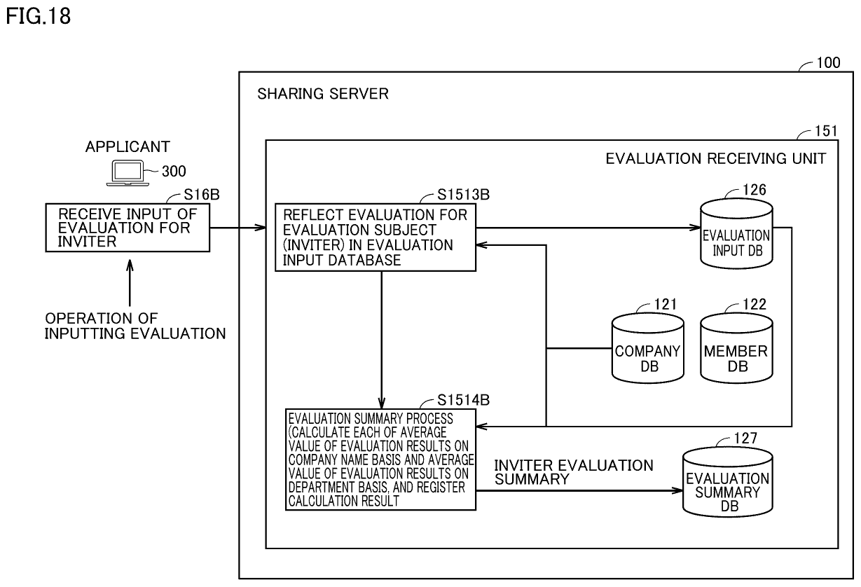

The process of step S16B performed by applicant device 300 and the process of evaluation receiving unit 151 will be described in detail later with reference to FIG. 18.

When an operation by the applicant for viewing an evaluation for an inviter is received, applicant device 300 performs a viewing request process (step S17B). In the viewing request process, inviter device 200 transmits a viewing request to evaluation output unit 152 of sharing server 100. In response to the viewing request, evaluation output unit 152 transmits, to applicant device 300, the evaluation for the inviter as registered in evaluation summary database 127 (inviter evaluation summary). Applicant device 300 presents the received evaluation for the inviter on display 305 (step S18B).

The processes of steps S17B, S18B performed by applicant device 300 and the process of evaluation output unit 152 will be described in detail later with reference to FIG. 20.

### Details of Processes of Case Registration Unit 144 and Inviter Device 200

FIG. 14 is a diagram for illustrating a procedure of registering an invitation case into invitation case database 124. Step S5 and the function of case registration unit 144 in FIG. 10 will be described more in detail with reference to FIG. 14.

An inviter to register an invitation case first signs in to sharing server 100 using inviter device 200. Thus, a logical communication path identified by the member ID of the inviter is established between inviter device 200 and sharing server 100. Then, the inviter inputs business information and disclosure information of the invitation case into inviter device 200 using operation unit 206 such as a mouse and a keyboard.

The information input by operation unit 206 is notified to processor 201 via input/output interface 204 of inviter device 200. Operation unit 206 and input/output interface 204 constitute an interface that receives an operation of inputting the content of a business and an operation of inputting disclosure information that designates a target to which the business is to be disclosed.

The business information of the invitation case includes a case title, a case content, an estimated man-hour (man-month), and an estimated period. The disclosure information includes a disclosure level. In accordance with a selection by the inviter, the disclosure information may include the ID of a company that is a non-disclosure target.

Inviter device 200 receives the input of the business information and the disclosure information of the invitation case, and performs a process of registering the invitation case (step S5). In the process of registering the invitation case, inviter device 200 transmits the business information and the disclosure information of the invitation case to sharing server 100.

Case registration unit 144 of sharing server 100 obtains the information of the inviter (step S1441). Specifically, case registration unit 144 specifies the company to which the inviter belongs.

When a member signs in to sharing server 100 using inviter device 200 or applicant device 300, sharing server 100 stores the member ID used for the sign-in. When some information is received from inviter device 200 or applicant device 300 in the communication established in accordance with this member ID, sharing server 100 identifies the member, who is the origin of transmission of the information, by the member ID used for the sign-in.

Therefore, when the business information and the disclosure information of the invitation business are received from inviter device 200, case registration unit 144 specifies the inviter, who is operating inviter device 200, by using the member ID used for the sign-in. Case registration unit 144 specifies the member who is the inviter and the company to which the inviter belongs, by using the specified member ID, member database 122, and company database 121.

Next, case registration unit 144 performs a process of registering the invitation case into invitation case database 124 (step S1442). Specifically, after generating a case ID, case registration unit 144 registers the company information (company ID), the ID of a company to which it is not to be disclosed, the disclosure level, the case title, the estimated man-hour, the estimated period, the case content, and the like into invitation case database 124 in association with the generated case ID.

According to the present embodiment, the inviter can freely control the scope of disclosure of the invitation case to fall within the following level: “within own company”, “within community”, or “no restriction”. As a result, an invitation case unintended by the inviter can be hindered from being disclosed to a specific company.

According to the present embodiment, the company to which disclosure is not to be made can be set separately from the disclosure level. Therefore, the inviter can set the scope of disclosure while excluding a part of companies among the plurality of companies each having a community relationship with the company to which the inviter belongs. As a result, a business related to a specific company in the community can be prevented from being disclosed to the specific company.

Instead of or in addition to the non-disclosure company ID list, a non-disclosure member ID list for registering a member ID to prohibit the invitation case from being disclosed thereto may be provided in invitation case database 124. Inviter device 200 may receive an operation of designating a member to whom the invitation case is prohibited from being disclosed, and may transmit the ID of the member to sharing server 100. Sharing server 100 may be configured not to provide the member corresponding to the member ID listed in the non-disclosure member ID list with the invitation case corresponding to the list. Thus, inviter device 200 may receive either a company or a member as a target to which/whom the business is prohibited from being disclosed.

FIG. 15 is a diagram for illustrating a procedure of searching for an invitation case in database 120. The processes of steps S6, S7 and the function of case extraction unit 145 in FIG. 11 will be described more in detail with reference to FIG. 15.

When an operation by the applicant for requesting a search for invitation case is received, applicant device 300 performs a search process for invitation case (step S6). In the search process for invitation case, applicant device 300 transmits a search request to case extraction unit 145 of sharing server 100.

When the search request is received, case extraction unit 145 extracts cases each permitted to be viewed by the applicant from the invitation cases registered in invitation case database 124. To this end, case extraction unit 145 performs processes of steps S1451 to S1454.

Each of steps S1451, S1452 is a process of extracting, based on the scope of disclosure set in each of the invitation cases, cases each permitted to be viewed by the applicant. In step S1451, the company to which the applicant belongs and the community of the company to which the applicant belongs are determined. In step S1452, cases that can be each disclosed are extracted.

Step S1453 is a process of extracting, based on the remaining capacity of the applicant for sideline, cases each permitted to be viewed by the applicant. Step S1454 is a process of extracting cases to be finally matched to the applicant.

### Process of Extracting Cases Based on Scopes of Disclosure

Step S1451 includes a step S1451A and a step S1451B.

In step S1451A, the company to which the applicant belongs is specified based on the member ID used for the sign-in, company database 121, and member database 122.

In step S1451B, the community of the company to which the applicant belongs is specified based on the ID of the company to which the applicant belongs and community database 123.

Step S1452 includes a step S1452A and a step S1452B.

In step S1452A, the invitation cases that can be each disclosed are extracted from invitation case database 124 based on the community to which the company to which the applicant belongs and the disclosure level.

In step S1452B, among the invitation cases extracted in step S1452A, an invitation case for which the company to which the applicant belongs exists in the non-disclosure company list is excluded. Here, cases each extracted by the process of step S1452B will be referred to as cases X.

### Process of Extracting Cases Based on Remaining Capacity for Sideline

Step S1453 includes a step S1453A, a step S1453B, and a step S1453C.

In step S1453A, a permissible sideline time T1 for the applicant is calculated.

The permissible sideline time is found by calculating “the upper-limit sideline time—the total sideline time”. The upper-limit sideline time is a time determined by the company to which the applicant belongs, and is registered in company database 121. The calculated permissible sideline time is registered into member database 122. Case extraction unit 145 may calculate the permissible sideline times of all the members every certain time and may register the calculated permissible sideline times into member database 122.

The total sideline time is calculated by the following calculation formula: “the total expected sideline time+the total actual sideline time” based on the expected sideline time and the actual sideline time registered in sideline database 125. That is, the total sideline time includes not only a time already spent for the sideline but also an expected time not spent by the sideline yet.

In step S1453B, a time T2 necessary to handle the business is calculated on the invitation case basis. Time T2 is calculated based on the estimated man-hour (man-month) and the estimated period registered in invitation case database 124. For example, the time of the estimated man-hour (month) may be employed as time T2. For example, for the invitation case corresponding to case ID 001, 5 hours may be set as the time per month as time T2.

In step S1453C, invitation cases corresponding to “time T2≤permissible sideline time T1” are extracted from invitation case database 124. Here, the cases extracted by the process of step S1453C will be referred to as cases Y.

### Process of Extracting Case Based on Scope of Disclosure and Remaining Capacity for Sideline

Case extraction unit 145 extracts cases X based on the scope of disclosure, extracts cases Y based on the remaining capacity for sideline, and then extracts cases existing in both cases X and cases Y, as matching cases for the applicant (step S1454).

### Process of Providing Extracted Cases

Next, case extraction unit 145 transmits information of the matching cases to applicant device 300 (step S1455). Applicant device 300 receives the matching cases. Applicant device 300 presents the received matching cases as the invitation cases on display 305 in the form of a list (step S7).

Thus, invitation cases that can be said to be appropriate for the applicant from two viewpoints are provided. That is, first, the applicant is provided with invitation cases that can each be handled to such an extent that the upper-limit sideline time of the applicant is not exceeded. Thus, it is possible to prevent the applicant from entering a state of overwork. Second, each of the invitation cases of the inviters is provided to an applicant falling within the scope of disclosure intended by the inviter. Thus, confidential information of the company to which the inviter belongs can be prevented from being leaked to another competitor.

### Process of Registering Scheduled Sideline Time and Actual Sideline Time

FIG. 16 is a diagram for illustrating a procedure of registering the schedule and record of a sideline into database 120. Step S14 and the function of record receiving unit 149 in FIG. 12 will be described more in detail with reference to FIG. 16.

For example, the applicant inputs a scheduled sideline time into applicant device 300 when the applicant receives an order for a new sideline, and inputs an actual sideline time into applicant device 300 at any timing while engaging in the sideline. Applicant device 300 receives the input of the scheduled sideline time (step S14). Applicant device 300 transmits the received scheduled sideline time and actual sideline time to record receiving unit 149 of sharing server 100.

Record receiving unit 149 receives the scheduled sideline time and the actual sideline time of the applicant, and registers the received scheduled sideline time and actual sideline time of the applicant into sideline database 125 (step S1511). As a result, in sideline database 125, the scheduled sideline time and the actual sideline time of the applicant on the monthly basis are registered on the case ID basis.

Normally, after the scheduled sideline time is input by the applicant, the actual sideline time is input by the applicant at the end of the month. For this reason, a case in which a scheduled sideline time is registered but an actual sideline time is yet to be registered may be included in sideline database 125. For example, at a stage at which the applicant who has received an order for a sideline inputs the scheduled sideline time, the scheduled sideline time is registered but the actual sideline time is not registered as data corresponding to the sideline.

Next, record receiving unit 149 automatically calculates an expected sideline time of the month (step S1512). Record receiving unit 149 calculates the expected sideline time based on the scheduled sideline time and the actual sideline time. Specifically, as described above, the “expected sideline time” is calculated based on the following calculation formula: “(the man-hour progression rate/the progression rate)×the scheduled sideline time−the actual sideline time”. It should be noted that record receiving unit 149 may calculate the “expected sideline time” in accordance with the following calculation formula: “the scheduled sideline time−the actual sideline time”. Record receiving unit 149 registers the calculated expected sideline time into sideline database 125. As shown in sideline database 125 of FIG. 7, the expected sideline time is registered on the case ID basis.

### Process of Registering Evaluation Result (Evaluation for Applicant)

FIG. 17 is a diagram for illustrating a procedure of registering an evaluation for an applicant into database 120. Step S16A and the function of evaluation receiving unit 151 in FIG. 12 will be described more in detail with reference to FIG. 17.

When the applicant completes the sideline, the applicant delivers the outcome and reports the completion to the inviter, and is subjected to the inviter's review. Thereafter, the inviter operates inviter device 200 to input an evaluation for the applicant into inviter device 200. Inviter device 200 receives the input evaluation (step S16A). Inviter device 200 transmits the received evaluation to evaluation receiving unit 151 of sharing server 100. The information transmitted from inviter device 200 to sharing server 100 includes the member ID and the evaluation value (0 to 10) of the applicant who is an evaluation subject.

When the information of the evaluation for the evaluation subject (applicant) is received from inviter device 200, evaluation receiving unit 151 reflects the evaluation for the evaluation subject in evaluation input database 126 (step S1513A).

When an evaluation result for the evaluation subject (applicant) has been already registered in evaluation input database 126, evaluation receiving unit 151 incorporates the value of the evaluation received this time so as to calculate the average value of the evaluation results for the evaluation subject. Evaluation receiving unit 151 updates the evaluation result registered in evaluation input database 126 with the calculated average value. As a result, in evaluation input database 126, the average value (evaluation result) of the evaluations for the evaluation subject (applicant) is registered on the evaluator (inviter) basis. Thus, the information of applicant evaluation portion 126B is updated in evaluation input database 126.

Next, evaluation receiving unit 151 performs an evaluation summary process (step S1514A). In the evaluation summary process, evaluation receiving unit 151 calculates each of the average value of the evaluation results for the evaluation subject (applicant) on the company basis and the average value of the evaluation results for the evaluation subject (applicant) on the department basis, and registers the calculation result into evaluation summary database 127. Thus, the information of applicant evaluation summary portion 127B is updated in evaluation summary database 127.

For example, evaluation receiving unit 151 specifies the evaluator (inviter) using the member ID used by inviter device 200 for the sign-in to perform step S16A. Evaluation receiving unit 151 specifies the ID of the company to which the evaluator belongs, the department to which the evaluator belongs, the member ID of the evaluation subject, and the ID of the company to which the evaluation subject belongs, based on the information of the evaluation received in step S1513A, company database 121, and member database 122. The “member ID” is an example of “identification information by which sharing server 100 including evaluation receiving unit 151 can identify where (company and department) one who has accessed sharing server 100 belongs”.

Evaluation receiving unit 151 accesses evaluation summary database 127 and detects a data row in which the specified IDs (the member ID of the evaluation subject, the ID of the company to which the evaluation subject belongs, and the ID of the company to which the evaluator belongs) are arranged. Evaluation receiving unit 151 updates the values of the applicant evaluation summary corresponding to the detected data row.

### Process of Registering Evaluation Result (Evaluation for Inviter)

FIG. 18 is a diagram for illustrating a procedure of registering an evaluation for an inviter into the database. Step S16B and the function of evaluation receiving unit 151 in FIG. 13 will be described more in detail with reference to FIG. 18.

As described above, when the applicant completes the sideline, the applicant delivers the outcome and reports the completion to the inviter, and is subjected to the inviter's review. Thereafter, the applicant operates applicant device 300 to input an evaluation for the inviter into applicant device 300. Applicant device 300 receives the input evaluation (step S16B). Applicant device 300 transmits the received evaluation to evaluation receiving unit 151 of sharing server 100. The information transmitted from applicant device 300 to sharing server 100 includes the member ID and the evaluation value (0 to 10) of the inviter who is an evaluation subject.

When the information of the evaluation for the evaluation subject (inviter) is received from applicant device 300, evaluation receiving unit 151 reflects the evaluation for the evaluation subject in evaluation input database 126 (step S1513B).

When an evaluation result for the evaluation subject (inviter) has been already registered in evaluation input database 126, evaluation receiving unit 151 incorporates the value of the evaluation received this time so as to calculate the average value of the evaluation results for the evaluation subject. Evaluation receiving unit 151 updates the evaluation result registered in evaluation input database 126 with the calculated average value. As a result, in evaluation input database 126, the average value (evaluation result) of the evaluations for the evaluation subject (inviter) is registered on the evaluator (applicant) basis. Thus, the information of inviter evaluation portion 126A is updated in evaluation input database 126.

Next, evaluation receiving unit 151 performs an evaluation summary process (step S1514B). In the evaluation summary process, evaluation receiving unit 151 calculates each of the average value of the evaluation results for the evaluation subject (inviter) on the company basis and the average value of the evaluation results for the evaluation subject (inviter) on the department basis, and registers the calculation result into evaluation summary database 127. Thus, the information of inviter evaluation summary portion 127A is updated in evaluation summary database 127.

For example, evaluation receiving unit 151 specifies the evaluator (applicant) using the member ID used by applicant device 300 for the sign-in to perform step S16B. Evaluation receiving unit 151 specifies the ID of the company to which the evaluator belongs, the department to which the evaluator belongs, the member ID of the evaluation subject, and the ID of the company to which the evaluation subject belongs, based on the information of the evaluation received in step S1513B, company database 121, and member database 122. The “member ID” is an example of “identification information by which sharing server 100 including evaluation receiving unit 151 can identify where (company and department) one who has accessed sharing server 100 belongs”.

Evaluation receiving unit 151 accesses evaluation summary database 127 and detects a data row in which the specified IDs (the member ID of the evaluation subject, the ID of the company to which the evaluation subject belongs, and the ID of the company to which the evaluator belongs) are arranged. Evaluation receiving unit 151 updates the values of the inviter evaluation summary corresponding to the detected data row.

For example, in data group 1271 of FIG. 9, the member ID=P1 of the evaluation subject, the ID=00A of the company to which the evaluation subject belongs, and the ID=00B of the company to which the evaluator belongs are arranged. When a member belonging to the system department of company B evaluates member P1, the evaluation is received in step S1513B.

In this case, in step S1514B, the evaluation received in step S1513B is reflected in each of the inviter evaluation summary corresponding to the “whole” of data group 1271 and the inviter evaluation summary corresponding to the “system department”.

More specifically, evaluation receiving unit 151 regards, as the inviter evaluation summary corresponding to the “whole” in the data group 1271, the average value of the evaluations made by the whole of company B and including the evaluation received in step S1513B. Similarly, evaluation receiving unit 151 regards, as the inviter evaluation summary corresponding to the “system department” in data group 1271, the average values of the evaluations made by the system department and including the evaluation received in step S1513B.

FIG. 19 is a diagram for illustrating a procedure of presenting an evaluation for an applicant and a search result for member on display 205. Step S4A (process of inviter device 200) and the function of member search unit 143 in FIG. 10 as well as steps S17A, S18A and the function of evaluation output unit 152 in FIG. 12 will be described more in detail with reference to FIG. 19.

### Process of Outputting Evaluation Summary of Applicant

First, each of processes of steps S17A, S18A, S1521A, and S1522A shown in FIG. 19 will be described.

When an operation for allowing the inviter to view an evaluation by the applicant is received, inviter device 200 performs a viewing request process (step S17A). In the viewing request process, inviter device 200 transmits a viewing request to evaluation output unit 152 of sharing server 100. In response to the viewing request, evaluation output unit 152 selects, from evaluation summary database 127, an applicant evaluation summary which the inviter (viewing requester) is given an authority to view (step S1521A).

The inviter having made the viewing request is given an authority to view an applicant evaluation summary from the whole of the company to which the inviter belongs and an applicant evaluation summary from the department to which the inviter belongs. The inviter having made the viewing request is not given an authority to view an evaluation summary other than these. Evaluation output unit 152 determines the viewing authority based on the member ID of the inviter who transmits the viewing request, company database 121, and member database 122. The “member ID” is an example of “identification information by which sharing server 100 including evaluation receiving unit 151 can identify where (company and department) one who has accessed sharing server 100 belongs and can identify the viewing authority of the one who has accessed sharing server 100”.

Evaluation output unit 152 selects, from evaluation summary database 127, an applicant evaluation summary corresponding to the viewing authority. Evaluation output unit 152 transmits data including the selected applicant evaluation summary to inviter device 200 (step S1522A). The transmitted data includes the member ID of the applicant (evaluation subject), the information of the company to which the applicant belongs, the information of the department to which the applicant belongs, and the like in addition to the applicant evaluation summary. Depending on a viewing request, the transmitted data may include an applicant evaluation summary corresponding to each of a plurality of applicants (evaluation subjects).

Inviter device 200 having received the applicant evaluation summary presents the applicant evaluation summary on display 205 together with the information of the company to which the applicant belongs and the information of the department to which the applicant belongs (step S18A). When an applicant evaluation summary corresponding to each of a plurality of applicants (evaluation subjects) is received, inviter device 200 presents the applicant evaluation summary by presenting the plurality of applicants (evaluation subjects) in the form of a list.

Thus, when the viewing request is received in the communication established in accordance with the member ID by which each of the company and department to which the inviter belongs can be identified, sharing server 100 transmits the applicant evaluation summary, which is exemplary evaluation information, to inviter device 200 of the inviter who is the origin of transmission of the viewing request.

### Process of Searching for Member (Applicant)

Next, each of processes of steps S4A, S19A, and S1431A to S1433A will be described with reference to FIG. 19.

When a search operation is received from the inviter, inviter device 200 performs a member search process of searching for information about applicants (step S4A). In the member search process, inviter device 200 transmits a search request to member search unit 143 of sharing server 100. The search request includes a reference value for performing search to exclude a member having a low magnitude of evaluation as an applicant. This reference value is determined based on, for example, the value of the applicant evaluation summary.

Member search unit 143 having received the search request specifies the company to which the inviter having transmitted the search request belongs (step S1431A). Here, the company specified in step S1431A is referred to as “company Xa”.

Member search unit 143 specifies the inviter who is operating inviter device 200, by using the member ID used when inviter device 200 signs in to sharing server 100. Member search unit 143 uses company database 121 and member database 122 to specify company Xa to which the inviter belongs.

Next, member search unit 143 extracts, from evaluation summary database 127, a member having an applicant evaluation summary with a value provided by the whole of specified company Xa to exceed the reference value (step S1432A). That is, member search unit 143 extracts a search result with a member having a low magnitude of evaluation by the whole of company Xa being excluded.

Here, it should be noted that member search unit 143 determines whether or not the magnitude of evaluation is low based on the applicant evaluation summary. That is, a member α having both an authority as an applicant and an authority as an inviter may behave as an applicant and may behave as an inviter. Therefore, as an evaluation summary of such a member α, an applicant evaluation summary and an inviter evaluation summary are registered in evaluation summary database 127. Member α may have a high magnitude of evaluation as an inviter whereas member α may have a low magnitude of evaluation as an applicant. In this case, member α may be excluded from those to be extracted in step S1432A.

A function of receiving setting information for the reference value from inviter device 200 of each company may be provided in sharing server 100. Thus, in accordance with each company's own reference value, the company can exclude, from the search result, a member having a low magnitude of evaluation.

Next, member search unit 143 outputs the extracted member information as a search result to inviter device 200 that has made the search request (step S1433A). Inviter device 200 presents the received search result on display 205 in the form of a list (step S19A).

As a result, the inviter can view, on display 205, the search result from which the member having a low magnitude of evaluation made by the whole of the company to which the inviter belongs is excluded. Therefore, when selecting an order receiver from the applicants, the inviter can save an effort of excluding, by eyes, a member having a low magnitude of evaluation made by the whole of the company.

It should be noted that in the present embodiment, even a member having a low magnitude of evaluation made by a certain department of the company to which the inviter belongs is not excluded from the search result when the magnitude of evaluation made by the whole of the company is not low. However, member search unit 143 may further exclude such a member from the search result.

FIG. 20 is a diagram for illustrating a procedure of presenting an evaluation for an inviter and a search result for member on display 305. Step S4B (process of applicant device 300) and the function of member search unit 143 in FIG. 10 as well as steps S17B, S18B and the function of evaluation output unit 152 in FIG. 13 will be described more in detail with reference to FIG. 20.

### Process of Outputting Evaluation Summary for Inviter

First, each of processes of steps S17B, S18B, S1521B, and S1522B shown in FIG. 20 will be described.

When an operation by the applicant for viewing an evaluation for an inviter is received, applicant device 300 performs a viewing request process (step S17B). In the viewing request process, applicant device 300 transmits a viewing request to evaluation output unit 152 of sharing server 100. In response to the viewing request, evaluation output unit 152 selects, from evaluation summary database 127, an inviter evaluation summary which the applicant (viewing requester) is given an authority to view (step S1521B).

The applicant having made the viewing request is given an authority to view an inviter evaluation summary from the whole of the company to which the applicant belongs and an inviter evaluation summary from the department to which the applicant belongs. The applicant having made the viewing request is not given an authority to view an evaluation summary other than these. Evaluation output unit 152 determines the viewing authority based on the member ID of the applicant who transmits the viewing request, company database 121, and member database 122. The “member ID” is an example of “identification information by which sharing server 100 including evaluation receiving unit 151 can identify where (company and department) one who has accessed sharing server 100 belongs and can identify the viewing authority of the one who has accessed sharing server 100”.

Evaluation output unit 152 selects, from evaluation summary database 127, an inviter evaluation summary corresponding to the viewing authority. Evaluation output unit 152 transmits data including the selected inviter evaluation summary to applicant device 300 (step S1522B). The transmitted data includes the member ID of the inviter (evaluation subject), the information of the company to which the inviter belongs, the information of the department to which the inviter belongs, and the like in addition to the inviter evaluation summary. Depending on a viewing request, the transmitted data may include an inviter evaluation summary corresponding to each of a plurality of inviters (evaluation subjects).

Applicant device 300 having received the inviter evaluation summary presents the inviter evaluation summary on display 305 together with the information of the company to which the inviter belongs and the information of the department to which the inviter belongs (step S18B). When an inviter evaluation summary corresponding to each of a plurality of inviters (evaluation subjects) is received, applicant device 300 presents the inviter evaluation summary by presenting the plurality of inviters (evaluation subjects) in the form of a list.

Thus, when the viewing request is received in the communication established in accordance with the member ID by which each of the company and department to which the applicant belongs can be identified, sharing server 100 transmits the inviter evaluation summary, which is exemplary evaluation information, to applicant device 300 of the applicant who is the origin of transmission of the viewing request.

### Process of Searching for Member (Inviter)

Next, each of processes of steps S4B, S19B, and S1431B to S1433B will be described with reference to FIG. 20.

When a search operation is received from the applicant, applicant device 300 performs a member search process of searching for information about inviters (step S4B). In the member search process, applicant device 300 transmits a search request to member search unit 143 of sharing server 100. The search request includes a reference value for performing search to exclude a member having a low magnitude of evaluation as an inviter. This reference value is determined based on, for example, the value of the inviter evaluation summary.

Member search unit 143 having received the search request specifies the company to which the applicant having transmitted the search request belongs (step S1431B). Here, the company specified in step S1431B is referred to as “company Xb”.

Member search unit 143 specifies the applicant who is operating applicant device 300, by using the member ID used when applicant device 300 signs in to sharing server 100. Member search unit 143 uses company database 121 and member database 122 to specify company Xb to which the applicant belongs.

Next, member search unit 143 extracts, from evaluation summary database 127, a member having an inviter evaluation summary with a value provided by the whole of specified company Xb to exceed the reference value (step S1432B). That is, member search unit 143 extracts a search result with a member having a low magnitude of evaluation by the whole of company Xb being excluded.

A function of receiving setting information for the reference value from inviter device 200 of each company may be provided in sharing server 100. Thus, in accordance with each company's own reference value, the company can exclude, from the search result, a member having a low magnitude of evaluation.

Next, member search unit 143 outputs the extracted member information as a search result to applicant device 300 having made the search request (step S1433B). Applicant device 300 presents the received search result on display 305 in the form of a list (step S19B).

As a result, the applicant can view, on display 305, the search result from which the member having a low magnitude of evaluation made by the whole of the company to which the applicant belongs is excluded. Therefore, when selecting an order receiver from the applicants, the inviter can save an effort of excluding, by eyes, a member having a low magnitude of evaluation made by the whole of the company.

It should be noted that in the present embodiment, even a member having a low magnitude of evaluation made by a certain department of the company to which the applicant belongs is not excluded from the search result when the magnitude of evaluation made by the whole of the company is not low. However, member search unit 143 may further exclude such a member from the search result.

### Permitted Scope of Viewing of Evaluation Summary Database 127

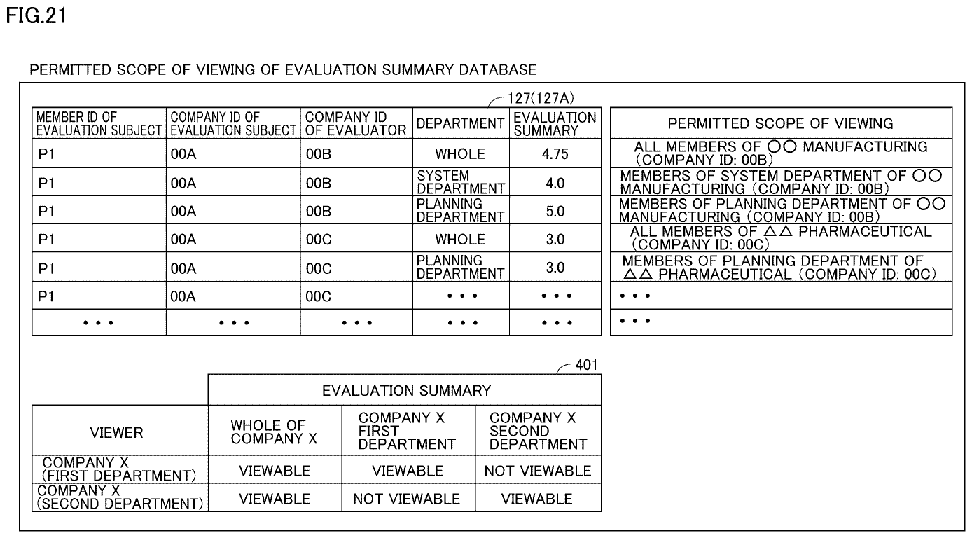

FIG. 21 is a diagram for illustrating a permitted scope of viewing of evaluation summary database 127. Here, the permitted scope of viewing will be described by exemplifying inviter evaluation summary portion 127A shown in FIG. 9 in evaluation summary database 127.

Inviter evaluation summary portion 127A shown in FIG. 21 includes evaluation summaries from company B and company C for member P1 who behaves as an “inviter”. Member P1 belongs to company A. The evaluation summaries from company B are classified into “whole”, “system department”, and “planning department”. The evaluation summaries from company C are classified into “whole”, “planning department”, and the like. Each of the members belonging to companies B and C views, as an “applicant”, the evaluation summaries for member P1.

Each of all the members belonging to company B has a viewing authority for the evaluation summary calculated from the evaluations made by the whole of company B as shown in the column “PERMITTED SCOPE OF VIEWING” in FIG. 21.

Each of the members of the system department of company B has a viewing authority for the evaluation summary calculated from the evaluations made by the system department of company B, but each of the members other than those of the system department of company B does not have the viewing authority therefor. Each of the members of the planning department of company B has a viewing authority for the evaluation summary calculated from the evaluations made by the planning department of company B, but each of the members other than those of the planning department of company B does not have the viewing authority therefor.

Each of all the members belonging to company C has a viewing authority for an evaluation summary calculated from evaluations made by the whole of company C. Each of the members of the planning department of company C has a viewing authority for an evaluation summary calculated from evaluations made by the planning department of company C, but the members other than those of the planning department of company C does not have the viewing authority therefor.

In the description above, the permitted scope of viewing has been described by exemplifying inviter evaluation summary portion 127A. In matching system 1, the permitted scope of viewing is also defined for applicant evaluation summary portion 127B (see FIG. 9) in accordance with the same design concept as that for inviter evaluation summary portion 127A.

When a member of a first department of a company X and a member of a second department of company X are viewers, authorities of the viewers for an evaluation summary from the whole of company X, an evaluation summary from the first department of company X, and an evaluation summary from the second department of company X are as shown in a table 401 of FIG. 21. Here, when an applicant corresponds to the “viewer”, an evaluation summary of an “inviter” is to be viewed. On the other hand, when an inviter corresponds to the “viewer”, an evaluation summary of an “applicant” is to be viewed.

The member belonging to the first department of company X can view the evaluation summary from the whole of company X and the evaluation summary from the first department of company X, but cannot view the evaluation summary from the second department of company X. The member belonging to the second department of company X can view the evaluation summary from the whole of company X and the evaluation summary from the second department of company X, but cannot view the evaluation summary from the second department of company X. A member belonging to a company Y other than company X cannot view the evaluation summary from the whole of company X, the evaluation summary from the first department of company X, and the evaluation summary from the second department of company X.

The evaluation summary from the whole of company X, the evaluation summary from the first department of company X, and the evaluation summary from the second department of company X are not disclosed to a member of a company other than company X. Therefore, a member who belongs to company Y and behaves as an applicant can objectively evaluate an inviter belonging to company X without a consideration of a relationship between the companies or the like on the occasion of evaluating the inviter belonging to company X. Similarly, a member who belongs to company Y and behaves as an inviter can objectively evaluate an applicant belonging to company X without a consideration of the relationship between the companies or the like on the occasion of evaluating the applicant belonging to company X.

Moreover, the evaluations (evaluations for an inviter and evaluations for an applicant) made by the members belonging to company X are shared among company X as the inviter evaluation summary and the applicant evaluation summary. Therefore, the evaluators can become conscious of such a fact that useful information is produced by accumulating evaluations one after another. With this, the evaluators are motivated to make accurate evaluations.

As a result, the accuracy of each of the inviter evaluation summary and the applicant evaluation summary is improved. Thus, the inviter evaluation summary can be usefully utilized as reference data when selecting an invitation business. Similarly, the applicant evaluation summary can be usefully utilized as reference data when selecting an order receiver.

Further, according to the present embodiment, when the member search process (step S4A) is performed in inviter device 200, the search result from which a member having a low magnitude of evaluation is excluded is provided to the inviter (step S1432A). Similarly, when the member search process (step S4B) is performed in applicant device 300, the search result from which a member having a low magnitude of evaluation is excluded is provided to the inviter (step S1432B). That is, matching system 1 has a filtering function of providing a search result from which a member having a low magnitude of evaluation is excluded.

Therefore, when determining an order receiver for the invitation business, the inviter can be prevented on the company basis from erroneously employing a member having a low magnitude of evaluation. Similarly, when determining an invitation business to apply for from a large number of invitation business, the applicant can be prevented on the company basis from erroneously selecting a case for which an application is invited by a member having a low magnitude of evaluation. It should be noted that sharing server 100 may perform filtering using an evaluation summary on the department basis.

An instruction signal for instructing which of the filtering using the evaluation summary from the whole of the company and the filtering using the evaluation summary on the department basis is to be used may be transmitted from inviter device 200 to sharing server 100. In this case, sharing server 100 is provided with a function of changing, in accordance with the instruction signal, the evaluation summary to be used for the filtering.

### Example of Setting Scope of Disclosure in accordance with Disclosure Level

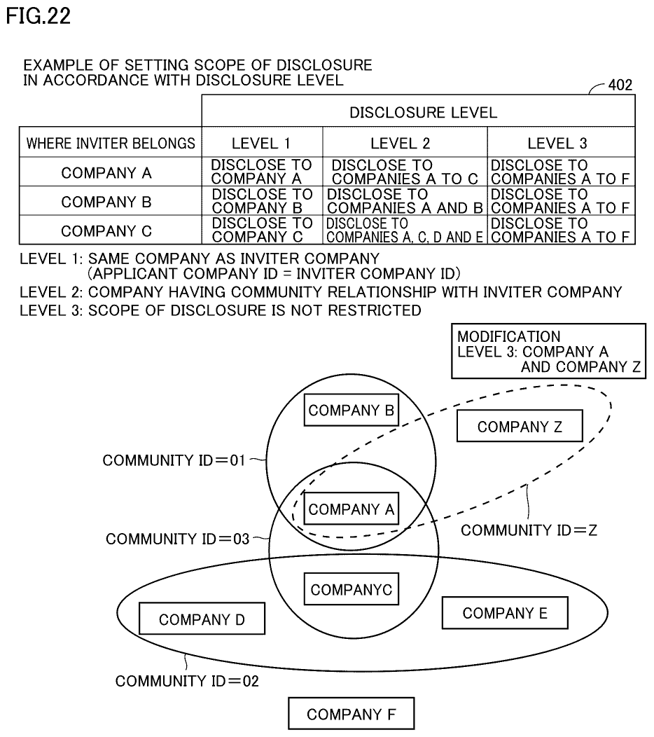

FIG. 22 is a diagram showing an example of setting the scope of disclosure in accordance with a disclosure level. Here, as shown in FIG. 22, it is assumed that companies A to E form a community relationship, and company F does not have a community relationship with any of the companies. In this case, the scopes of disclosure of invitation cases are as shown in a table 402 in accordance with companies to which inviters belong and disclosure levels set by the inviters.

The disclosure levels, i.e., “level 1” to “level 3” shown in FIG. 22 correspond to the above-described three levels, i.e., “own company”, “within community”, and “all”. Therefore, in level 1, the invitation case of the inviter is disclosed to an applicant of the same company as the company to which the inviter belongs. In level 2, in addition to the scope of level 1, the invitation case of the inviter is disclosed to an applicant belonging to a company having the community relationship with the company to which the inviter belongs. In level 3, the invitation case of the inviter is disclosed to applicants belonging to all the companies including the company to which the inviter belongs. It should be noted that when the inviter specifies a company ID for which disclosure is not to be made, a company corresponding to the company ID is excluded from the companies to which the disclosure is to be made regardless of the disclosure level set. Among the disclosure levels of the present embodiment, “level 1” is a level corresponding to “permitting the business information to be disclosed to the first applicant and prohibiting the business information from being disclosed to the applicant not belonging to the first group”. “Level 2” is a level corresponding to “permitting the business information to be disclosed to the applicant belonging to any of the first group and the community group having a community relationship with the first group, and prohibiting the business information from being disclosed to the applicant not belonging to any of the first group and the community group”. “Level 3” is a level corresponding to “permitting the business information to be disclosed to an applicant regardless of a group to which the applicant belongs”.

Here, levels 1 to 3 have been described as examples of the plurality of types of disclosure levels. However, the plurality of types of disclosure levels are not limited thereto. For example, a community may be divided into a plurality of small communities, and whether to disclose an invitation business may be set for each small community. More specifically, community 02 shown in FIG. 5 is divided into a first small community and a second small community. It is assumed that company C belongs to the first small community, and company D and company E belong to the second small community. In this case, an inviter of company D may be allowed to select the scope of disclosure of the invitation business of company D to be the scope of the first small community or the scope of the second small community.

Sharing server 100 may receive an operation of setting a different scope of disclosure for each invitation case. For example, a specific example in which the scope of disclosure is set to be different for each invitation case will be described by exemplifying cases 001 to 003 among a large number of invitation cases.

For example, the scope of disclosure of invitation case 001 may be restricted to companies A and C belonging to a community identified by a community ID=03. Alternatively, the scope of disclosure of invitation case 002 may be restricted to companies C, D, and E belonging to a community identified by a community ID=02. Alternatively, the scope of disclosure of case 003 may be restricted to companies C, D, and E belonging to a community identified by the community ID=02 and companies A and C belonging to the community identified by the community ID=03.

Company A may form a community different from the community identified by community ID=01 or 02. For example, as indicated by a broken line in FIG. 22, company A may form, with a company Z, a community identified by a community ID =Z. For example, when the inviter belongs to company A, the invitation case of the inviter may be disclosed to an applicant belonging to company A and an applicant belonging to company Z. Such a disclosure level may be employed as a modification of “level 3” as shown in FIG. 22.

In this case, “level 3” corresponds to “permitting the business information to be disclosed to an applicant belonging to each of the first group (company A) and a specific community group (community identified by the community ID=Z) that is different from the community group (companies A to C) corresponding to the second level and having the community relationship with the first group, and prohibiting the business information from being disclosed to an applicant not belonging to any of the first group and the specific community group”.

Here, levels 1 to 3 have been described as examples of the plurality of levels, but a larger number of levels may be set as the plurality of types of disclosure levels. As an exemplary interface for allowing the inviter to set the scope of disclosure, a screen on which a check box for setting a desired level from the plurality of types of levels is presented may be presented on user device 500.

### Exemplary Screen Presented When Checking Sideline Status

FIG. 23 is a diagram showing a screen presented on applicant device 300 of the administrator when the administrator (superior for an applicant) checks the sideline status of the subordinate. FIG. 23 shows an example in which the sideline status of the subordinate for the administrator is presented on applicant device 300 (user device 500). Applicant device 300 is provided with a keyboard 306A and a mouse 306B as the operation unit.

Here, the administrator is, for example, a department leader of the sales department of company C. Display 305 shows the sideline statuses of the employees belonging to the sales department. The administrator designates any of a tab 307A, a tab 307B, a tab 307C, . . . using keyboard 306A or mouse 306B so as to check the sideline statuses of the employees belonging to the sales department. Therefore, the administrator can manage the work time of each subordinate so as to avoid such a risk that the subordinate is brought into a state of overwork. It should be noted that the progression rate may also be presented on the screen.

### Exemplary Screen Presented When Changing Setting of Viewing Restriction

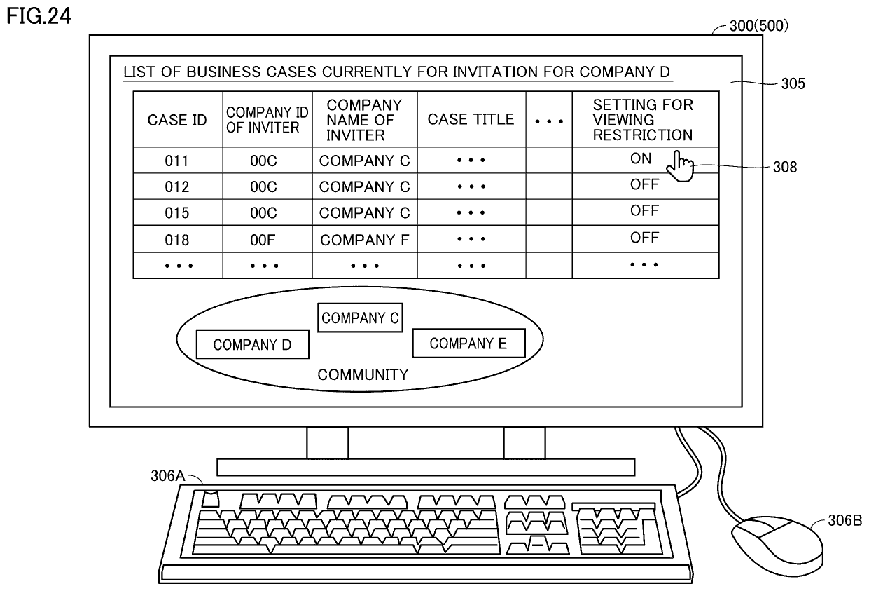

FIG. 24 is a diagram showing a screen presented on applicant device 300 when the administrator changes the setting of the viewing restriction. Here, it is assumed that the administrator who operates applicant device 300 (user device 500) belongs to company D. As shown in FIG. 24, on display 305, a list of business cases for company D that are currently for invitation is presented. Display 305 further presents that company D forms a community relationship with companies C and E.

The business case list includes pieces of information about the business cases on the business case basis, such as the “case ID”, the “company ID of the inviter”, the “company name of the inviter”, and the “case title”. FIG. 24 shows a plurality of cases of company C and cases of company F as the business cases. The business case list further includes a setting area in which the “viewing restriction” is set by the administrator on the business case basis.

The administrator can move a cursor 308 to the setting area by operating mouse 306B and switch the setting of the viewing restriction between “ON” and “OFF” in the setting area. “OFF” corresponds to presence of no viewing restriction, and “ON” corresponds to presence of a viewing restriction. The setting of “ON” is an example of restriction information for restricting viewing. The default setting of the setting area is “OFF”. When the setting of the viewing restriction is switched from “OFF” to “ON”, all the employees belonging to company D cannot view a business case corresponding to “ON”.

FIG. 24 shows an example in which the setting of a viewing restriction for a business case of company C corresponding to “case ID=011” is set to ON. By switching the setting of the viewing restriction for the business case of company C corresponding to “case ID=011” from OFF to ON, all the employees belonging to company D cannot view the business case of company C corresponding to “case ID=011”.

Since company C and company D have the community relationship, it is understood that company C and company D do not have a competitive relationship. In view of this understanding, company C will comfortably accept that the employees of company D view its own business cases and apply for the business cases. However, depending on the content of a business case or a situation of the company, company D may feel a concern in that an employee of company D receives an order for a business case of company C.

For example, when an employee of company D handles a special case of company C and a know-how of company D may be accordingly leaked to company C, company D supposedly wishes to avoid the employees of company D from applying for such a special case. Alternatively, when the recent reputation of company C in the industry is becoming worse, company D may wish to avoid the employees of company D from applying for a case of company C for some time.

Therefore, matching system 1 is provided with a function of allowing an applicant to set, to a business case, restriction information for viewing restriction. The applicant sets restriction information to a business case desired to be restricted from being viewed. Thus, all the employees of the company to which the applicant belongs cannot view the business case to which the restriction information is set.

Information to which of the plurality of business cases the restriction information is set is not notified to the inviter. For this reason, the inviter understands that there are no applications from applicants belonging to the specific company, but does not think that the viewing of the business case is restricted. Therefore, for example, even when company D sets the restriction information to the invitation case of company C, this does not cause a problem in the community relationship between company C and company D.

Here, it has been illustratively described that the viewing restriction is set on the case basis. However, the system may be configured such that viewing restrictions are collectively set on companies and case types (sales cases or the like). In this case, when a case added after a viewing restriction is set satisfies the condition of the viewing restriction set, the viewing restriction may also be immediately applied to the added case. Further, the scope of the viewing restriction may be configured to be limited to a whole of a company or a specific department designated when the viewing restriction is set. Thus, the user can configure not to, for example, present a case to a research department that handles confidential information, but can configure to present the case to other departments such as a general affairs department.

### Timing Chart

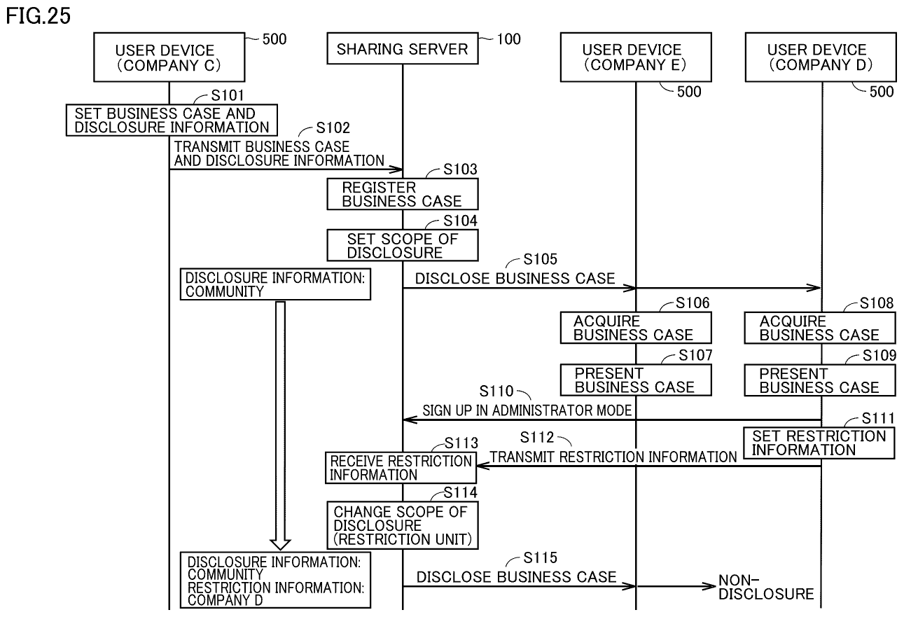

FIG. 25 is a timing chart about the setting of the restriction information. Here, a flow of setting viewing information to a business case will be described by exemplifying companies C to E among which the community relationship is formed.

Company C is a user (inviter) who provides a business case. Companies D and E are users (applicants) who are permitted by company C to view the business case. In the following description, user device 500 of company D is an example of a first user device to be operated by a first user belonging to a first group. Moreover, user device 500 of company C is an example of a second user device to be operated by a second user.

First, user device 500 of company C sets a business case and disclosure information in response to an operation by the user (step S101). Next, user device 500 of company C transmits the business case and the disclosure information to sharing server 100 in response to an operation by the user (step S102). It should be noted that in step S101, the user may set two or more business cases or may set one business case.

Next, sharing server 100 registers the received business case into invitation case database 124 (step S103). Next, sharing server 100 sets a scope of disclosure based on the received disclosure information (step S104). Here, it is assumed that the scope of disclosure of the business case is restricted to “community” by the disclosure information. In this case, the business case is disclosed to companies D and E. In this way, sharing server 100 sets the scope of disclosure of the business case provided by the second user (user belonging to company C) based on the disclosure information indicating the scope of disclosure of the business case. Here, steps S103 and S104 are an example of a setting unit that accesses the database in which the business case is registered and that sets the business case to be disclosed to the first group to which the first user belongs based on the disclosure information indicating the scope of disclosure of the business case.

Sharing server 100 discloses the business case to company D and company E in accordance with the set scope of disclosure (step S105). User device 500 of company E acquires the business case in response to an operation by the user (step S106). User device 500 of company E presents the acquired business case (step S107). User device 500 of company D acquires the business case (step S108). User device 500 of company D presents the acquired business case (step S109).

Next, user device 500 of company D signs up to sharing server 100 in the administrator mode in response to an operation by the user (step S110). Next, user device 500 of company D sets restriction information in response to an operation by the user (step S111). For example, as shown in FIG. 24, the user selects a business case desired to be restricted from being viewed, and switches “OFF” to “ON” in the setting area. Step S111 is an example of a receiving unit that receives a user operation for inputting restriction information.

Next, user device 500 of company D transmits the restriction information to sharing server 100 in response to an operation by the user (step S112). Here, the restriction information is transmitted to sharing server 100 on the business case basis. Step S112 is an example of a transmitting unit that transmits the restriction information to the computing device when the user operation is received by the receiving unit (herein “transmitter” means the same as “transmitting unit”).

For example, when restriction information is set for a first case of two business cases, the restriction information for the first case is transmitted to sharing server 100. Alternatively, when restriction information is set for a second case of the two business cases, the restriction information for the second case is transmitted to sharing server 100. That is, user device 500 is configured to selectively transmit the restriction information for the first case and the restriction information for the second case to sharing server 100 based on an operation by the user.

Next, sharing server 100 receives the restriction information (step S113). Step S113 is an example of a reception unit that receives the restriction information from the user device. Next, sharing server 100 changes the scope of disclosure of the business case based on the received restriction information (step S114). More specifically, sharing server 100 registers, into invitation case database 124, the restriction information for restricting the user of company D from viewing the target business case.

Step S114 is an example of a restriction unit that restricts the disclosure of the business case to the first group in accordance with the restriction information regardless of the scope of disclosure set based on the disclosure information. It should be noted that in step S1452 of FIG. 15, when the applicant is the user of company D, the business case for which the restriction information is set is excluded from the business cases that can be disclosed.

Next, sharing server 100 discloses the business case to the user of company E (step S115). As a result, the business case is not disclosed to the user of company D. In this way, sharing server 100 restricts the business case provided by the second user (user belonging to company C) from being disclosed to the first group (company D) in accordance with the restriction information regardless of the scope of disclosure set based on the disclosure information. The restriction information is an example of information that restricts the business case from being disclosed to the first group to which the first user belongs regardless of the scope of disclosure that is based on the disclosure information.

### Details of Case Contents

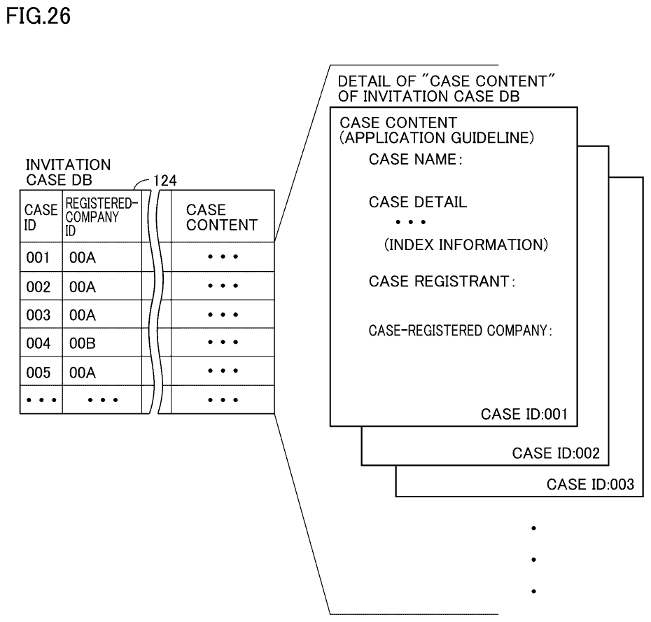

FIG. 26 is a diagram showing details of a case content included in invitation case database 124. The case content includes an application guideline. As shown in FIG. 26, the case content is registered in invitation case database 124 on the case ID basis.

The case content includes items of a case name, a case detail, a case registrant, and a case-registered company. The title of an invitation case is described in the case name. The case detail includes a text describing the content of the invitation case. This text may include skills, experiences, qualifications, and the like needed for applicants. The case registrant means one who has registered the case, i.e., the inviter. The case-registered company means a company to which the case registrant belongs.

The case content is disclosed to a user (applicant) to whom the case is permitted to be disclosed. A company-specific term may be used in the text included in the case detail. Such a company-specific term in the text is registered in invitation case database 124 as “index information” so as to be associated with a company-specific term in a below-described company-specific term database 136.

As described above with reference to FIG. 1, user device 500 presents the company-specific term in a presentation manner different from those of the other terms. Thus, the user understands that it is a company-specific term. Further, in response to an operation by the user (for example, an operation of clicking a portion of the company-specific term), user device 500 presents the meaning intended by the company-specific term.

The applicant reviews the case contents, and determines a case to apply for from a large number of cases. The applicant has an interview with the inviter of the case before finally applying for the case. Moreover, the inviter may select a specific one from applicants as a provisional order receiver and may then have an interview with the provisional order receiver before making a business contract. After making a business contract with the applicant, the inviter may have an interview with the applicant (order receiver) in accordance with a status of progress of the business.

User device 500 may provide the inviter and the applicant with an environment for a web conference for performing such interviews. When a text including a company-specific term is presented on the display during the Web conference, user device 500 may present the company-specific term in the manner shown in FIG. 1.

### Other Databases

Hereinafter, in addition to various databases 121 to 127 shown in FIG. 2, other databases employed in the present embodiment will be described.

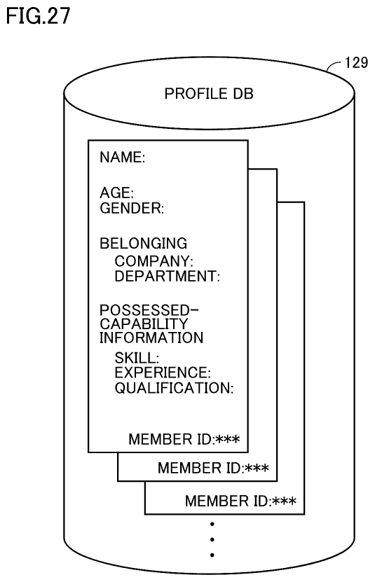

FIG. 27 is a diagram showing an exemplary profile database 129. As shown in FIG. 27, in profile database 129, profile information of a member (user) is registered on the member ID basis. A part of the profile information may overlap the information registered in member database 122. The profile information includes the name, age, and gender of the member. Further, the profile information includes belonging information by which where (company and department) the member belongs can be specified. The belonging information is exemplary group information for specifying one of the company and the department within the company.

Further, the profile information includes possessed-capability information of the member. The possessed-capability information of the member is classified based on a skill, an experience, and a qualification.

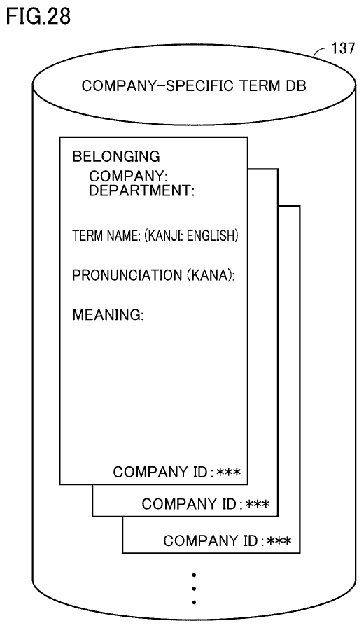

FIG. 28 is a diagram showing an exemplary company-specific term database 137. As shown in FIG. 28, company-specific term information is registered in company-specific term database 137 on the company ID basis. Sharing server 100 specifies a company-specific term on the company basis by referring to company-specific term database 137.

The company-specific term information includes belonging information by which where (company and department) the member belongs can be specified. The belonging information is exemplary group information for specifying one of the company and the department within the company. It can also be said that the belonging information is information indicating the company and the department in each of which the company-specific term to be registered is widely used.

The company-specific term information further includes “name”, “pronunciation”, and “meaning” of the term to be registered. For the company-specific term “DX”, “DX” is registered as the “name”, “di:eks” is registered as the “pronunciation”, and “to create some new value regardless of whether or not the digital technology is used” is registered as the “meaning”, for example.

Another example of the company-specific term is “application development”. “Application development” is generally understood to mean development of an application to be used in an electronic device such as a smartphone. However, in a certain department in a company handling electronic components, “application development” may mean “to cultivate a usage of a component”. In such a case, the term name “application development” and its meaning (to cultivate a usage of a component) is registered in company-specific term database 137.

### Explanation for Processing Procedure for Index Function

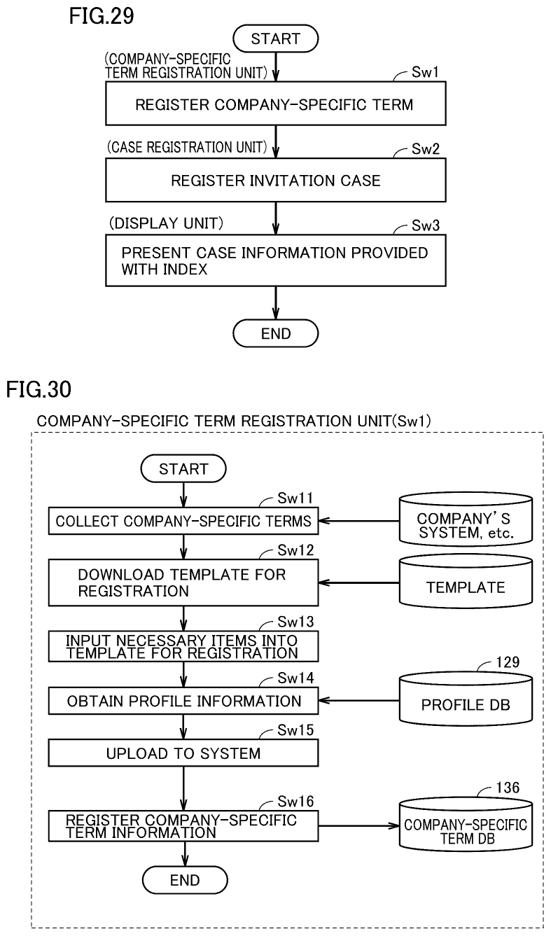

Next, various processing procedures for the index function will be described with reference to FIGS. 29 to 32. FIG. 29 is a flowchart showing a processing procedure for the index function of matching system 1.

In the flowchart shown in FIG. 29, first, sharing server 100 registers a company-specific term into company-specific term database 137 (step Sw1). In step Sw1, sharing server 100 functions as a company-specific term registration unit. Next, sharing server 100 registers an invitation case into invitation case database 124 (step Sw2). In step Sw2, sharing server 100 functions as a case registration unit. When registering the invitation case into invitation case database 124, the case registration unit indexes the company-specific term included in the invitation case information.

Next, sharing server 100 presents the case information provided with the index on user device 500 (step Sw3). For example, when the company-specific term is used in a text describing the case detail, the text is presented on user device 500 with the company-specific term being underlined. Instead of underlining the company-specific term or in addition to underlining the company-specific term, the company-specific term may be presented in a color different from those of the other words on screen 552 of user device 500. In step Sw3, sharing server 100 functions as a display unit.

FIG. 30 is a flowchart showing a processing procedure of the company-specific term registration unit (Sw1). First, a person in charge in a company collects company-specific terms by using the company's own system or the like (step Sw11). That is, the person in charge creates a company-specific term list. Next, the person in charge downloads a template for registration from sharing server 100 (step Sw12). Next, the person in charge inputs necessary items into the template (step Sw13). The necessary items include the company-specific terms, the meanings of the company-specific terms, and the meanings of the company-specific terms.

Next, the person in charge in the company accesses sharing server 100 and obtains the profile information of the person in charge from profile database 129 (step Sw14). The profile information includes the company ID of the company to which the person in charge belongs. The person in charge uploads the template together with the profile information to matching system 1 (step Sw15). Sharing server 100 obtains the profile information and the template. Sharing server 100 generates company-specific term information based on the obtained profile information and template, and registers the generated company-specific term information into company-specific term database 137 (step Sw16). In this way, the company-specific terms and the meanings of the company-specific terms are registered into company-specific term database 137. The company-specific terms and the meanings of the company-specific terms are registered in company-specific term database 137 on the company basis.

The processes of steps Sw11 to Sw16 are performed for each company. In this way, the company-specific term information is registered in company-specific term database 137 on the company basis. It should be noted that sharing server 100 may register the company-specific terms collectively into company-specific term database 137 from an external file such as a CSV (Comma Separated Value) file.

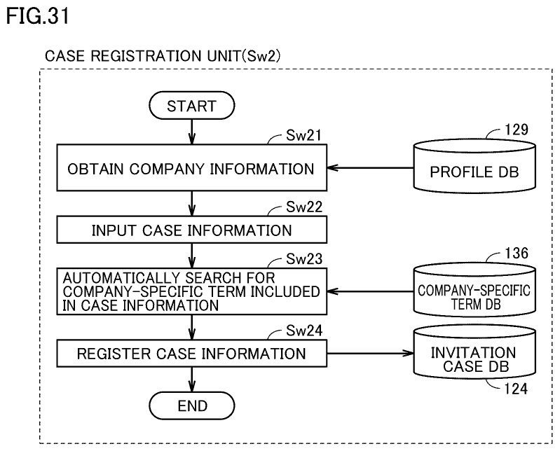

FIG. 31 is a flowchart showing a processing procedure of the case registration unit (Sw2). First, an inviter to register an invitation case into the system accesses profile database 129 so as to obtain the company information of his/her company (step Sw21). Next, the inviter inputs case information into user device 500 (step Sw22). The case information includes various types of information such as a case content to be registered in invitation case database 124. The inviter may input details of the case content using a company-specific term widely used in the company to which the inviter belongs.

Next, sharing server 100 automatically searches for the company-specific term included in the input case information (step Sw23). On this occasion, sharing server 100 indexes the company-specific term found by the search and associates it with the company-specific term information registered in company-specific term database 137. Next, sharing server 100 registers, into invitation case database 124, the case information input by the inviter (step Sw24). In this way, the case information is registered into invitation case database 124 with the company-specific term and the meaning of the company-specific term being associated with each other.

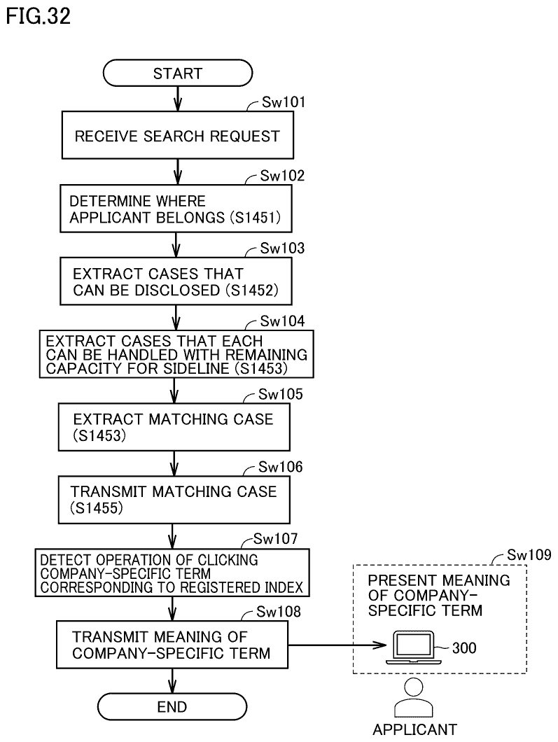

FIG. 32 is a flowchart showing a processing procedure of presenting the meaning of a company-specific term on the screen in response to an operation by an applicant. Here, the following describes a process for providing a matching case matched to the applicant in consideration of the scope of disclosure of the invitation case and a remaining capacity for sideline, and for notifying the meaning of the company-specific term to the applicant.

First, sharing server 100 receives a search request for invitation case from an applicant (step Sw101). Next, sharing server 100 determines where the applicant belongs (step Sw102). Details of this process have been described as step S1451.

Next, sharing server 100 extracts a case that can be disclosed (step Sw103). Details of this process have been described as step S1452. Next, sharing server 100 extracts a case that can be handled with a remaining capacity for sideline (step Sw104). Details of this process have been described as step S1453. It should be noted that the process of step Sw104 may be deleted from the flowchart. In other words, sharing server 100 may extract a case matched to the applicant without taking the remaining capacity for sideline into consideration.

Next, sharing server 100 extracts a matching case (step Sw105). Details of this process have been described as step S1454. Next, sharing server 100 transmits the matching case (step Sw106). Details of this process have been described as step S1455. In this way, sharing server 100 presents the matching case on applicant device 300 by transmitting the matching case to applicant device 300.

Next, sharing server 100 detects an operation of clicking a company-specific term corresponding to the registered index (step Sw107). Next, sharing server 100 refers to company-specific term database 137 and transmits the meaning of the company-specific term to applicant device 300 (step Sw108). Next, applicant device 300 presents the meaning of the company-specific term on display 305 (step Sw109). Thus, for example, screen 552 shown in FIG. 1 is presented on display 305. In this way, sharing server 100 presents the meaning of the company-specific term to applicant device 300 by transmitting the meaning of the company-specific term to applicant device 300.

As described above, according to the present embodiment, matching system 1 functioning as a crowdsourcing platform can be provided. In order to utilize the crowdsourcing to find a more appropriate person, it is desirable to further broaden the scope of crowdsourcing, rather than keeping the scope to be within a particular company or a small number of companies. In this case, it is necessary to consider a stake between an inviter who invites an application for an order receiver for a business and an applicant who applies for the invitation. In the present embodiment, sharing server 100 communicates with applicant device 300 operated by the applicant via communication interface 104. Sharing server 100 registers, into the database, the business information for inviting an order receiver and the disclosure information indicating the scope of disclosure of the business information (step S1442). Sharing server 100 determines, based on corresponding disclosure information, business information permitted to be disclosed to the applicant among the pieces of business information registered in database 120 (step S1452). The business information includes detailed information about the content of the business (case content (application guideline)). Sharing server 100 presents, on applicant device 300, the business information permitted to be disclosed to the applicant and the meaning of a term (in-house term including a company-specific term) included in the detailed information (steps Sw3, Sw106, and Sw109).

Therefore, according to the present embodiment, an appropriate applicant can be selected in consideration of the stake between the inviter and the applicant. Further, according to the present embodiment, the applicant can be prevented from misunderstanding the content of the business information due to a term used in an unfamiliar meaning or meaning different from its usual meaning.

Further, according to the present embodiment, an effort of additionally explaining the company-specific term can be saved when the user exchanges information about the case with a user outside the company. Further, sharing server 100 can automatically index the company-specific term included in the case information. Therefore, the user does not need to manually index the company-specific term. Further, sharing server 100 has a function of registering the company-specific term into company-specific term database 137. Therefore, the user does not need to manually register the company-specific term into company-specific term database 137. Further, since the user can recognize that the company-specific term is not understandable by other companies, the user can know a cultural difference from the other companies.

In the present embodiment, the “company-specific term” in the company has been described as an exemplary “in-house term” widely used in the group to which the user belongs. However, instead of or in addition to the “company-specific term”, the embodiment described above may be applied to a term similar to the company-specific term and used in a non-profit organization, a community, and a unit (department, section, or the like) therein.

Each of a “company-based group” and a “department-based group in the same company” in the present embodiment is an exemplary “group”. One “group” may be formed by applicants who do not belong to a company, such as freelancers. A “company group” may be formed by a plurality of companies.

In the present embodiment, the “company forming the community relationship” is an example of the “community group”.

In the present embodiment, the information of the “non-disclosure target” included in the disclosure information is an example of “information by which one to whom the business information is prohibited from being disclosed can be specified”.

The communication (S9 in FIG. 11) for transmitting the approval information from applicant device 300 of the administrator functioning as the approver to approval unit 147 is performed in the logical communication path identified by the member ID of the approver. The expression “approval unit 147 receives the approval information in such a communication path” is an example of “receiving the approval notification in the communication involving the identification information of the approver for the first applicant”.

In the present embodiment, the “evaluation summary” registered in evaluation summary database 127 is an example of “evaluation information that is based on the evaluation received from inviter device 200 functioning as the evaluator device”.

In the present embodiment, “inviter device 200A” operated by the inviter belonging to company A functions as an evaluator device and is an example of “first evaluator device operated by one or more evaluators belonging to the first group”.

In the present embodiment, “inviter device 200B” operated by the inviter belonging to company B functions as an evaluator device and is an example of “second evaluator device operated by one or more evaluators belonging to a second group different from the first group”.

The system department and the planning department are illustratively described as the departments of company A in FIG. 21. In the present embodiment, “one of the system department and the planning department” is an example of the “first division group” included in the first group, and the other is an example of the “second division group” included in the first group.

Sharing server 100 extracts, from the list of invitation case database 124, business information with which the work time of the applicant does not exceed the upper-limit time, based on the estimated man-hours registered in invitation case database 124, the upper-limit sideline time registered in company database 121, the actual sideline time registered in sideline database 125, and the expected sideline time registered in sideline database 125. Specifically, for example, when the applicant engages in a plurality of sidelines, sharing server 100 calculates the total value of the actual sideline times corresponding to the respective sidelines so as to find the total actual sideline time, and calculates the total value of the expected sideline times corresponding to the respective sidelines so as to find the total expected sideline time. Sharing server 100 adds the found total actual sideline time and total expected sideline time to find the total sideline time. Sharing server 100 subtracts the total sideline time from the upper-limit sideline time of the applicant to find the permissible sideline time of the applicant. Sharing server 100 searches the list of invitation case database 124 for cases that can be each handled with the found permissible sideline time. On this occasion, sharing server 100 calculates a time needed to handle each invitation case based on the estimated man-hour in invitation case database 124, and searches for an invitation case falling within the range of the permissible sideline time. Here, the “upper-limit sideline time” is an example of the “upper-limit time, which is the upper limit of the work time of the applicant”, and the “actual sideline time” is an example of the “actual time, which is a time during the applicant has already worked as an actual record”, and the “expected sideline time” is an example of the “expected time, which is expected as the work time of the applicant”. The upper-limit time may be a time obtained by setting the upper limit on not only the sideline time but also the total time of the main job time and the sideline time. The first upper-limit time may be an upper-limit time for all the businesses including the main job and the sideline, rather than the upper-limit sideline time. Each of the first actual time and the first expected time may be not only the time of the sideline but also the total time of all the businesses including the sideline and the main job.

Each of inviter device 200 and applicant device 300 may not only include all of the processor, the memory, the communication interface, and the input/output interface shown in FIG. 2, but may be a thin client system using VDI (Virtual Desktop Infrastructure). The thin client system using VDI is a system in which a desktop environment on a server is transferred to a terminal at a remote location for the sake of use. Inviter device 200, applicant device 300, and sharing server 100 do not need to be necessarily independent devices. When the thin client system as described above is used, the functions of inviter device 200, applicant device 300, and sharing server 100 can be provided on the same aggregated server.

Database 120 is not limited to a relational database, and an object type database, a NoSQL type database, or the like may be used.

Sharing server 100 is an exemplary computing device. The computing device may be constituted of a server (such as an on-premises server or a cloud server), a serverless system, or the like. Here, the on-premises server is a server installed and managed in a facility managed by its own company. The cloud server is a server (borrowed server) provided by another business entity through a network. The serverless system is a system by which a computing/memory function can be used when needed without being aware of presence of a server. The computing device includes the server and the serverless system. The server includes the on-premises server and the cloud server.

### Modification 1

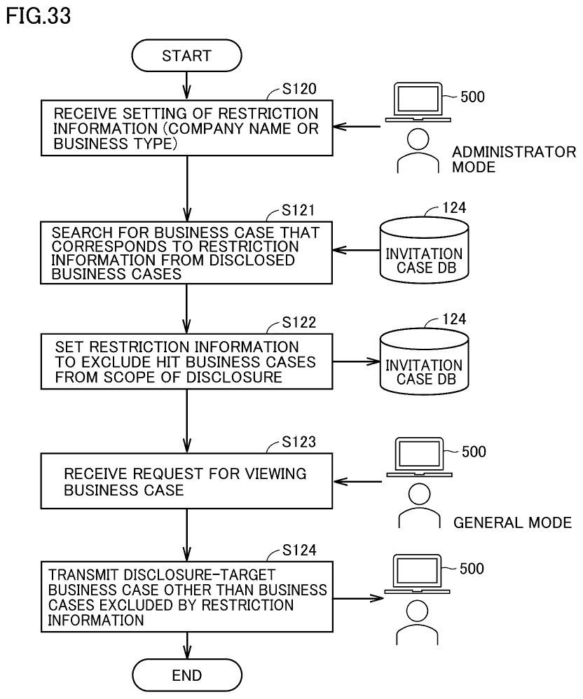

Next, a modification 1 will be described with reference to FIG. 33. FIG. 33 is a flowchart about a process for restriction information as performed by sharing server 100 as modification 1. Regarding the setting of the restriction information, it has been illustratively introduced that the restriction information is set on the business case basis with reference to FIGS. 24 and 25.

However, when there are a large number of business cases each desired to be restricted from being viewed, an operation of setting the restriction information for each business case results in an increased burden on the user. Moreover, it is difficult for the user to securely set the restriction information for all the business cases that should be each restricted from being viewed. Therefore, in modification 1, the following describes an example in which the user designates a company that provides a business case desired to be restricted from being viewed or a business type (for example, an electronic parts industry or the like) of the company, so as to set restriction information to a business case corresponding to the designated company or business type.

It should be noted that in order to implement modification 1, an operator of matching system 1 registers a business type ID for identifying the business type of the company into each of company database 121 (FIG. 3) and invitation case database 124 (FIG. 5), in addition to the business ID for identifying the company.

First, a user belonging to a company on the applicant side signs up to sharing server 100 in the administrator mode, and then inputs, to user device 500, the name of a company or a business type of the company to which restriction information is desired to be set. The input name of the company is an example of user designation information and company designation information. The input business type is an example of business-type designation information.

For example, assume that a user belonging to company D sets restriction information to all the business cases provided by company C. In this case, company D is an example of the first group, and company C is an example of the second group. The user (first user) belonging to company D inputs the company name of company C to user device 500. The “company name of company C” input to user device 500 is an example of the user designation information. Thus, the user designation information includes information for designating the second group.

It should be noted that as an organization to which restriction information is desired to be set, the user may designate not only a profit organization such as a company but also a non-profit organization and a community, each of which uses matching system 1. Alternatively, when there is a member who does not belong to an organization and uses matching system 1 as an individual, the user may input the name of such an individual member to user device 500. That is, a target designated by the user designation information may be any of a profit organization, a non-profit organization, and an individual.

User device 500 transmits information about the input name or business type of the company to sharing server 100 as the restriction information. Sharing server 100 receives the setting of the restriction information from user device 500 (step S120).

Next, sharing server 100 refers to invitation case database 124 so as to search for a business case that corresponds to the restriction information from business cases disclosed to the user among a plurality of business cases (step S121). The business case that corresponds to the restriction information is a business case registered with the company ID corresponding to the company name received in step S121. Alternatively, the business case that corresponds to the restriction information is a business case registered with the business type ID corresponding to the business type name received in step S121.

Next, sharing server 100 sets “restriction information” in invitation case database 124 so as to exclude business cases hit in the search in step S121 from the scope of disclosure (step S122).

Next, a user belonging to a company on the applicant side signs up to sharing server 100 in the general mode, and then requests sharing server 100 to view a business case. Next, from the user via user device 500, sharing server 100 receives a request for viewing a business case (step S123).

Next, sharing server 100 transmits, to user device 500, a disclosure-target business case other than the business cases excluded by the restriction information (step S124), and ends the process that is based on this flowchart. In user device 500, the disclosure-target business case other than the business cases excluded by the restriction information is presented.

Here, it has been illustratively described that the restriction information is set using the name of the company or the name of the business type as keys. However, the system may be configured such that the user can combine a plurality of keys to designate a business case to which restriction information is desired to be set. For example, matching system 1 may permit a user operation of designating, with a first key, the name of a business type to which restriction information is desired to be set and designating, with a second key, a company (for example, a venture company or the like) desired to be excluded from the targets for the setting of the restriction information.

Moreover, matching system 1 may receive a user operation of designating a business type of a company to which restriction information is desired to be set and making a designation of excluding a part of companies related to the business type from the setting of the restriction information. It should be noted that the business type is merely one form of a category to be restricted. The restriction information may be constituted of a company name, a department name (for example, an intellectual property department), or the like in addition to or instead of the business type.

### Modification 2

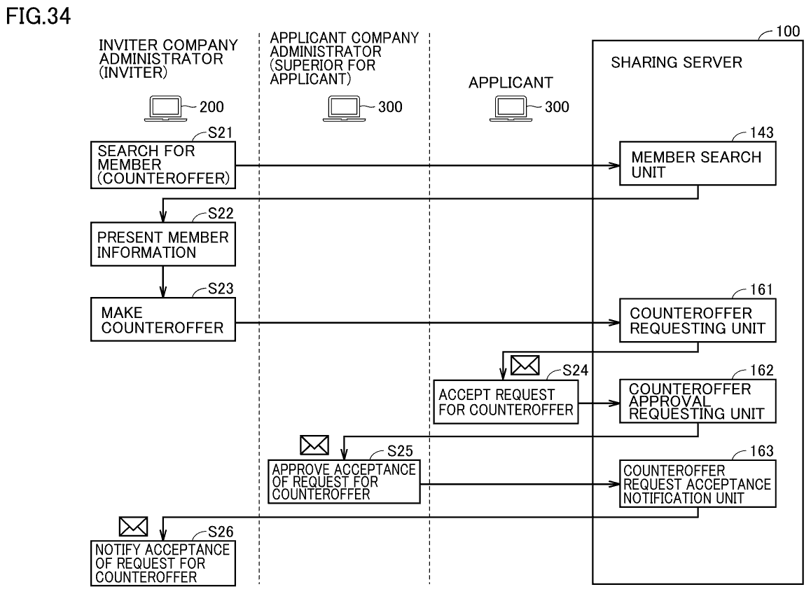

Next, a modification 2 will be described with reference to FIGS. 34 to 36. In modification 2, the following describes a counteroffer function by which one selected by an inviter from a large number of members can be prompted to apply for an invitation for an invitation business.

### Background as to Proposal of Counteroffer Function

In the crowdsourcing, in general, an inviter discloses information for an invitation case and waits for an application from one who is interested in the content of the invitation case. However, in such an invitation method, it may take a time to receive a response from an applicant. Further, it is unknown whether or not there will be an application from one having skill expected by the inviter.

Therefore, it is conceivable that the inviter searches for a member and designates an appropriate member (counteroffer). However, in a state in which the member ID and the name of the member are informed to the inviter, it is difficult for the inviter to designate a truly desired applicant. Moreover, in order to prevent secret information from being leaked to a company or the like having a rival relationship, member information of the company or the like having the rival relationship must be excluded from the search result.

In view of such a background, in modification 2, a search result including detailed profile information of a member is provided to an inviter who has performed a member search. Further, in modification 2, the member information of the company or the like having the rival relationship with the company or the like to which the inviter belongs is excluded from the search result. Hereinafter, modification 2 will be described in detail with reference to figures.

FIG. 34 is a diagram for illustrating functions of sharing server 100, inviter device 200, and applicant device 300 according to modification 2.

As shown in FIG. 34, sharing server 100 functionally includes a counteroffer requesting unit 161, a counteroffer approval requesting unit 162, and a counteroffer request acceptance notification unit 163 in addition to member search unit 143. These various functions are realized by processor 101, memory 102, storage 103, and communication interface 104 included in sharing server 100.

As described above, member search unit 143 has a function of searching for a member of matching system 1. In particular, in modification 2, member search unit 143 has a function of providing detailed profile information of a member to a searcher. When receiving a search operation of the inviter, inviter device 200 performs a member search process (step S21). In particular, in step S21, inviter device 200 receives a search operation for allowing the inviter to make a counteroffer. Member search unit 143 provides the member information registered in member database 122 to inviter device 200. The provided member information includes detailed profile information of the member. However, member search unit 143 excludes, from the search result, the member information of the company or the like having the rival relationship with the company or the like to which the inviter belongs.

Inviter device 200 receives the member information (search result) from member search unit 143, and presents the member information as the search result on display 205 (step S22). Thereafter, inviter device 200 receives an operation of selecting, by the inviter, an applicant from the search result. That is, the inviter selects a member to whom a counteroffer is to be made based on the search result and operates inviter device 200 to make a counteroffer (step S23). Inviter device 200 transmits the member ID of the target member for the counteroffer to sharing server 100.

Counteroffer requesting unit 161 receives, from inviter device 200, the member ID of the target member for the counteroffer. Counteroffer requesting unit 161 specifies the member corresponding to the received member ID. Counteroffer requesting unit 161 notifies applicant device 300 of the target member for the counteroffer that the request for counteroffer has been received. This notification may include information of the invitation case for the counteroffer. The target member for the counteroffer receives the request for counteroffer by applicant device 300. The “request” received here is an example of “information for prompting the applicant to make an application”. The target member for the counteroffer determines whether to accept the request for counteroffer. The target member for the counteroffer can use applicant device 300 to perform an operation of accepting the request for counteroffer or an operation of rejecting the request for counteroffer. For example, applicant device 300 accepts the request for counteroffer (step S24). Applicant device 300 having accepted the request for counteroffer transmits application information to counteroffer approval requesting unit 162.

Counteroffer approval requesting unit 162 transmits the application information of the subordinate to the superior for the applicant. Counteroffer approval requesting unit 162 specifies the member ID of the superior, who is the administrator for the applicant, based on the relationship between the member ID of the applicant and the member ID of the superior, which are registered in member database 122. The superior for the applicant checks the application information in his/her own applicant device 300 and approves the application (step S25).

Counteroffer request acceptance notification unit 163 receives the approval information from the superior for the applicant. Counteroffer request acceptance notification unit 163 receives the application from the applicant on condition that the approval information is received. Counteroffer request acceptance notification unit 163 notifies inviter device 200 that the application from the member to whom the counteroffer has been made is received. Based on the notification, inviter device 200 notifies the inviter that the counteroffer is accepted (step S26). More specifically, inviter device 200 presents, on display 205, information for notifying the inviter that the counteroffer is accepted.

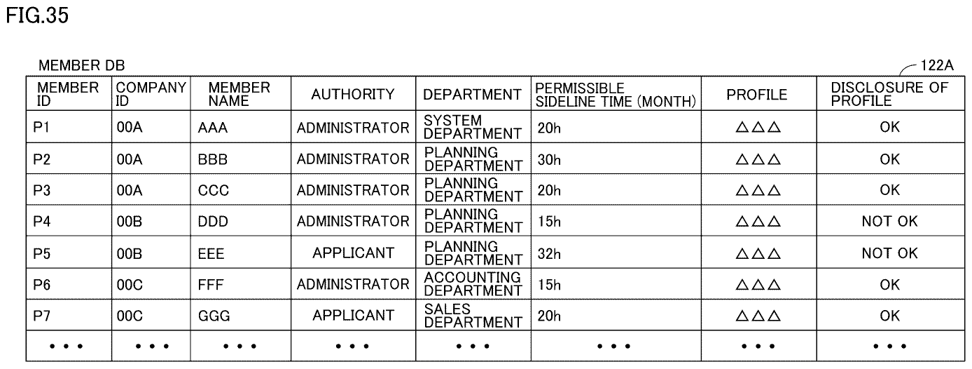

FIG. 35 is a diagram showing an example of member database 122A according to a modification 2. In member database 122A shown in FIG. 35, profile information and profile disclosure information indicating whether to disclose the profile are added as compared with member database 122 shown in FIG. 4.

Matching system 1 gives an authority to a member to register his/her profile information into member database 122A and modify it using applicant device 300. The member registers various pieces of profile information of the member into member database 122A using applicant device 300. The pieces of profile information include, for example, the member's SPI (Synthetic Personality Inventory) information, the member's job history, the member's record, the member's possessed qualification, and the like.

The member sets the profile disclosure information using applicant device 300. The profile information of the member for which the profile disclosure information is set to be enabled is provided to the searcher. The profile information of the member for which the profile disclosure information is set to be disabled is not provided to the searcher. Sharing server 100 registers the profile disclosure information into member database 122A based on the setting selected by each member. In this way, sharing server 100 receives an input of information indicating whether to permit the profile information to be included in the search result, from each of the plurality of members.

Here, it has been illustratively described that whether to permit the disclosure of the profile information of the member is determined based on the setting of the profile disclosure information. However, sharing server 100 may receive a setting operation as to whether to permit the disclosure on the basis of the type of the profile information. Thus, for example, the member can set the record and the possessed qualification to be disclosed, and can set the information of the SPI not to be disclosed. Alternatively, when the age is included in the profile information, the member can set the age not to be disclosed and set the other pieces of profile information to be disclosed. In this case, sharing server 100 registers a plurality of pieces of profile information of each of a plurality of registrants (members) into member database 122A. Sharing server 100 receives, from each of the plurality of registrants, an input for setting a scope of disclosure as a search result among the plurality of pieces of profile information.

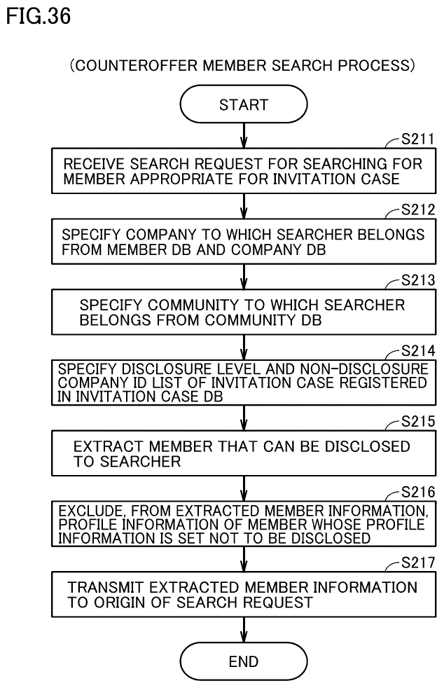

FIG. 36 is a flowchart showing a processing procedure of a counteroffer member search process according to modification 2. The process based on this flowchart is performed by sharing server 100.

First, sharing server 100 receives a search request for allowing a searcher to search for a member appropriate for an invitation case (step S211). Here, the searcher is an inviter who has the invitation case. The inviter searches for a member using his/her inviter device 200 in order to make a counteroffer to a member having a skill appropriate for the invitation case. The search request for the inviter is received by sharing server 100 in step S211. The search request may include the member ID of the searcher and the case ID of the invitation case.

Next, sharing server 100 specifies a company to which the searcher belongs from member database 122A and company database 121 (step S212). Next, sharing server 100 specifies a community to which the searcher belongs from community database 123 (step S213).

Next, sharing server 100 specifies disclosure level and non-disclosure company

ID list of the invitation case registered in invitation case database 124 (step S214). Next, sharing server 100 extracts a member that can be disclosed to the searcher (step S215).

More specifically, sharing server 100 specifies, based on the non-disclosure company list and the disclosure level in invitation case database 124, a company to which the invitation case possessed by the searcher (inviter) should not be disclosed. Sharing server 100 determines that a member belonging to such a company is a member who cannot be disclosed to the searcher. Sharing server 100 extracts a member other than the member belonging to such a company, as a member who can be disclosed to the searcher.

Next, sharing server 100 refers to member database 122A and excludes, from the extracted member information, the profile information of a member whose profile information is set not to be disclosed (step S216).

Next, sharing server 100 transmits the extracted member information to the origin of the search request (step S217), and ends the process that is based on this flowchart. Inviter device 200 serving as the origin of the search request receives the member information transmitted from sharing server 100, and presents the information on display 205. In the information presented on display 205, the ID, name, and profile information of each extracted member are presented. However, regarding a member whose profile information is set not to be disclosed, the ID and name of the member are presented, and the profile information thereof is not presented.

As described above, according to modification 2, the inviter can search for a member considered to be optimal for application for the invitation business while referring to detailed profile information of the member, and can make a counteroffer to the member. Moreover, a member in a company or the like having a rival relationship with the company or community to which the inviter belongs are excluded from the members presented as the search result. Therefore, it is possible to prevent such a failure that the inviter places an order for a business to a member of the rival company. Further, since the member can determine whether to disclose the profile information by himself/herself, it is possible to provide a system in which the free will of each member is respected.

It should be noted that the member may be allowed to set whether to disclose not only the profile information but also the name. Moreover, some categories may be provided in the profile information such that the member can set whether to disclose the profile information on the category basis.

By adding the counteroffer function described above to matching system 1, the inviter can check the profile information of the member permitted to view the invitation case. Further, the inviter can prompt the member, to whom the inviter wishes to place an order, to make an application. Moreover, the member who is prompted to make an application from the inviter can view the case information and can agree to or reject to make an application. Moreover, each member can decide whether to disclose the profile information at the time of registering and editing the member information. Thus, the inviter can actively select one to whom a counteroffer is to be made and allows an optimal applicant to engage in the business promptly.

### Modification 3

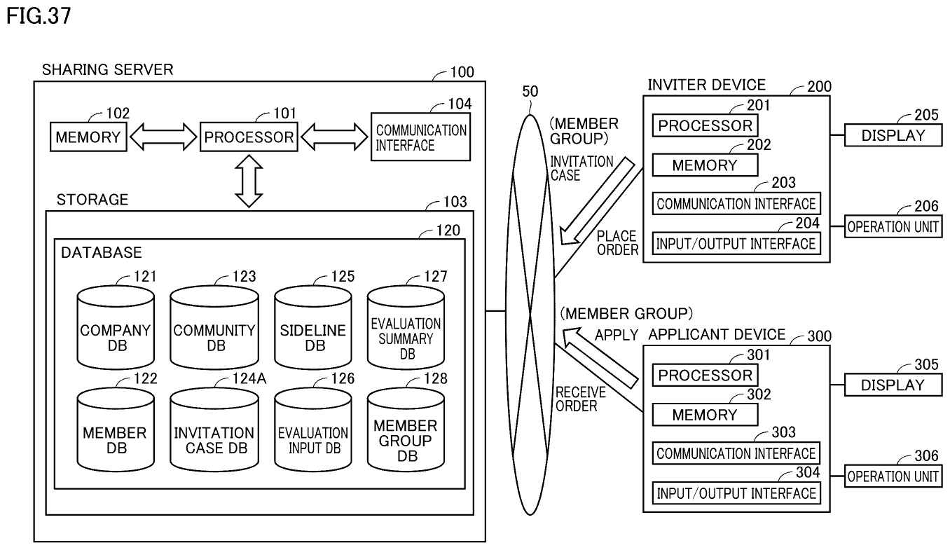

Next, a modification 3 will be described with reference to FIGS. 37 to 41. In modification 3, the following describes a member group application function in which a plurality of members can apply for an invitation business as a group.

### Background as to Proposal of Member Group Application Function

In the crowdsourcing, in general, an inviter discloses information on an invitation case, and an individual who is interested in the content of the invitation case applies for the invitation. However, there are not a few cases that should be or are desired to be handled by a team made up of a plurality of persons, such as a comprehensive businesses from business planning to acquisition of intellectual property rights associated with the planning. For this reason, when the number of persons for the invitation is limited to one, it is difficult that a person who wishes to receive an order undertakes a business beyond that can be handled by an individual.

In view of such a background, in modification 3, the member group application function is provided so as to allow a plurality of members to apply for an invitation business as a group. Hereinafter, modification 3 will be described in detail.

FIG. 37 is a block diagram showing configurations of sharing server 100, inviter device 200, and applicant device 300 according to modification 3. In the block diagram shown in FIG. 37, a member group database 128 is added as compared with the block diagram shown in FIG. 2. In invitation case database 124A shown in FIG. 37, a function by which an invitation case that permits a member group to make an application can be registered is added as compared with invitation case database 124 shown in FIG. 6.

A member group constituted of a plurality of members is registered in member group database 128. By using inviter device 200, the inviter can register, into invitation case database 124A, an invitation case that permits a member group to make an application. By using applicant device 300, an applicant can apply, as the member group registered in member group database 128, for the invitation case that permits a member group to make an application.

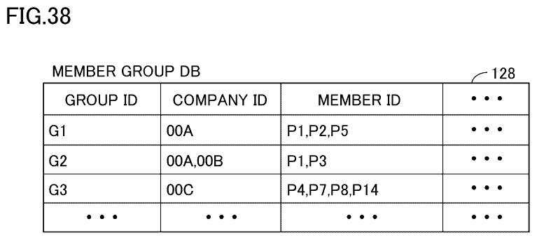

FIG. 38 is a diagram showing an exemplary member group database 128 according to modification 3. Pieces of member group information are registered in member group database 128. The pieces of member group information include a group ID for identifying the member group, the company ID of a company to which each member of the member group belongs, the member ID of each member of the member group, and the like.

Hereinafter, respective member groups corresponding to group IDs may be referred to as a member group G1, a member group G2, a member group G3, . . . , using the group IDs.

Member group G1 is constituted of three members identified by the member IDs=P1, P2, P5. Since the company ID registered to correspond to member group G1 is 00A, all the three members belong to company A.

Member group G2 is constituted of two members identified by the member IDs=P1, P3. Since the company IDs registered to correspond to member group G2 are 00A and 00B, it is understandable that one of the two members belongs to company A and the other belongs to company B. As understood from a comparison between member group G1 and member group G2, the member ID=P1 is registered in both member groups G1 and G2. Therefore, member P1 belongs to the two member groups.

Member group G3 is constituted of four members identified by the member

IDs=P4, P7, P8, P14. Since the company ID registered to correspond to member group G3 is 00C, all the four members belong to company C.

As shown in FIG. 37, member group database 128 is stored in storage 103 of sharing server 100. A member forms a member group by obtaining an agreement from the other members who have become familiar with the member through the same company, community, or the like and registers the member group into member group database 128. The “member group” is an example of the “application group”.

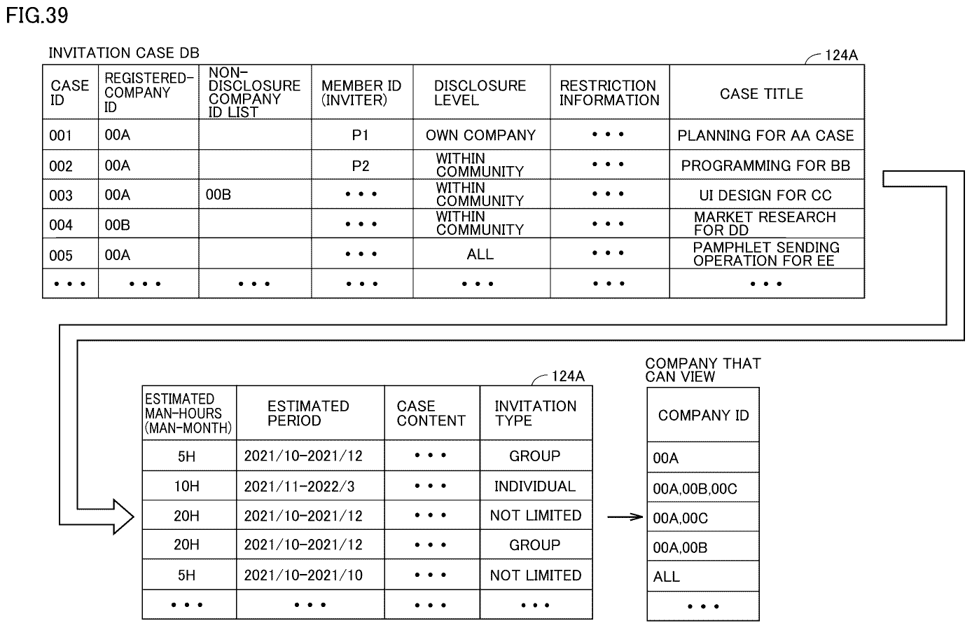

FIG. 39 is a diagram showing an example of invitation case database 124A according to modification 3. As compared with invitation case database 124 shown in FIG. 6, invitation type information is added to invitation case database 124A shown in FIG. 39. The inviter operates inviter device 200 to set an invitation type. Based on the setting, sharing server 100 registers the invitation type into invitation case database 124A in association with the business information.

The inviter can select the invitation type from group and individual. When the inviter selects no invitation type, it is regarded that the invitation type of the invitation case is not limited to group or individual. An order for a case in which the invitation type is set to group can be received by a member group. An order for a case in which the invitation type is set to individual can be received by an individual member. An order for a case in which the invitation type is not limited can be received by both a member group and an individual. The “invitation type information” is an example of “information by which it can be specified that a business for which an invitation is made to an order receiver is a business for which a plurality of applicants should jointly apply”.

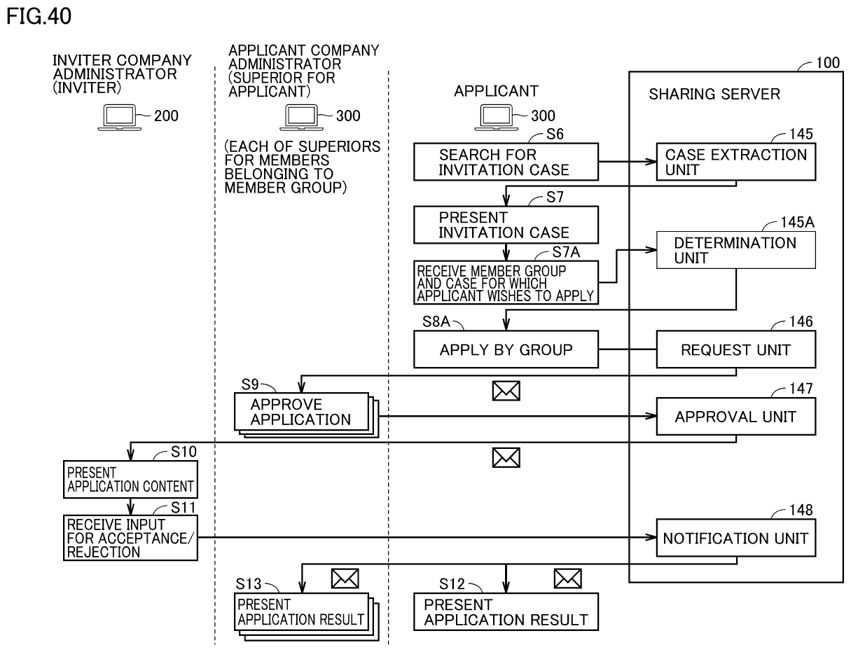

FIG. 40 is a diagram for illustrating functions of sharing server 100, inviter device 200, and applicant device 300 according to modification 3. In FIG. 40, a determination unit 145A is added to sharing server 100 as compared with FIG. 11. Moreover, in FIG. 40, as compared with FIG. 11, a step S7A is added after step S7, and a step S8A for group application is employed instead of step S8 for application.

Here, it is assumed that an applicant belongs to a plurality of member groups. The applicant operates applicant device 300 to search for an invitation case (step S6). Applicant device 300 transmits a search request to case extraction unit 145 of sharing server 100.

When the search request is received, case extraction unit 145 extracts cases each permitted to be viewed by the applicant from the invitation cases registered in invitation case database 124 as described with reference to FIG. 11. The cases extracted by case extraction unit 145 include cases in which the invitation types are any of “group”, “individual”, and “not limited”. Case extraction unit 145 transmits the extracted invitation cases to applicant device 300. Applicant device 300 receives the invitation cases from case extraction unit 145. Applicant device 300 presents the received invitation cases on display 305 (step S7).

Display 305 presents a disclosure level, a case title, an estimated man-hour, an estimated period, a case content, an invitation type, and the like on the invitation case basis. When the applicant wishes to make an application as a member group, the applicant designates the member group by using operation unit 306 such as a mouse and a keyboard, and selects a case in which the invitation type is “group” or “not limited”. Applicant device 300 receives the member group and the case for which the applicant wishes to apply, based on the operation of the applicant (step S7A). Applicant device 300 transmits the group ID of the received member group and the case ID of the received case to sharing server 100. Determination unit 145A of sharing server 100 acquires the group ID and the case ID.

Determination unit 145A accesses member group database 128 and specifies a member ID registered to correspond to the acquired group ID. Determination unit 145A accesses member database 122 and specifies a company ID corresponding to the specified member ID.

Determination unit 145A accesses community database 123 and specifies the community ID of the community to which the company of the specified company ID belongs. Determination unit 145A accesses invitation case database 124A and specifies a company ID (company ID of the inviter), a non-disclosure company ID, a disclosure level, and an invitation type each registered to correspond to the acquired case ID.

Determination unit 145A determines whether or not the invitation case received by applicant device 300 is a case for which application by the member group designated by the applicant is permitted, based on the information specified as described above. In other words, determination unit 145A determines whether to permit an application by a member group.

For example, when one of the members in the member group belongs to a company listed in the non-disclosure company ID list corresponding to the invitation case, determination unit 145A does not permit the application by the member group. Alternatively, determination unit 145A does not permit the application by the member group when one of the members in the member group belongs to a company outside the community even though the disclosure level of the invitation case is “within community”.

Determination unit 145A returns the determination result to applicant device 300. FIG. 40 shows a flow when the application by the member group is permitted by determination unit 145A. When the application by the member group is permitted by determination unit 145A, applicant device 300 receives the application by the member group (step S8A). For example, applicant device 300 presents, on display 305, a screen indicating that the application received in step S7A is permitted and a screen for confirming whether to make an application. The applicant selects the application using operation unit 306 such as a mouse and a keyboard.

When the application by the member group is received (step S8A), applicant device 300 transmits the application information to sharing server 100. Request unit 146 of sharing server 100 acquires the application information. The subsequent processes are the same as those described with reference to FIG. 11. However, request unit 146 transmits the application information to the superior for each of the members belonging to the member group. Therefore, the application approval process of step S9 is performed for each superior for each member belonging to the member group. Therefore, approval unit 147 receives, from the plurality of superiors, pieces of approval information indicating approvals for the application from the subordinates or pieces of rejection information indicating rejections of the application from the subordinates.

Approval unit 147 receives the application from the applicant when the pieces of approval information are obtained from all the superiors for the members belonging to the member group. Approval unit 147 having received the application from the applicant transmits the application information to inviter device 200. Inviter device 200 presents the content of the application on display 205 (step S10) as described above with reference to FIG. 11. The inviter inputs, to inviter device 200, a result of determination for acceptance or rejection. Inviter device 200 receives the input result (step S11), and transmits the received result for acceptance or rejection to notification unit 148 of sharing server 100.

Notification unit 148 transmits the application result (result for acceptance or rejection) to applicant device 300 of the applicant and applicant device 300 of the superior (administrator). It should be noted that notification unit 148 transmits the application result to the superior for each member belonging to the member group.

Applicant device 300 of the applicant and applicant device 300 of the superior for each member belonging to the member group present the applicant result on displays 305 (steps S12, S13). Each of the applicant and the superior for each member belonging to the member group sees the presentation of display 305 so as to check the application result.

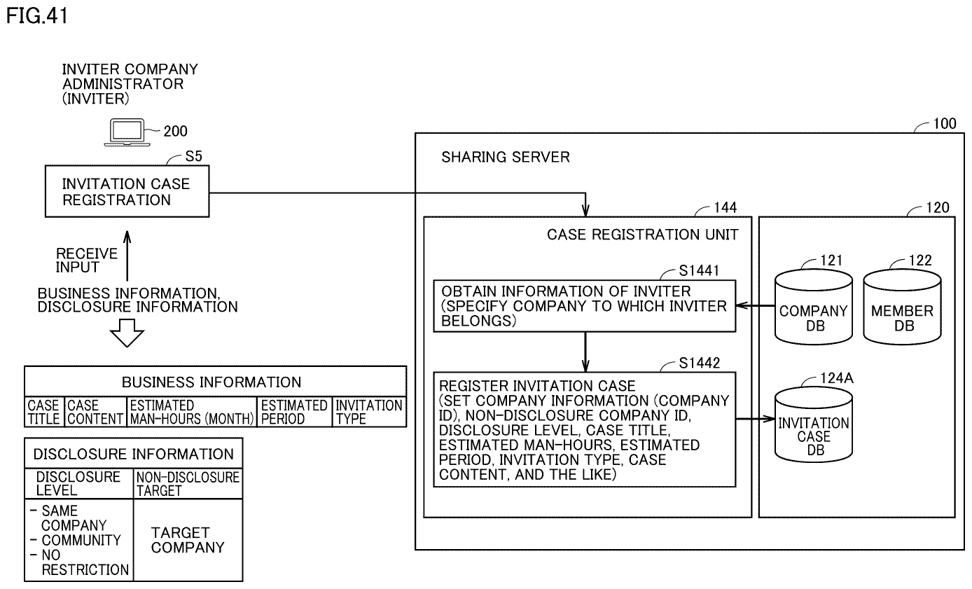

FIG. 41 is a diagram for illustrating a procedure for registering an invitation case into invitation case database 124A according to modification 3. In FIG. 41, an invitation type is added to business information to be input to inviter device 200, as compared with FIG. 13.

In modification 3, when an inviter who registers an invitation case inputs business information and disclosure information of the invitation case to inviter device 200, the invitation type of the invitation case can be included in the business information. The invitation type is either of group and individual. Case registration unit 144 of sharing server 100 registers, into invitation case database 124A, the invitation case with the invitation type selected by the inviter being included (step S1442). When the inviter does not select the invitation type, case registration unit 144 registers, into invitation case database 124A, information indicating that the invitation type is not limited. The other contents shown in FIG. 41 are the same as those of FIG. 13 described above, and therefore will not be described repeatedly here.

As described above, according to modification 3, a plurality of members can apply for an invitation case as a group. Further, according to modification 3, whether to permit an application by a member group is determined based on the relationship between the company and community to which the inviter belongs and the company and community to which each member of the member group belongs. Therefore, a member group including a member belonging to an organization having a competitive relationship with the inviter can be prevented from receiving an order of the invitation case of the inviter.

By adding the above-described member group application function to matching system 1 as described above, it is possible to provide a system in which the order receiving side can view an invitation case and apply for the invitation case as a member group. Thus, matching system 1 can handle reception and placement of an order for a large-scale business desired to be handled by a team.

### Modification 4

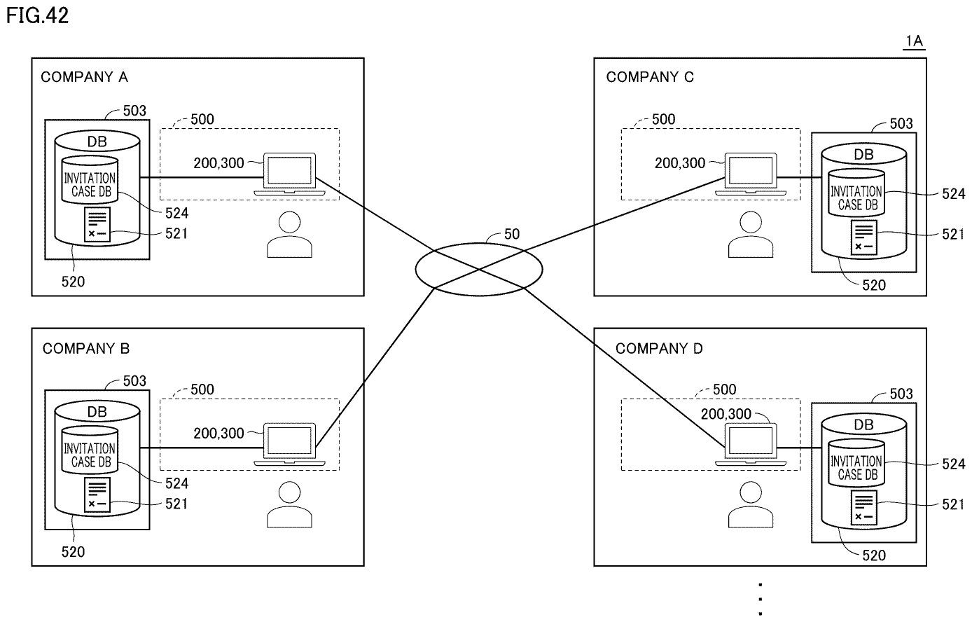

FIG. 42 is a diagram showing a configuration of a matching system 1A according to a modification 4. As shown in FIG. 42, the functions of sharing server 100 may be distributed across the systems in the companies. That is, as matching system 1, a distributed management type matching system 1A may be employed instead of centralized management type matching system 1.

The system configuration shown in FIG. 42 is the same among companies A, B, C, D, . . . . In each company, user device 500, a database 520, and a storage 503 that stores the database are disposed. When a member operates user device 500 as an inviter, user device 500 functions as inviter device 200. When the member operates user device 500 as an applicant, user device 500 functions as applicant device 300.

User device 500 is constituted of, for example, a server. User device 500 is an exemplary computing device including inviter device 200 and applicant device 300. As with each of inviter device 200 and applicant device 300, user device 500 includes a processor, a memory that stores a program or the like necessary for arithmetic processing of the processor, a communication interface, and the like.

Database 520 has the function of database 120 shown in FIG. 2, and includes an invitation case database 524 instead of invitation case database 124, and other various databases. In invitation case database 524 of company A, an invitation case prepared by an employee or the like of company A as an inviter is registered. In invitation case database 524 of company B, an invitation case prepared by an employee or the like of company B as an inviter is registered. Similarly, in invitation case database 524 of each of the other companies, an invitation case prepared by an employee of each of the companies as an inviter is registered.

A disclosure permission list 521 is registered in database 520. Disclosure permission list 521 includes a list of groups (companies, communities, or the like) to which an invitation case is permitted to be disclosed. Disclosure permission list 521 includes information corresponding to the “non-disclosure company ID list” and the “disclosure level” among the pieces of information registered in invitation case database 124 shown in FIG. 6. User device 500 registers, into database 520, disclosure permission list 521 (disclosure information) indicating the invitation case (business information) and the scope of disclosure of the invitation case.

Based on disclosure permission list 521, user device 500 of company A determines a company or community to which the invitation case is to be disclosed and a company or community to which the invitation case is not to be disclosed. User device 500 of company A transmits the invitation case to each company or community based on the determination. For example, when user device 500 of company A determines to disclose a certain invitation case to company C and not to disclose the invitation case to companies B and D, user device 500 of company A transmits the invitation case to company C and does not transmit the invitation case to companies B and D.

User device 500 of each of companies B, C, D, . . . operates based on disclosure permission list 521 in the same manner as user device 500 of company A. Thus, user device 500 determines, based on disclosure permission list 521, the invitation case permitted to be disclosed to the applicant among the invitation cases registered in database 520, and provides applicant device 300 with the invitation case permitted to be disclosed to the applicant.

According to modification 4, a server for managing the system in a centralized manner does not need to be provided in the matching system.

### Modification 5

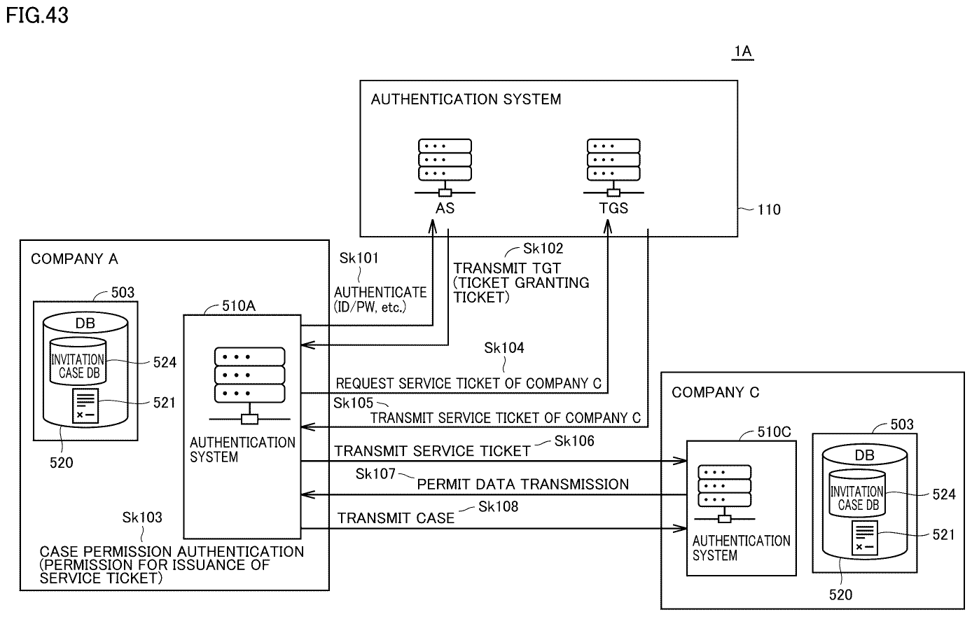

A modification 5 will be described with reference to FIG. 43. FIG. 43 is a diagram showing an example (modification 5) in which Kerberos authentication is applied to matching system 1A. As shown in FIG. 43, the Kerberos authentication may be applied to authentication between companies in matching system 1A. The Kerberos authentication is one of network authentication methods applied between a server and a client.

Here, modification 5 will be described by exemplifying companies A and C among the plurality of companies. As shown in FIG. 43, an authentication system 510A is disposed in company A, and an authentication system 510C is disposed in company C. An authentication system 110 is a KDC (key distribution center). Authentication system 110 is operated by an authentication institution, for example. Authentication system 110 is constituted of a server located in the authentication institution. Each of authentication systems 510A, 510C is constituted of, for example, user device 500 (see FIG. 42).

Authentication system 110 has a function of issuing a TGT (Ticket Granting Ticket). Authentication system 110 includes an AS (Authentication Server) and a TGS (Ticket Granting Server). The AS issues the TGT (Ticket Granting Ticket). The TGT is a ticket to obtain a service ticket. The TGS issues a service ticket. Company A can transmit data to company C by obtaining the service ticket.

Here, it will be illustratively described that company A transmits an invitation case to company C after performing the Kerberos authentication. Therefore, here, company A is an inviter, and company C is an applicant. First, authentication system 510A requests authentication system 110 to perform an authentication procedure (step Sk101). For example, authentication system 510A transmits information necessary for authentication, such as an ID and a password for login, to the AS of authentication system 110. Authentication system 510A may use a public authentication key technique for the authentication procedure.

The AS of authentication system 110 performs authentication based on the information received from authentication system 510A, and then transmits the TGT to authentication system 510A (step Sk102). Authentication system 510A performs permission authentication for the case and obtains an issuance permission for the service ticket (step Sk103).

Next, authentication system 510A requests a service ticket of company C to the TGS of authentication system 110 (step Sk104). On this occasion, authentication system 510A presents, to the TGS, the TGT issued by the AS. The TGS checks the TGT, and then transmits the service ticket of the company C to authentication system 510A (step Sk105).

Next, authentication system 510A transmits the service ticket to authentication system 510C of company C in order to obtain a transmission permission from company C (step Sk106). Authentication system 510C obtains the service ticket. Authentication system 510C transmits a data transmission permission to authentication system 510A (step Sk107).

Then, authentication system 510A transmits, to authentication system 510C, the case permitted to be disclosed to company C by disclosure permission list 521 among the invitation cases registered in invitation case database 524. Thus, company A can allow the applicant of company C to view the invitation case of company A. It should be noted that instead of each company storing disclosure permission list 521 of the company, disclosure permission lists 521 of all the companies may be stored in authentication system 110. In this case, authentication system 110 has a function of determining a viewing authority for each invitation case.

When the Kerberos authentication is applied to matching system 1, company A can use the obtained TGT, thereby simplifying the authentication procedure when transmitting a case to a company other than company C. For example, when the case is desired to be transmitted to company D, authentication system 510A of company A requests a service ticket of company D to the TGS with the obtained TGT being presented. When there is no problem with the TGT, the TGS issues the service ticket of company D to authentication system 510A.

By using the Kerberos authentication as described above, a Single Sign On technique can be implemented in matching system 1. As a result, for example, when data such as an invitation case is transmitted from company A to another company, it is not necessary to perform authentication for each company. It should be noted that here, companies A and C are shown as an example of the plurality of companies. However, the Kerberos authentication as described above may be applied as an authentication method among three or more companies.

As described above, according to the present embodiment, since a company on the order placer side can provide case information to a limited company, confidential information can be prevented from being leaked. Since a company on the order receiver side can receive case information from a company having reliability ensured by matching system 1, 1A, it is possible to obtain case information having high reliability.

According to the present embodiment, the company to which disclosure is not to be made can be set by the inviter separately from the disclosure level (see FIG. 13). That is, in the present embodiment, inviter device 200 receives an operation of inputting a target group (non-disclosure target company) to which business information is prohibited from being disclosed, and transmits, to sharing server 100, information (“non-disclosure target” in the “disclosure information”) by which the received target group can be specified. Sharing server 100 prohibits the disclosure of the business information to the applicant belonging to the target group even though the disclosure level is a level (disclosure level) that permits the disclosure of the business information to the target group (S1442). Therefore, according to the present embodiment, it is possible to individually set a company to which the invitation case is desired to be restricted from being disclosed.

According to the present embodiment, since an administrator of a company to which an employee belongs can check the content of a business for which an order has been received by the employee, confidential information can be prevented from being leaked. Further, according to the present embodiment, a company on the order receiver side can know main job time and sideline time of the employee. Therefore, the company on the order receiver side can manage the health of the employee.

As described above, according to the present embodiment, it is possible to provide matching systems 1, 1A each functioning as a crowdsourcing platform. In order to use the crowdsourcing to find a more appropriate person, it is desirable to further broaden the scope of the crowdsourcing, rather than keeping the scope of the crowdsourcing within a particular company or a small number of companies. In this case, a stake between an inviter who makes an invitation to an order receiver for a business and an applicant who applies for the invitation need to be taken into consideration. According to each of matching systems 1, 1A according to the present embodiment, it is possible to select an appropriate applicant in consideration of the stake between the inviter and the applicant.

Each of sharing server 100 and user device 500 is an exemplary computing device that communicates with an applicant device and that can access a database. Sharing server 100 and user device 500 register business information and disclosure information indicating a scope of disclosure of the business information into databases 120, 520. Sharing server 100 and user device 500 determine business information permitted to be disclosed to an applicant from pieces of business information registered in databases 120, 520 based on corresponding disclosure information, and provide (transmit), to applicant device 300, the business information permitted to be disclosed to the applicant. For each of a first applicant to a third applicant, sharing server 100 and user device 500 determine whether to permit disclosure thereto in accordance with a disclosure level (step S1452A).

In the disclosure information, the plurality of disclosure levels including “same company”, “community”, and “not limited” are set. The plurality of disclosure levels includes a first level and a second level. The first level (for example, “within own company”) corresponds to permitting the disclosure of the business information to a first applicant belonging to a first group and prohibiting the disclosure of the business information to an applicant not belonging to the first group (see FIG. 22). The second level (for example, “within community”) corresponds to permitting the disclosure of the business information to an applicant belonging to either of the first group and a community group that forms a community relationship with the first group, and prohibiting the disclosure of the business information to an applicant not belonging to either of the first group and the community group (see FIG. 22). The third level corresponds to permitting the disclosure of the business information to an applicant belonging to the first group and a specific community group different from the community group corresponding to the second level and having the community relationship with the first group, and prohibiting the disclosure of the business information to the applicant belonging to neither of the first group and the specific community group (see the modification of FIG. 22).

The plurality of disclosure levels include a disclosure level (see FIG. 22) corresponding to permitting the disclosure of the business information to an applicant regardless of a group to which the applicant belongs. Attribute data (community ID) by which the community group can be specified is registered in databases 120, 520, and sharing server 100 and user device 500 specify the applicant to whom the disclosure of the business information is permitted, based on the disclosure information and the attribute data.

When input of an target group (the company ID of a company that is a non-disclosure target) for which the disclosure of the business information is prohibited is received, sharing server 100 and user device 500 prohibit the disclosure of the business information to an applicant belonging to the target group even though the disclosure level is a level that permits the disclosure of the business information to the target group.

Sharing server 100 receives, from inviter device 200, a request for searching for pieces of information of a plurality of registrants (members) registered in database 120 (step S21), and provides, to the inviter device, a search result that is based on the received request (step S22). Inviter device 200 receives an operation of selecting, from the search result by the inviter, an encouraged applicant to be encouraged to make an application as an applicant (step S23), and transmits the identification information of the selected encouraged applicant (member ID of the member targeted for the counteroffer) to sharing server 100. Sharing server 100 transmits, to applicant device 300 of the selected encouraged applicant, information for prompting to make an application (step S24).

Sharing server 100 registers a plurality of pieces of profile information of each of a plurality of registrants (members) in database 120 (see FIG. 35). Sharing server 100 receives, from each of the plurality of registrants, an input for setting a scope of disclosure as the search result among the plurality of pieces of profile information (the operation of setting whether to permit the disclosure is received on the basis of the type of the profile information). Sharing server 100 receives an input of invitation type information (invitation type shown in FIG. 41) by which it can be specified whether the business for which the invitation is made to the order receiver is a group business for which an order can be received when a plurality of applicants apply therefor jointly or a business for which an order can be received in response to application from a single applicant. Sharing server 100 registers the invitation type information into database 120 in association with the business information (step S1442).

Sharing server 100 registers, into database 120, an application group (member group) constituted of a plurality of applicants. Sharing server 100 receives an application from the application group with regard to business information permitted to be disclosed to all the applicants belonging to the application group (determination unit 145A).

The present embodiment has configurations listed below.
(a-1) An evaluation system for evaluating an order receiver who has applied for a business comprises: a first evaluator device to be operated by one or more evaluators belonging to a first group; and a computing device that communicates with the first evaluator device and that is able to access a database, wherein the first evaluator device receives an input of an evaluation for the order receiver and transmits the received evaluation to the computing device, the computing device registers, into the database on an order receiver basis, first evaluation information that is based on the evaluation received from the first evaluator device, and when the computing device receives a viewing request in a first communication established in accordance with identification information by which one is able to be identified to belong to the first group, the computing device transmits the first evaluation information to an origin of transmission of the viewing request in the first communication.
(a-2) The evaluation system further comprises a second evaluator device to be operated by one or more second evaluator belonging to a second group different from the first group, the second evaluator device receives an input of an evaluation for an order receiver and transmits the received evaluation to the computing device, the computing device registers, into the database on the order receiver basis, second evaluation information that is based on the evaluation received from the second evaluator device, and when the computing device receives a viewing request in a second communication established in accordance with identification information by which one is able to be identified to belong to the second group, the computing device transmits the second evaluation information to an origin of transmission of the viewing request in the second communication.
(a-3) The first group is constituted of a first company, and the second group is constituted of a second company different from the first company.
(a-4) The first group is constituted of a first department of the first company, and the second group is constituted of a second department of the first company.
(a-5) When the computing device receives evaluations for a predetermined order receiver from a plurality of evaluators belonging to the first group, the computing device calculates an average value of the evaluations made for the predetermined order receiver by the plurality of evaluators, and the computing device transmits the average value as the first evaluation information for the predetermined order receiver to the origin of transmission of the viewing request in the first communication.
(a-6) The first group includes one or more evaluators belonging to a first division group and one or more evaluators belonging to a second division group different from the first division group, based on evaluations for a predetermined order receiver from a plurality of evaluators belonging to the first division group, the computing device calculates a first average value that is an average value of the evaluations for the predetermined order receiver, based on evaluations for the predetermined order receiver from a plurality of evaluators belonging to the second division group, the computing device calculates a second average value that is an average value of the evaluations for the predetermined order receiver, based on the evaluations for the predetermined order receiver from the plurality of evaluators belonging to the first group, the computing device calculates a third average value that is an average value of the evaluations for the predetermined order receiver, when the computing device receives a viewing request in a third communication established in accordance with identification information by which one is able to be identified to belong to the first division group, the computing device transmits each of the first average value and the third average value as the first evaluation information for the predetermined order receiver to an origin of transmission of the viewing request in the third communication, and when the computing device receives a viewing request in a fourth communication established in accordance with identification information by which one is able to be identified to belong to the second division group, the computing device transmits each of the second average value and the third average value as the first evaluation information for the predetermined order receiver to an origin of transmission of the viewing request in the fourth communication.
(a-7) A list of order receivers is registered in the database, when the first evaluator device receives an operation of searching in the list, the first evaluator device transmits a search request to the computing device, when the computing device receives the search request, the computing device transmits, to the origin of transmission of the viewing request in the first communication, a search result in which an order receiver who has an evaluation specified by the first evaluation information to have a magnitude not satisfying a criterion is excluded from the list.
(a-8) In the database, a plurality of pieces of business information are registered together with disclosure information indicating a scope of disclosure to an applicant, the evaluation system further comprises an applicant device to be operated by an applicant belonging to the second group, and the computing device determines, based on the disclosure information, business information permitted to be disclosed to the applicant belonging to the second group among the plurality of pieces of business information registered in the database, and provides the applicant device with the business information permitted to be disclosed to the applicant belonging to the second group.
(a-9) An evaluator device to be operated by one or more evaluators belonging to a first group comprises: an interface that receives an operation of inputting an evaluation for an order receiver who has applied for a business; a receiving unit that receives a viewing request; a display; and a processor that transmits the evaluation received by the interface and the viewing request received by the receiving unit to a computing device that is able to access a database, wherein the processor causes the display to present the evaluation made by each of the one or more evaluators belonging to the first group when the viewing request is made.
(a-10) A method of evaluating an order receiver who has applied for a business comprises: communicating with a first evaluator device operated by one or more evaluators belonging to a first group; receiving, from the first evaluator device, an evaluation for the order receiver; registering, into a database, first evaluation information that is based on the evaluation received from the first evaluator device; and when a viewing request is received in a first communication established in accordance with identification information by which one is able to be identified to belong to the first group, transmitting the first evaluation information to an origin of transmission of the viewing request in the first communication.
(b-1) An evaluation system for evaluating an inviter who makes an invitation to an applicant for a business comprises: a first evaluator device to be operated by one or more evaluators belonging to a first group; and a computing device that communications with the first evaluator device and that is able to access a database, wherein the first evaluator device receives an input of an evaluation for the inviter and transmits the received evaluation to the computing device, the computing device registers, into the database on an inviter basis, first evaluation information that is based on the evaluation received from the first evaluator device, and when the computing device receives a viewing request in a first communication established in accordance with identification information by which one is able to be identified to belong to the first group, the computing device transmits the first evaluation information to an origin of transmission of the viewing request in the first communication.
(b-2) The evaluation system further comprises a second evaluator device to be operated by one or more second evaluators belonging to a second group different from the first group, wherein the second evaluator device receives an input of an evaluation for the inviter and transmits the received evaluation to the computing device, the computing device registers, into the database on the inviter basis, second evaluation information that is based on the evaluation received from the second evaluator device, and when the computing device receives a viewing request in a second communication established in accordance with identification information by which one is able to be identified to belong to the second group, the computing device transmits the second evaluation information to an origin of transmission of the viewing request in the second communication.
(b-3) The first group is constituted of a first company, and the second group is constituted of a second company different from the first company.
(b-4) The first group is constituted of a first department of the first company, and the second group is constituted of a second department of the first company.
(b-5) When the computing device receives evaluations for a predetermined inviter from a plurality of evaluators belonging to the first group, the computing device calculates an average value of the evaluations made for the predetermined inviter by the plurality of evaluators, and the computing device transmits the average value as the first evaluation information for the predetermined inviter to the origin of transmission of the viewing request in the first communication.
(b-6) The first group includes one or more evaluators belonging to a first division group and one or more evaluators belonging to a second division group different from the first division group, based on evaluations for a predetermined inviter from a plurality of evaluators belonging to the first division group, the computing device calculates a first average value that is an average value of the evaluations for the predetermined inviter, based on evaluations for the predetermined inviter from a plurality of evaluators belonging to the second division group, the computing device calculates a second average value that is an average value of the evaluations for the predetermined inviter, based on evaluations for the predetermined inviter from a plurality of evaluators belonging to the first group, the computing device calculates a third average value that is an average value of the evaluations for the predetermined inviter, when the computing device receives a viewing request in a third communication established in accordance with identification information by which one is able to be identified to belong to the first division group, the computing device transmits each of the first average value and the third average value as the first evaluation information for the predetermined inviter to an origin of transmission of the viewing request in the third communication, and when the computing device receives a viewing request in a fourth communication established in accordance with identification information by which one is able to be identified to belong to the second division group, the computing device transmits each of the second average value and the third average value as the first evaluation information for the predetermined inviter to an origin of transmission of the viewing request in the fourth communication.
(b-7) A list of inviters is registered in the database, when the first evaluator device receives an operation of searching in the list, the first evaluator device transmits a search request to the computing device, when the computing device receives the search request, the computing device transmits, to the origin of transmission of the viewing request in the first communication, a search result in which an inviter who has an evaluation specified by the first evaluation information to have a magnitude not satisfying a criterion is excluded from the list.
(b-8) In the database, a plurality of pieces of business information are registered together with disclosure information indicating a scope of disclosure to an applicant, the evaluation system further comprises an applicant device to be operated by an applicant belonging to the second group, and the computing device determines, based on the disclosure information, business information permitted to be disclosed to the applicant belonging to the second group among the plurality of pieces of business information registered in the database, and provides the applicant device with the business information permitted to be disclosed to the applicant belonging to the second group.
(b-9) An evaluator device to be operated by one or more evaluators belonging to a first group comprises: an interface that receives an operation of inputting an evaluation for an inviter who makes an invitation to an applicant for a business; a receiving unit that receives a viewing request; a display; and a processor that transmits the evaluation received by the interface and the viewing request received by the receiving unit to a computing device that is able to access a database, wherein the processor causes the display to present the evaluation made by each of the one or more evaluators belonging to the first group when the viewing request is made.
(b-10) A method of evaluating an inviter who makes an invitation to an applicant for a business comprises: communicating with a first evaluator device to be operated by one or more evaluators belonging to a first group; receiving, from the first evaluator device, an evaluation for the inviter; registering, into a database, first evaluation information that is based on the evaluation received from the first evaluator device; and when a viewing request is received in a first communication established in accordance with identification information by which one is able to be identified to belong to the first group, transmitting the first evaluation information to an origin of transmission of the viewing request in the first communication.
(c-1) A matching system for matching an inviter who makes an invitation to an order receiver for a business and an applicant comprises: a first applicant device to be operated by a first applicant; and a computing device that communicates with the first applicant device and that is able to access a database, wherein the computing device registers, into the database, business information for making an invitation to the order receiver and disclosure information indicating a scope of disclosure of the business information, the computing device determines, based on corresponding disclosure information, business information permitted to be disclosed to the first applicant among pieces of business information registered in the database, the business information includes detailed information about a content of the business, and the computing device causes the first applicant device to present the business information permitted to be disclosed to the first applicant and a term included in the detailed information.
(c-2) The term included in the detailed information is an in-house term widely used in a group to which the inviter belongs.
(c-3) The computing device registers, into the database, the in-house term and a meaning of the in-house term.
(c-4) The computing device registers the in-house term into the database on the basis of the group to which the inviter belongs.
(c-5) When an operation of the first applicant for the in-house term is detected in the first applicant device, the computing device transmits, to the first applicant device, information by which the meaning of the in-house term registered in the database is able to be specified.
(c-6) The computing device searches for the in-house term included in the detailed information, and registers the business information into the database with the detected in-house term and the meaning of the in-house term being associated with each other.
(c-7) A computing device included in a matching system for matching an inviter who makes an invitation to an order receiver for a business and an applicant comprises: a communication interface that communicates with a first applicant device to be operated by a first applicant; and a processor that accesses a database, wherein the processor registers, into the database, business information for making the invitation to the order receiver and disclosure information indicating a scope of disclosure of the business information, the processor determines, based on corresponding disclosure information, business information permitted to be disclosed to the first applicant among pieces of business information registered in the database, the business information includes detailed information about a content of the business, and the processor causes the first applicant device to present the business information permitted to be disclosed to the first applicant and a meaning of a term included in the detailed information.
(c-8) A method of matching an inviter who makes an invitation to an order receiver for a business and an applicant comprises: communicating with a first applicant device operated by a first applicant; registering, into a database, business information for making the invitation to the order receiver and disclosure information indicating a scope of disclosure of the business information; and determining, based on corresponding disclosure information, business information permitted to be disclosed to the first applicant among pieces of business information registered in the database, wherein the business information includes detailed information about a content of the business, and the method further comprises causing the first applicant device to present the business information permitted to be disclosed to the first applicant and a meaning of a term included in the detailed information.
(d-1) A user device comprises a second applicant device to be operated by a second applicant different from a first applicant, a computing device determines, based on disclosure information, a business case permitted to be disclosed to the second applicant among business cases registered in the database, and provides the second applicant device with the business case permitted to be disclosed to the second applicant.
(d-2) The user device includes a third applicant device to be operated by a third applicant different from the first applicant and the second applicant, any of a plurality of disclosure levels is set for the disclosure information, and in accordance with each of the disclosure levels, the computing device determines whether to permit disclosure to each of the first applicant to the third applicant.
(d-3) The first applicant belongs to a first group, the second applicant belongs to a second group different from the first group, the plurality of disclosure levels include a first level and a second level, the first level corresponds to permitting the business case to be disclosed to the first applicant and prohibiting the business case from being disclosed to an applicant not belonging to the first group, and the second level corresponds to permitting the business case to be disclosed to an applicant belonging to any of the first group and a community group having a community relationship with the first group, and prohibiting the business case from being disclosed to an applicant not belonging to any of the first group and the community group.
(d-4) The first applicant belongs to a first group, and the second applicant belongs to a second group different from the first group, the plurality of disclosure levels include a first level, a second level, and a third level, the first level corresponds to permitting the business case to be disclosed to the first applicant and prohibiting the business case from being disclosed to an applicant not belonging to the first group, the second level corresponds to permitting the business case from being disclosed to an applicant belonging to any of the first group and a community group having a community relationship with the first group, and the third level corresponds to permitting the business case to be disclosed to an applicant belonging to each of the first group and a specific community group that is different from the community group corresponding to the second level and having the community relationship with the first group, and prohibiting the business case from being disclosed to an applicant not belonging to any of the first group and the specific community group.
(d-5) The plurality of disclosure levels include a disclosure level corresponding to permitting the business case to be disclosed to an applicant regardless of a group to which the applicant belongs.
(d-6) Attribute data by which the community group is able to be specified is registered in the database, and the computing device specifies an applicant to whom the business case is permitted to be disclosed, based on the disclosure information and the attribute data.
(d-7) When the computing device receives an input of a target group to which the business case is prohibited from being disclosed, the computing device prohibits the business case from being disclosed to an applicant belonging to the target group even when the disclosure level is a level at which the business case is permitted to be disclosed to the target group.
(d-8) The computing device receives, from an inviter device, a request to search for pieces of information of a plurality of registrants registered in the database, and provides the inviter device with a search result that is based on the received request, and the inviter device receives an operation of selecting, from the search result by the inviter, an encouraged applicant to be encouraged to make an application as an applicant, and transmits identification information of the selected encouraged applicant to the computing device, and the computing device transmits, to an applicant device of the selected encouraged applicant, information for prompting to make an application.
(d-9) The computing device registers a plurality of pieces of profile information of each of the plurality of registrants into the database, and the computing device receives, from each of the plurality of registrants, an input for setting a scope of disclosure as the search result among the plurality of pieces of profile information.
(d-10) When the computing device receives an input of invitation type information by which it is able to be specified whether the business for which the invitation is made to the order receiver is a group business for which an order is able to be received when a plurality of applicants jointly apply therefor or a business for which an order is able to be received in response to an application from a single applicant, the computing device registers the invitation type information into the database in association with the business case.
(d-11) The computing device registers, into the database, an application group constituted of a plurality of applicants, and the computing device is able to receive an application from the application group with regard to a business case permitted to be disclosed to all the applicants belonging to the application group.

### Implementations

Implementations of the present disclosure are listed below.
(Item 1) A matching system according to item 1 is a matching system for matching a business case, the matching system comprising: a user device to be operated by a user; and a computing device configured to access a database in which the business case is registered and configured to disclose the business case to the user, wherein the user device includes a first user device to be operated by a first user belonging to a first group, and a second user device to be operated by a second user, the computing device sets a scope of disclosure of a business case provided by the second user based on disclosure information indicating a scope of disclosure of the business case, based on an operation of the first user, the first user device transmits, to the computing device, restriction information for restricting disclosure of the business case to the first group, and the computing device restricts the business case provided by the second user from being disclosed to the first group in accordance with the restriction information regardless of the scope of disclosure set based on the disclosure information.
(Item 2) A matching system according to item 2 is such that in the matching system according to item 1, the restriction information includes any one of user designation information for designating a user to be restricted, business-type designation information for designating a business type to be restricted, and company designation information for designating a company to be restricted.
(Item 3) A matching system according to item 3 is such that in the matching system according to item 2, the second user belongs to a second group, and the user designation information includes information for designating the second group.
(Item 4) A matching system according to item 4 is such that in the matching system according to any one of items 1 to 3, the business case provided by the second user includes a first case and a second case, and the first user device is configured to selectively transmit the restriction information for the first case and the restriction information for the second case to the computing device based on an operation of the first user.
(Item 5) A matching system according to item 5 is such that in the matching system according to any one of items 1 to 4, the first user device transmits the restriction information to the computing device when the first user is one who has an authority to set the restriction information.
(Item 6) A matching system according to item 6 is such that in the matching system according to any one of items 1 to 5, the second user device transmits the disclosure information to the computing device in response to an operation of the second user.
(Item 7) A matching system according to item 7 is such that in the matching system according to any one of items 1 to 6, the user device includes a first applicant device to be operated by a first applicant, the computing device determines, based on disclosure information and restriction information, a business case permitted to be disclosed to the first applicant among business cases registered in the database, and provides, to the first applicant device, the business case permitted to be disclosed to the first applicant.
(Item 8) A matching system according to item 8 is such that in the matching system according to any one of items 1 to 7, the user device includes an inviter device to be operated by an inviter, the inviter device transmits the business case and the disclosure information to the computing device.
(Item 9) A matching system according to item 9 is such that in the matching system according to any one of items 1 to 7, the user device includes an inviter device to be operated by an inviter, and the computing device includes the inviter device.
(Item 10) A user device according to item 10 is a user device for communicating with a computing device for matching a business case, wherein the computing device is configured to access a database in which the business case is registered and is configured to disclose the business case to a user, the computing device sets a scope of disclosure of the business case based on disclosure information indicating the scope of disclosure of the business case and restriction information, the user device includes a receiving unit that receives a user operation for inputting the restriction information, and a transmitting unit that transmits the restriction information to the computing device when the user operation is received by the receiving unit, and the restriction information is information that restricts the business case from being disclosed to a first group to which a first user belongs, regardless of the scope of disclosure that is based on the disclosure information.
(Item 11) A computing device according to item 11 is a computing device for communicating with a user device and matching a business case, the computing device comprising: a setting unit that accesses a database in which the business case is registered and that sets a business case to be disclosed to a first group to which a first user belongs, based on disclosure information indicating a scope of disclosure of the business case; a reception unit that receives, from the user device, restriction information for restricting the disclosure of the business case to the first group; and a restriction unit that, when the restriction information is received, restricts the business case from being disclosed to the first group in accordance with the restriction information regardless of the scope of disclosure set based on the disclosure information.
(Item 12) A method according to item 12 is a method of matching a business case, the method comprising: accessing a database in which the business case is registered and setting a business case to be disclosed to a first group to which a first user belongs, based on disclosure information indicating a scope of disclosure of the business case; receiving, from a user device, restriction information for restricting disclosure of a business case to the first group; and when the restriction information is received, restricting the business case from being disclosed to the first group in accordance with the restriction information regardless of the scope of disclosure set based on the disclosure information.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

According to the present disclosure, it is possible to restrict a scope of disclosure of a business case in consideration of a stake between users when matching the business case.

Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The scope of the invention is indicated by the appended claims, rather than the foregoing description.

### REFERENCE SIGNS LIST

1 matching system; 50 Internet; 100 sharing server; 101 processor; 102 memory; 103, 503 storage; 104 communication interface; 120, 520 database (DB); 121 company database (company DB); 122, 122A member database (member DB); 123 community database (community DB); 124, 124A, 524 invitation case database (invitation case DB); 125 sideline database (sideline DB); 126 evaluation input database (evaluation input DB); 126A inviter evaluation portion; 126B applicant evaluation portion; 127 evaluation summary database (evaluation summary DB); 127A inviter evaluation summary portion; 127B applicant evaluation summary portion; 128 member group database (member group DB); 129 profile database (profile DB); 137 company-specific term database (company-specific term DB); 140 community registration unit; 141 company registration unit; 142 member registration unit; 143 member search unit; 144 case registration unit; 145 case extraction unit; 145A determination unit; 146 request unit; 147 approval unit; 148 notification unit; 149 record receiving unit; 150 record output unit; 151 evaluation receiving unit; 152 evaluation output unit; 161 counteroffer requesting unit; 162 counteroffer approval requesting unit; 163 counteroffer request acceptance notification unit; 200, 200A, 200B, 200C inviter device; 201 processor; 202 memory; 203 communication interface; 204 input/output interface; 205 display; 206 operation unit; 206A keyboard; 206B mouse; 300, 300A, 300B, 300C applicant device; 301 processor; 302 memory; 303 communication interface; 304 input/output interface; 305 display; 306 operation unit; 306A keyboard; 306B mouse; 307A to 307C tab; 308 cursor; 401, 402 table; 500 user device; 521 disclosure permission list; 551, 552, 1271, 1272 data group.

1. A matching system for matching a business case, the matching system comprising:
a user device to be operated by a user; and
a computing device including processing circuitry, the computing device is configured to access a database in which the business case is registered and configured to disclose the business case to the user, wherein the user device includes a first user device to be operated by a first user belonging to a first group, and a second user device to be operated by a second user,
the computing device sets a scope of disclosure of a business case provided by the second user based on disclosure information indicating the scope of disclosure of the business case,
based on an operation of the first user, the first user device transmits, to the computing device, restriction information for restricting disclosure of the business case to the first group, and
the computing device restricts the business case provided by the second user from being disclosed to the first group in accordance with the restriction information regardless of the scope of disclosure set based on the disclosure information.

2. The matching system according to claim 1, wherein the restriction information includes any one of user designation information for designating a user to be restricted, business-type designation information for designating a business type to be restricted, and company designation information for designating a company to be restricted.

3. The matching system according to claim 2, wherein
the second user belongs to a second group, and
the user designation information includes information for designating the second group.

4. The matching system according to claim 1, wherein
the business case provided by the second user includes a first case and a second case, and
the first user device is configured to selectively transmit the restriction information for the first case and the restriction information for the second case to the computing device based on an operation of the first user.

5. The matching system according to claim 1, wherein the first user device transmits the restriction information to the computing device when the first user is one who has an authority to set the restriction information.

6. The matching system according to claim 1, wherein the second user device transmits the disclosure information to the computing device in response to an operation of the second user.

7. The matching system according to claim 1, wherein
the user device includes a first applicant device to be operated by a first applicant,
the computing device determines, based on disclosure information and restriction information, a business case permitted to be disclosed to the first applicant among business cases registered in the database, and provides, to the first applicant device, the business case permitted to be disclosed to the first applicant.

8. The matching system according to claim 1, wherein
the user device includes an inviter device to be operated by an inviter,
the inviter device transmits the business case and the disclosure information to the computing device.

9. The matching system according to claim 1, wherein
the user device includes an inviter device to be operated by an inviter, and
the computing device includes the inviter device.

10. A user device for communicating with a computing device for matching a business case, wherein
the computing device is configured to access a database in which the business case is registered and is configured to disclose the business case to a user,
the computing device sets a scope of disclosure of the business case based on disclosure information indicating the scope of disclosure of the business case and restriction information,
the user device comprising:
a receiver that receives a user operation for inputting the restriction information, and
a transmitter that transmits the restriction information to the computing device when the user operation is received by the receiver, and
the restriction information is information that restricts the business case from being disclosed to a first group to which a first user belongs, regardless of the scope of disclosure that is based on the disclosure information.

11. A computing device for communicating with a user device and matching a business case, the computing device comprising:
processing circuitry configured to:
access a database in which the business case is registered and that sets a business case to be disclosed to a first group to which a first user belongs, based on disclosure information indicating a scope of disclosure of the business case;
receive, from the user device, restriction information for restricting the disclosure of the business case to the first group; and
when the restriction information is received, restrict the business case from being disclosed to the first group in accordance with the restriction information regardless of the scope of disclosure set based on the disclosure information.

12. The matching system according to claim 2, wherein
the business case provided by the second user includes a first case and a second case, and
the first user device is configured to selectively transmit the restriction information for the first case and the restriction information for the second case to the computing device based on an operation of the first user.

13. The matching system according to claim 3, wherein
the business case provided by the second user includes a first case and a second case, and
the first user device is configured to selectively transmit the restriction information for the first case and the restriction information for the second case to the computing device based on an operation of the first user.

14. The matching system according to claim 2, wherein the first user device transmits the restriction information to the computing device when the first user is one who has an authority to set the restriction information.

15. The matching system according to claim 3, wherein the first user device transmits the restriction information to the computing device when the first user is one who has an authority to set the restriction information.

16. The matching system according to claim 4, wherein the first user device transmits the restriction information to the computing device when the first user is one who has an authority to set the restriction information.

17. The matching system according to claim 2, wherein the second user device transmits the disclosure information to the computing device in response to an operation of the second user.

18. The matching system according to claim 3, wherein the second user device transmits the disclosure information to the computing device in response to an operation of the second user.

19. The matching system according to claim 4, wherein the second user device transmits the disclosure information to the computing device in response to an operation of the second user.

20. The matching system according to claim 5, wherein the second user device transmits the disclosure information to the computing device in response to an operation of the second user.
